(19) United States
(12) Patent Application Publication
(10) Pub. No.: US 2025/0313279 A1
(43) Pub. Date: Oct. 9, 2025

(54) CARGO AREA FOR UTILITY VEHICLE

(71) Applicant: Polaris Industries Inc., Medina, MN (US)

(72) Inventors: Jeremiah Johnstun, Wyoming, MN (US); Lauren Frank, Medina, MN (US); Bryan Finn, Medina, MN (US); Joshua Rasa, Fridley, MN (US); Mychale Hinners, Medina, MN (US); Derek Bisping, Wyoming, MN (US); Brian Seidel, Wyoming, MN (US); Beree James Cox, Los Alamitos, CA (US); David Bagnariol, Medina, MN (US); Michael Leighton, Wyoming, MN (US); Joshua Baumann, Wyoming, MN (US)

(73) Assignee: Polaris Industries Inc., Medina, MN (US)

(21) Appl. No.: 18/874,762

(22) PCT Filed: Jun. 29, 2023
(86) PCT No.: PCT/US2023/026591

§ 371 Date: Dec. 13, 2024

Related U.S. Application Data
(60) Provisional application No. 63/357,204, filed on Jun. 30, 2022.

(51) Int. Cl. B62D 33/02; B62D 33/027

(52) U.S. Cl. CPC B62D 33/0207; B62D 33/0222; B62D 33/0273

(57) ABSTRACT

A utility vehicle includes a plurality of ground-engaging members, a frame assembly having a front frame portion and a rear frame portion, a plurality of body panels supported by the frame assembly, a rail including at least one channel extending along a longitudinal length of the rail, and at least one port integrated with the channel configured for receiving a coupling mechanism.

### CROSS-REFERENCE TO RELATED APPLICATION

This application claims the benefit of U.S. Provisional Application No. 63/357,204, filed on Jun. 30, 2022. The entire disclosure of the above application is incorporated herein by reference.

### FIELD OF THE DISCLOSURE

The present application relates to a utility vehicle and, more particularly, to a utility vehicle with a cargo area.

### BACKGROUND OF THE DISCLOSURE

Vehicles configured for off-road travel, such as utility vehicles and all-terrain vehicles, may require various configurations to be able to support accessories or other components of the vehicle. Depending on the application of the vehicle, it may be required that the vehicle is configured with capabilities for supporting a broad range of accessories, for example tools, equipment, food, or other desired accessories.

### SUMMARY OF THE DISCLOSURE

In one embodiment of the present disclosure, a utility vehicle includes a plurality of ground-engaging members, a frame assembly having a front frame portion and a rear frame portion, a plurality of body panels supported by the frame assembly, a rail including at least one channel extending along a longitudinal length of the rail, and at least one port integrated with the channel configured for receiving a coupling mechanism.

In another embodiment of the present disclosure, a utility vehicle includes a plurality of ground-engaging members, a frame assembly having a front frame portion and a rear frame portion, and a plurality of body panels supported by the frame assembly. The utility vehicle further includes a cargo area supported by the frame assembly, the cargo area including a floor panel and at least two side walls extending vertically upward from the floor panel, and a first rail coupled with one of the side panels of the cargo area. The first rail includes a first channel extending along a longitudinal length of the first rail and extending along a top surface of the side panel, a second channel extending along the longitudinal length of the first rail and extending along an inner surface of the side panel, and at least one port integrated with the second channel configured for receiving a coupling mechanism. Further, the first rail is coupled to the side panel with at least one fastener, the fastener concealed from a top view of the side panel.

In a further embodiment of the present disclosure, a utility vehicle includes a plurality of ground-engaging members, a frame assembly having a front frame portion and a rear frame portion, a plurality of body panels supported by the frame assembly, and a cargo area supported by the frame assembly. The cargo area includes a floor panel and a first side wall extending vertically upward from the floor panel, a second side wall extending vertically upward from the floor panel and a tailgate coupled with the floor. The cargo area further includes a first rail coupled with the first side panel and a second rail coupled with the second side panel. The first rail and the second rail each have a longitudinal length and include a first channel. The first channel of each of the first and second rails extends along the longitudinal length and extends along a top surface of the corresponding first or second side panel. The first and second rail each have a plurality of ports arranged within the top surface of the first rail and the second rail configured for receiving a coupling mechanism. Further, the cargo area includes an overhead rack coupled with the first rail and the second rail, the overhead rack defined by a plurality of upstanding posts coupled with the first and second rails and at least two rails extending laterally between the upstanding posts, the at least two rails each including a channel.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a front left perspective view of a utility vehicle with an open cargo area of the present disclosure; FIG. 2 is a rear right perspective view of the vehicle of FIG. 1;

FIG. 3 is a left side view of the of the vehicle of FIG. 1;

FIG. 4 is a right side view of the vehicle of FIG. 1;

FIG. 5 is a top view of the vehicle of FIG. 1;

FIG. 6 is a front view of the vehicle of FIG. 1;

FIG. 7 is a rear view of the vehicle of FIG. 1;

FIG. 8 is a front left perspective view of the utility vehicle of FIG. 1 with an enclosed cargo area;

FIG. 9 is a rear right perspective view of utility vehicle of FIG. 8;

FIG. 10 is a rear perspective view of a cargo area for use with the vehicle of FIGS. 1-9;

FIG. 11 illustrates a rear perspective view of a frame assembly of the cargo area of FIG. 10;

FIG. 12 is an exploded view of a portion of the frame assembly of FIG. 11;

FIG. 13 is an enlarged view of a rail for use with the frame assembly of FIG. 11;

FIG. 14 is a cross sectional view of the rail of FIG. 13 taken along lines 14-14 of FIG. 13;

FIG. 15A is a bottom perspective view of a portion of the cargo area of FIG. 10;

FIG. 15B is a rearward perspective view of the rail drain;

FIG. 15C is a side view of the rail drain;

FIG. 16 is a cross sectional view taken along the line 16-16 of FIG. 15;

FIG. 17 is an exploded view of the rail of FIG. 14 and a portion of the cargo area of FIG. 10;

FIG. 18 is an exploded view of a portion of cargo area of FIG. 10;

FIG. 19A is a cross sectional view of the rail and a portion of the cargo area taken along line 19A-19A of FIG. 15;

FIG. 19B is a top view of a portion of cargo area with an exemplary embodiment of a rail;

FIG. 19C is a cross sectional view of a portion of cargo area taken along the line 19C-19C of FIG. 19B;

FIG. 20 is a perspective view of an additional embodiment of a rail in accordance with the present disclosure;

FIG. 21 is a rear view of the rail of FIG. 20 having a seal mechanism in accordance with the present disclosure;

FIG. 22 is a rear view of the rail of FIG. 20 showing an additional embodiment of a seal mechanism;

FIG. 23 is a rear view of the rail of FIG. 20 with an additional embodiment of a seal mechanism;

FIG. 24 is a rear view of the rail of FIG. 20 with an additional embodiment of a seal mechanism;

FIG. 25 is a side view of a seal mechanism in accordance with the present disclosure;

FIG. 26 is a side top perspective view of the seal mechanism of FIG. 25;

FIG. 27 is a rear view of the rail and the seal mechanism of FIG. 21 after compression;

FIG. 28 is a rear view of the rail and the seal mechanism of FIG. 22 after compression;

FIG. 29 is a top view of a rail of the present disclosure having wear resistant strips coupled therewith;

FIG. 30 is a side view of the rail and the wear resistant strips of FIG. 29 in accordance with the present disclosure;

FIG. 31 is a rear perspective view of a cargo area of the present disclosure;

FIG. 32 is an enlarged view of a portion of a rail and a cap of the cargo area of FIG. 31;

FIG. 33 is an exploded view of the portion of the rail and the cap of FIG. 32;

FIG. 34 is a top perspective view of a portion of the cargo area of FIG. 31;

FIG. 35 is a top perspective view of a portion of a cargo area of the present application having support crossbars;

FIG. 36 is a perspective view of one of the crossbars of FIG. 35 for use with the cargo area of FIG. 35;

FIG. 37 is an exploded view of the crossbar of FIG. 36;

FIG. 38 is an exploded view of a portion of the crossbar of FIG. 37;

FIG. 39A is a bottom view of a coupling mechanism of the portion of the crossbar of FIG. 38 with the coupling mechanisms in a first configuration;

FIG. 39B is a bottom view of the coupling mechanism of FIG. 39A in a second configuration;

FIG. 39C is a bottom view of the coupling mechanism of FIG. 39A in a third configuration;

FIG. 40A is a rear perspective view of a cargo area of the present disclosure and showing a rack coupled with a portion of the cargo area;

FIG. 40B is a partially exploded view of the rack and cross-bed rails

FIG. 41A is a left perspective view of the cargo area of the present disclosure and showing a rear overhead rack coupled with a portion of the cargo area;

FIG. 41B is a rear elevational of the rear overhead of FIG. 41A;

FIG. 42 is a bottom perspective view of the rear overhead rack of FIG. 41A;

FIG. 43A is a coupling mechanism for coupling the rear overhead rack of FIG. 42 with the cargo area of FIG. 41A;

FIG. 43B is an alternate coupling mechanism for coupling the rear overhead rack of FIG. 42 with the cargo area of FIG. 41A;

FIG. 44 is an exploded view of the rear overhead rack of FIG. 42;

FIG. 45 is an underside view of a portion of the rear overhead rack of FIG. 42;

FIG. 46 is a perspective view of the rear overhead rack of FIG. 41A with accessories coupled to the rear overhead rack;

FIG. 46A is a rear view of an accessory supported on the rear overhead rack of FIG. 46.

FIG. 46B is an exploded view of the coupling between the accessory and the rear overhead rack of FIG. 46.

FIG. 47 is a right top perspective view of a cargo area of the present disclosure with a cargo area extender;

FIG. 48 is a front perspective view of the cargo area extender of FIG. 47;

FIG. 49 is a top perspective view of the cargo area of FIG. 47 with an additional embodiment of a cargo area extender;

FIG. 50 is a front perspective view of the cargo area extender of FIG. 49;

FIG. 51 is an exploded view of a coupling mechanism of the cargo area extender of FIG. 49;

FIG. 52 is a perspective view of an inner side of a side panel of the cargo area of the present disclosure with an accessory rack coupled thereon;

FIG. 53 is a perspective view of a first accessory rack and a second accessory rack for coupling to each side of the cargo area;

FIG. 54 is an exploded view of a coupling mechanism for use with a rail of the present disclosure in a first configuration prior to coupling with a rail of the present disclosure;

FIG. 55 is the coupling mechanism of FIG. 54 in second configuration after coupling to the rail;

FIG. 56A is an exploded view of the coupling mechanism of FIG. 55;

FIG. 56B is side view of the coupling mechanism in an unlocked locked position relative to a cross-section of a rail.

FIG. 56C is a bottom view of the coupling mechanism of FIGS. 54-56B aligned

in a port of a rail during insertion.

FIG. 56D is a bottom view of the coupling mechanism of FIGS. 54-56B aligned in a channel of a rail away from the port after insertion.

FIG. 56E is a bottom view of the coupling mechanism of FIGS. 54-56B aligned in a channel in a locked position.

FIG. 57A is a double mount for securing an accessory is illustrated.

FIG. 57B is a rear perspective view of a cargo area of the present disclosure with a storage box mounted with a double mount;

FIG. 57C is a perspective view of the storage box with an alternate coupling mechanism;

FIG. 58 is a tire mount coupled with a rail of the cargo area in accordance with the present disclosure;

FIG. 59 is a side perspective view of the tire mount of FIG. 58;

FIG. 60 is an exploded view of the tire mount of FIG. 59;

FIG. 61 is an additional embodiment of a tire mount coupled with the cargo area of the present disclosure;

FIG. 62 is a rear right perspective view of the tire mount of FIG. 61 within the cargo area;

FIG. 63 is a perspective view of a portion of the tire mount of FIG. 62;

FIG. 64 is a perspective view of a chainsaw mount coupled with the cargo area of the present disclosure;

FIG. 65 is a perspective view of the chainsaw mount of FIG. 64;

FIG. 66 is an exploded view of the chainsaw mount of FIG. 64;

FIG. 67 is a rear view of the chainsaw mount of FIG. 64 in a first or tilted configuration;

FIG. 68 is a side view of the chainsaw mount of FIG. 64;

FIG. 69 is a perspective view of a gun mount attached to a crossbar of the present disclosure;

FIG. 70 is a rear perspective view of the gun mount of FIG. 69;

FIG. 71 is a front perspective view of an additional embodiment of a gun mount;

FIG. 72 is an exploded view of the gun mount of FIG. 71;

FIG. 73 is a power assembly coupled on a rail of cargo area of the present disclosure;

FIG. 74 is a partially exploded view of the power assembly and the rail of FIG. 73; and

FIG. 75 is an exploded view of the power assembly and the rail of FIG. 73.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a utility vehicle, it should be understood that the features disclosed herein may have application to various types of utility vehicles such as all-terrain vehicles, motorcycles, snowmobiles, boats and golf carts.

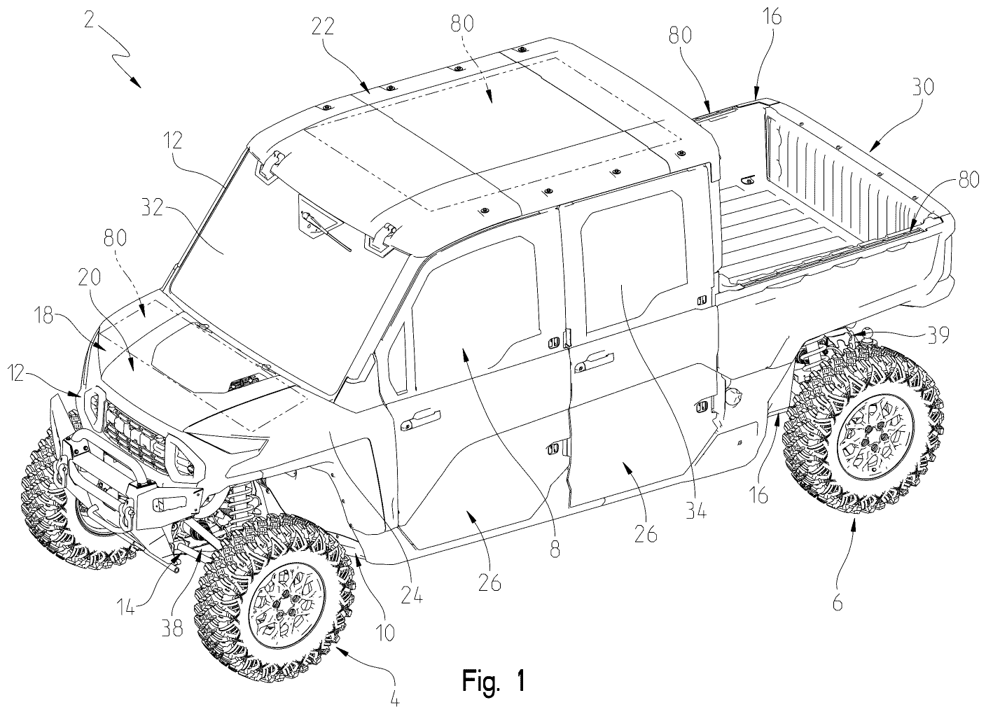

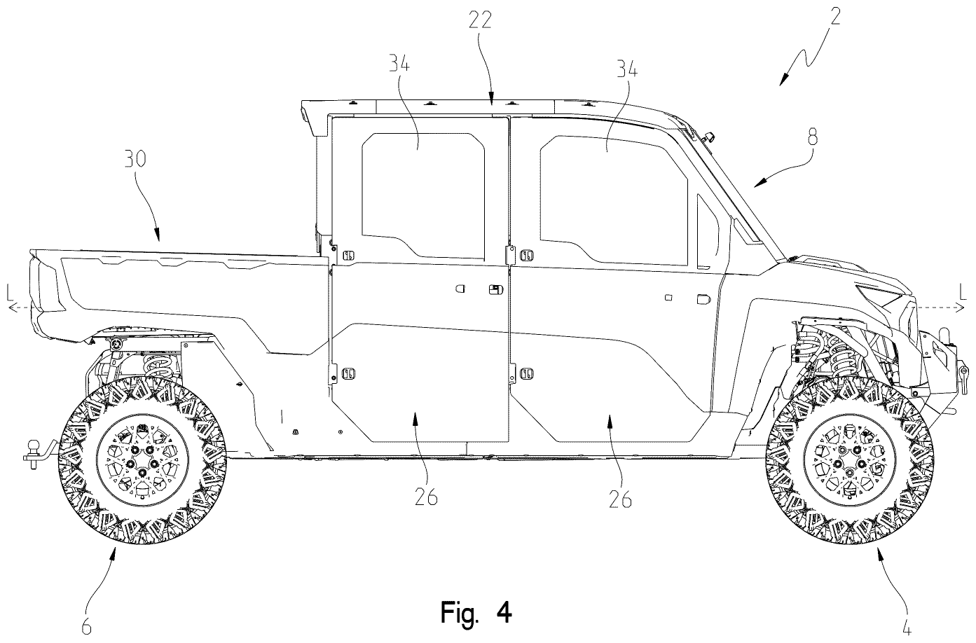

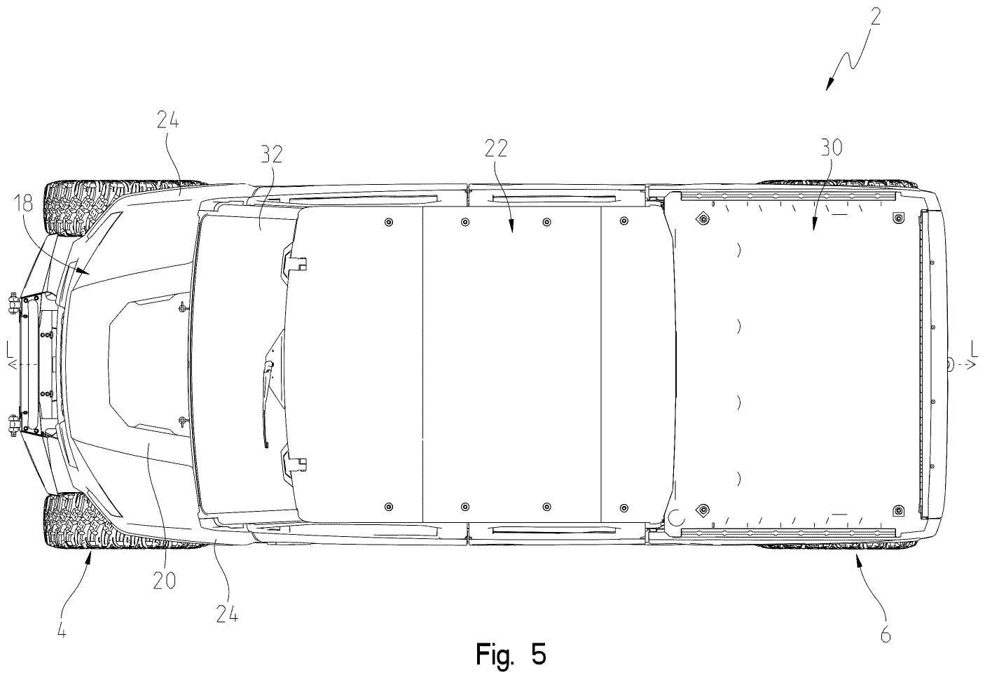

Referring to FIGS. 1-9, an illustrative embodiment of a utility vehicle 2 is shown which is configured to traverse a variety of off-road terrains, including mud, rocks, dirt, sand, and other trail or off-road conditions. Vehicle 2 may be referred to as a utility vehicle (“UTV”), an all-terrain vehicle (“ATV”), or a side-by-side vehicle (“SxS”) and is configured for travel over various terrains or surfaces. Vehicle 2 may be configured for military, industrial, agricultural, or recreational applications.

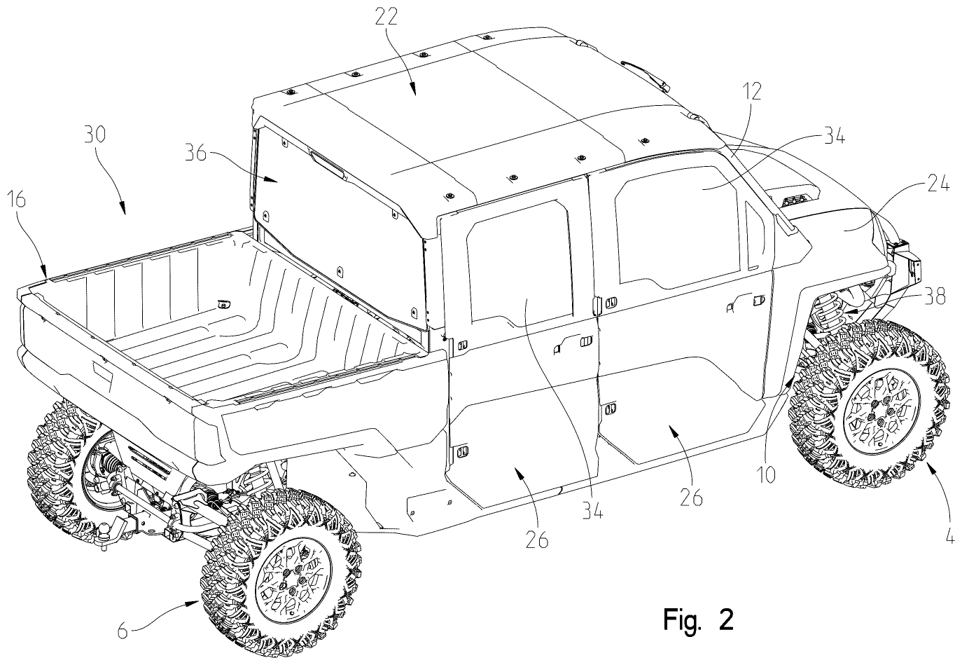

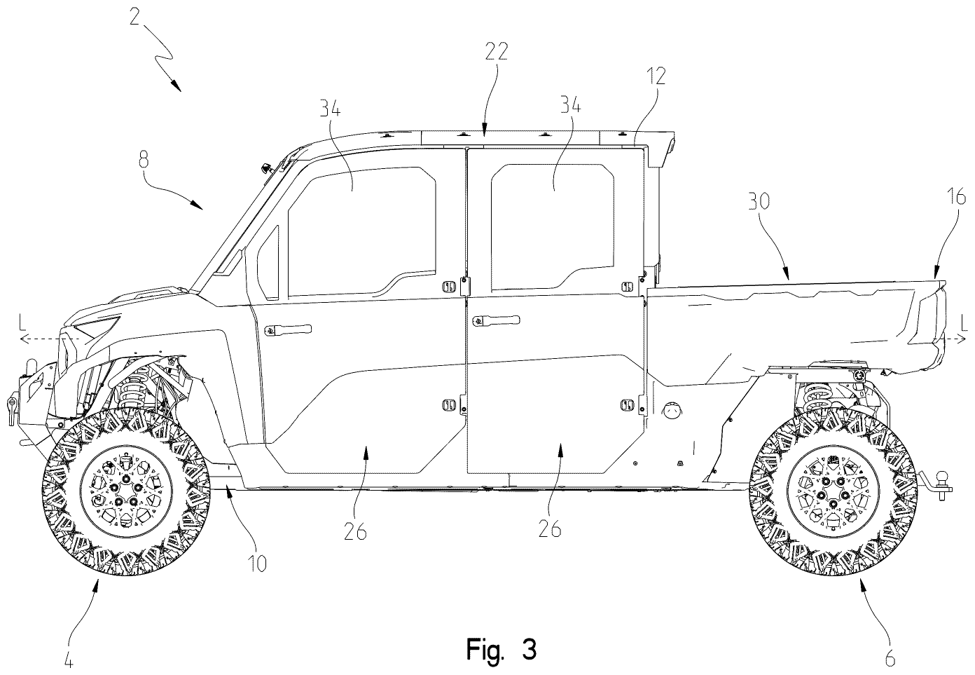

Vehicle 2 includes a plurality of ground-engaging members, including front ground-engaging members 4 and rear-ground engaging members 6. Ground-engaging members 4, 6 are configured to support a frame assembly on the ground surface. The frame assembly includes a lower frame assembly 10 and an upper frame assembly 12 coupled to lower frame assembly 10. An operator area 8 or cab may be defined between frame assemblies 10, 12 to support an operator or driver and one or more passengers positioned laterally adjacent and/or rearward of the operator. Frame assemblies 10, 12 extend along a longitudinal axis L (FIG. 3) of vehicle 2.

Frame assemblies 10, 12 may be configured to support a plurality of body panels 18 which, illustratively, may include a hood 20, a roof 22, front fenders or side panels 24, doors 26, and/or rear fenders 28. Lower frame assembly 10 also supports a cargo area 30 at a rear frame section 16. Various body panels 18 may enclose operator area 8, such as roof 22 and doors 26, and may be sealed against portions of lower and upper frame assemblies 10, 12 when assembled on vehicle 2. Alternatively, roof 22 and doors 26 may be removed or not included on vehicle 2 when desired by the operator. A front windshield 32, door windows 34, and/or a rear windshield 36 (FIG. 2) may further enclose operator area 8 when desired by the operator.

Front suspension assembly 38 is operably coupled to portions of a front frame section 14 of lower frame assembly 10 and front ground-engaging members 4 while a rear suspension assembly 39 is operably coupled to portions of a rear frame section 16 of lower frame assembly 10 and rear ground-engaging members 6. Rear ground-engaging members 6 and front ground-engaging members 4 may be operatively coupled to a powertrain of vehicle 2 for powering movement of vehicle 2.

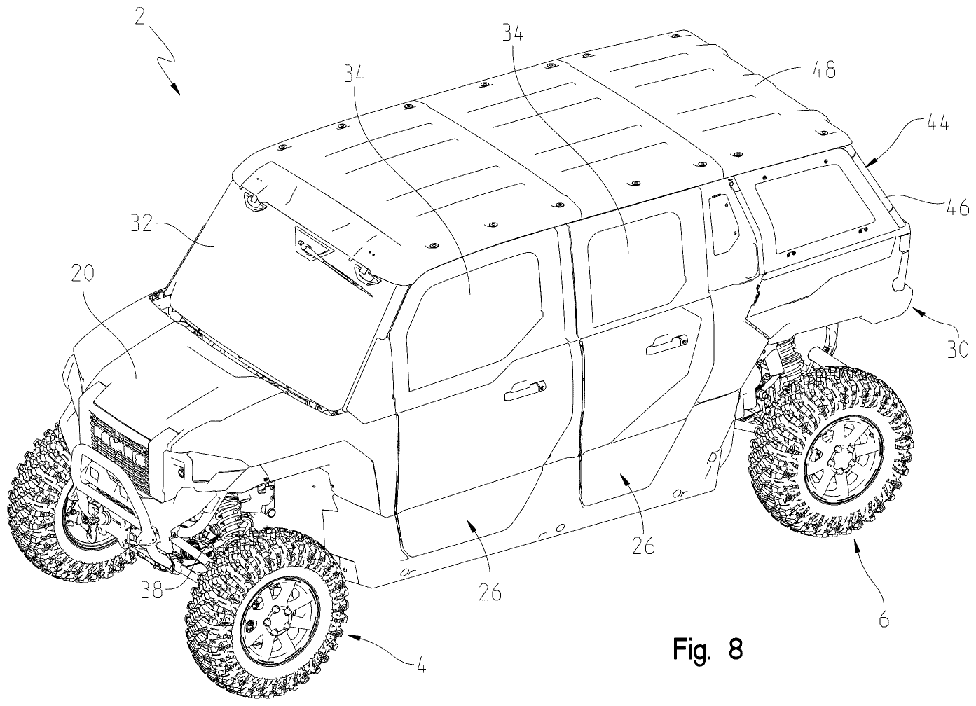

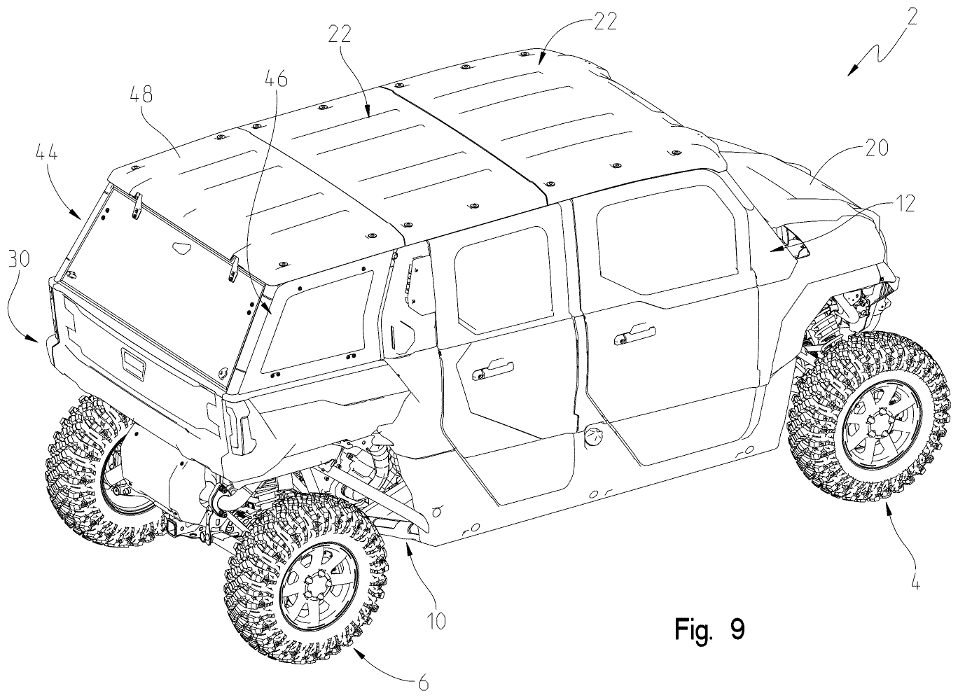

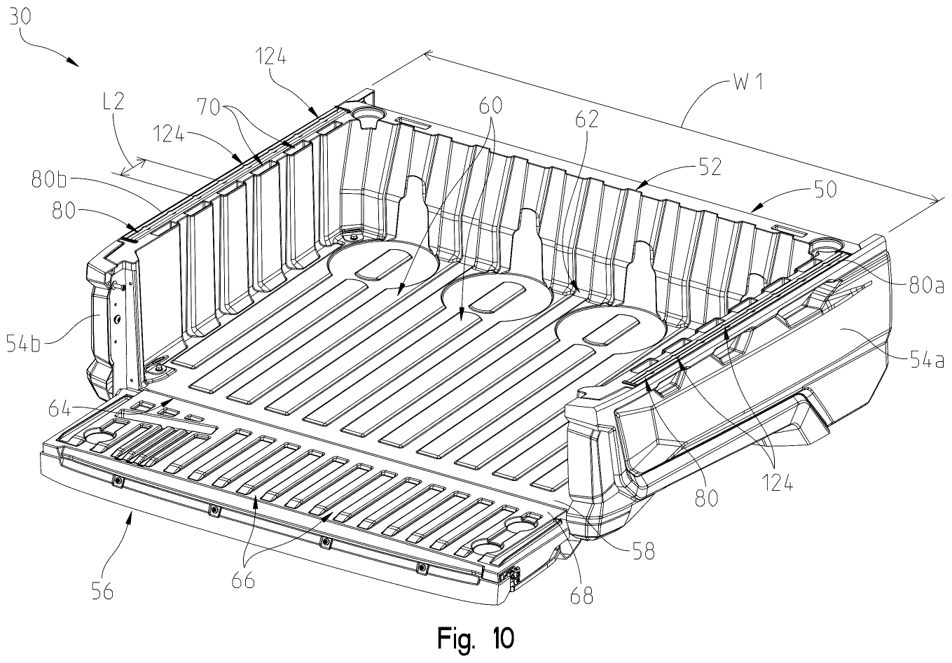

FIG. 8 illustrates an additional embodiment of vehicle 2 having an enclosed cargo area 30 at rear frame section 16. Specifically, as illustrated in FIGS. 8-9, cargo area 30 may be enclosed with a cover 44 to protect items that are held within cargo area 30 during operation of vehicle 2. As illustrated, cover 44 includes a plurality of upwardly extending side panels 46 and a roof 48, however, various other embodiments of cover 44 may be incorporated such that cover 44 may have only one, two, or three side panels and may or may not have a roof panel. Cargo area 30 and various features thereof will be described further herein with reference to FIGS. 10-19.

FIG. 10 illustrates a perspective view of cargo area 30 in accordance with embodiments herein. As illustrated, cargo area 30 is comprised of a cargo box 50 having a forward wall 52, opposing side panels 54 coupled to forward wall 52, a rear wall or tailgate 56, and a floor 58. Further, as illustrated, tailgate 56 may be coupled to floor 58 such that tailgate 56 may rotate rearwardly into an open or lowered position from a raised position, as shown in FIG. 10, or may be rotated towards forward wall 52 such that tailgate 56 extends vertically upwards and is generally perpendicularly to floor 58. When tailgate 56 is rotated forwardly to the closed position from a lowered position, cargo area 30 may be enclosed on at least five sides when cover 44 is provided on vehicle 2.

As illustrated, floor 58 of cargo box 50 is defined by a plurality of raised surfaces 60 extending generally longitudinally from a front end 62 of floor 58 to a rear end 64 of floor 58. Further, tailgate 56 is illustrated as having a plurality of indentations 66 extending along a length of an inner surface 68 of tailgate 56. Various other indentations and/or raised surfaces may be incorporated into each of floor 58 and tailgate 56 to provide increased traction for supporting accessories within cargo box 50. Further, as illustrated, each of side panels 54 includes a plurality of channels 70 extending generally from a top surface of each side panel 54 to a junction at which side panels 54 are coupled with floor 58. Channels 70 may be used for attachment of accessories to cargo box 50 and within cargo area 30. Various other channels, indentations, and raised surfaces may be incorporated into any of the panels of cargo box 50. Further, various other accessories and/or elements may be incorporated into cargo box 50, for example, cup holders. Additionally, cargo box 50 may be tiltable and/or movable. For example, cargo box 50 may be tilted downwardly at a rear end of cargo box 50 (i.e., the end comprising tailgate 56) such that contents of cargo box 50 may be easily emptied therefrom.

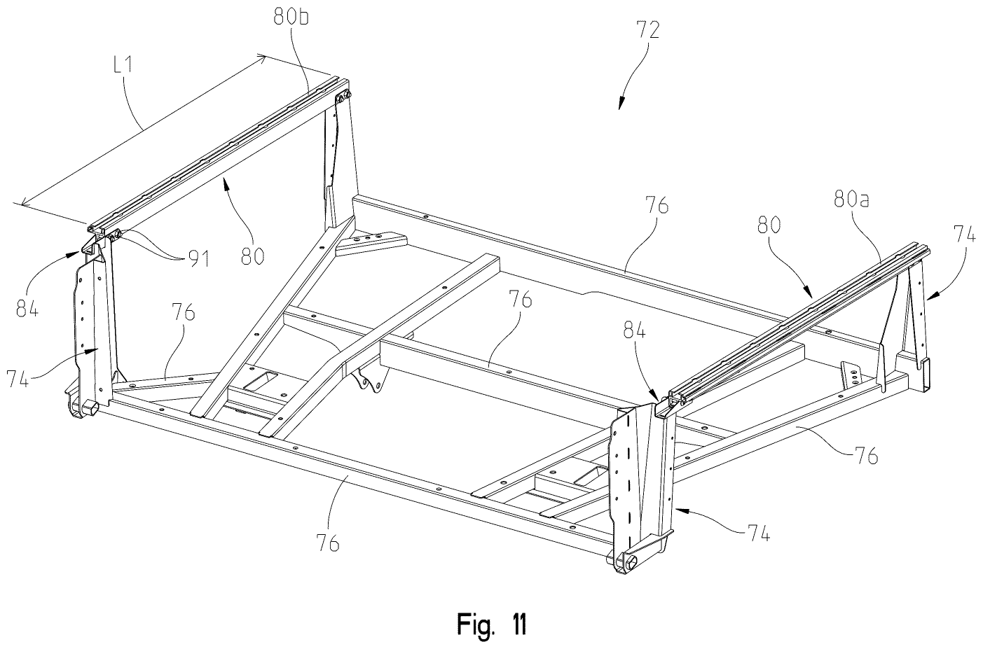

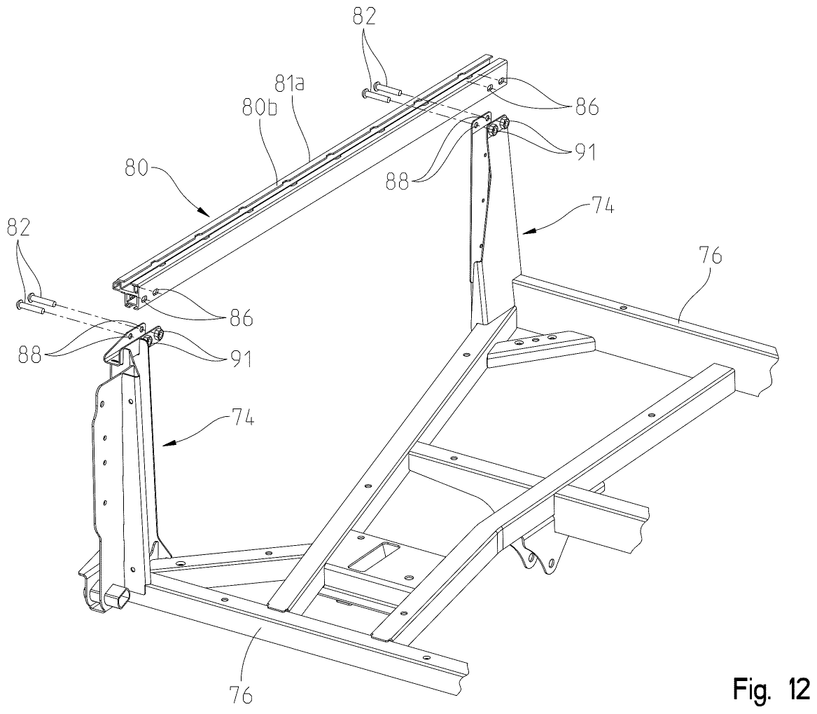

FIGS. 11-12 illustrate a frame 72 of cargo box 50. Illustratively, frame 72 includes four upstanding posts 74 positioned at approximately the four corners of cargo box 50. Frame 72 further includes a plurality of cross-members 76 which couple opposing posts of upstanding posts 74 together. Further, cargo box 50 includes a plurality of rails 80 positioned at and/or defining an uppermost or top surface of side panels 54 and coupled to upstanding posts 74. More specifically, rails 80 may be coupled to upper surfaces of upstanding posts 74 through the use of fasteners 112. However, in other embodiments, as will be described further herein, rails 80 may also be positioned at least partially along an inner surface of side panels 54 and/or adjacent uppermost surface of side panels 54. Further, rails 80 may be positioned with any variety of arrangements on cargo box 50. For example, rails 80 may be integral with or coupled onto floor 58 of cargo area 30. Rails 80 may be coupled with tailgate 56 and/or with forward wall 52 of cargo box 50. While rails 80 are disclosed herein as being supported within cargo area 30, rails 80 may be incorporated at any position on vehicle 2. For example, as illustrated in phantom in FIG. 1, rails 80 may be positioned along hood 20 and/or may couple to and support roof 22 of vehicle 2. Further, rails 80 may support rear windshield 36. In some embodiments, at least one of rails 80 may be positioned vertically above front windshield 32, longitudinally forward of front windshield 32 and coupled with hood 20, and/or coupled with any other body panels 18 of vehicle 2. Further, while illustrated as including two rails 80, any number of rails 80 may be integrated into use with vehicle 2.

Additionally, as illustrated in FIGS. 11-17, rails 80 are illustrated as having a generally three-dimensional profile and are coupled to cargo box 50. In this way, rails 80 may be thinner and occupy less space within cargo area 30. Further, in these embodiments, rail 80 may be embedded with, integral with, or molded into any surfaces of cargo area 30. For example, rails 80 may be a molded piece extending along side panel 54 and/or floor 58 having a generally flat and linear profile. However, various other shapes, configurations, and profiles of rails 80 may be incorporated.

With reference still to FIGS. 11-12, rails 80 may directly couple to the uppermost extent of upstanding posts 74 and/or may be coupled to a bracket 84 at the uppermost extent of upstanding posts 74. For example, as illustrated in FIGS. 11-12, fasteners 82 are configured to be received through laterally aligned apertures 86 of rails 80 and laterally aligned apertures 88 at the upper extent of posts 74. Weld nuts 91 may be included at the upper extent of upstanding posts 74 and/or on bracket 84 to couple with fasteners 82. Due to the lateral alignment of apertures 86 and 88, fasteners 82 are received through side walls of rails 80 and, therefore, are concealed by the body panels of side panels 54 of cargo box 50. In other words, when viewing cargo area 30 from a top view, fasteners 82 may be concealed. The arrangement of cargo box 50 and its components may be similar to the arrangement of the cargo box as described in U.S. Application No. 63/329,543, titled “UTILITY VEHICLE”, and filed on Apr. 11, 2022, the entirety of which is incorporated herein by reference.

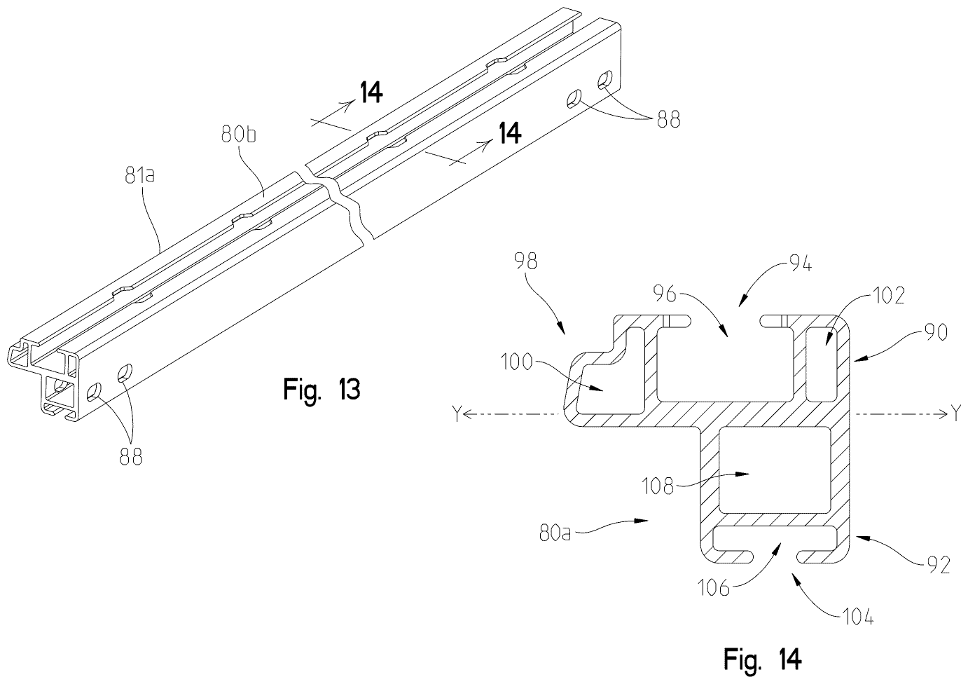

Rails 80 may include at least a first rail 80a and a second rail 80b, both of which are mounted generally horizontally within the vehicle. An upper side or surface 81a of rails 80a and 80b is generally horizontal when mounted on the vehicle side walls. The angle relative to horizontal may vary depending on the amount of load in the cargo area. FIG. 13 illustrates a perspective view of first rail 80a which includes apertures 88 extending laterally through the side of rail 80a. While the following description, as well as further descriptions throughout, may be made with specific reference to first rail 80a, the description applies to second rail 80b, as well. Further, in some embodiments, a description may refer specifically to second rail 80b, however, the description may be applicable to first rail 80a, as well.

As illustrated in FIG. 14, first rail 80a is illustrated as having an upper portion 90 and a lower portion 92. Upper portion 90 and lower portion 92 may be separated by a lateral axis Y extending through rail 80a. Upper portion 90 is defined by a top opening 94 that extends along an entire longitudinal length L1 of top rail 80a. Top opening 94 defines a top channel 96 extending within rail 80 and along longitudinal length L1 of rails 80. Additionally, upper portion 90 includes an outwardly extending portion 98 that may protrude outwardly and laterally with a polygonal shape. In some embodiments, outwardly extending portion 98 may be received within a portion of side panels 54 when rails 80 are coupled with side panels 54. Outwardly extending portion 98 additionally defines a second top channel 100 laterally adjacent to first top channel 96. Top portion 90 further defines a third top channel 102 that is arranged laterally adjacent first top channel 96.

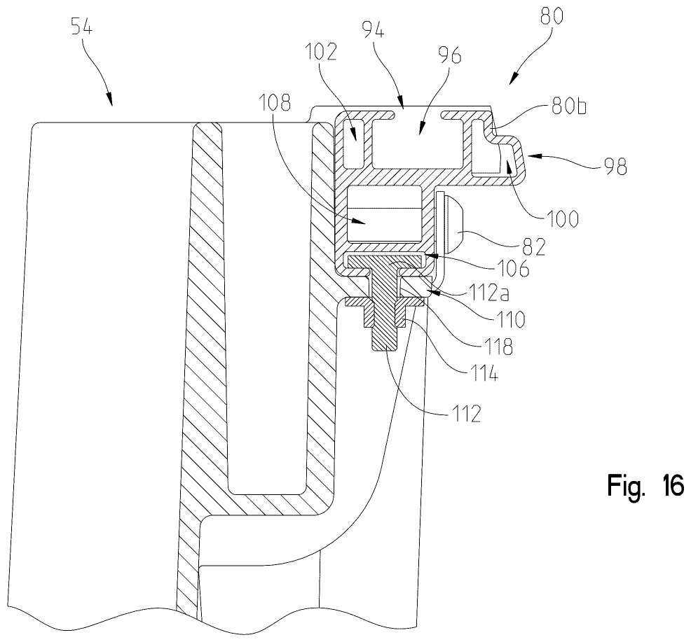

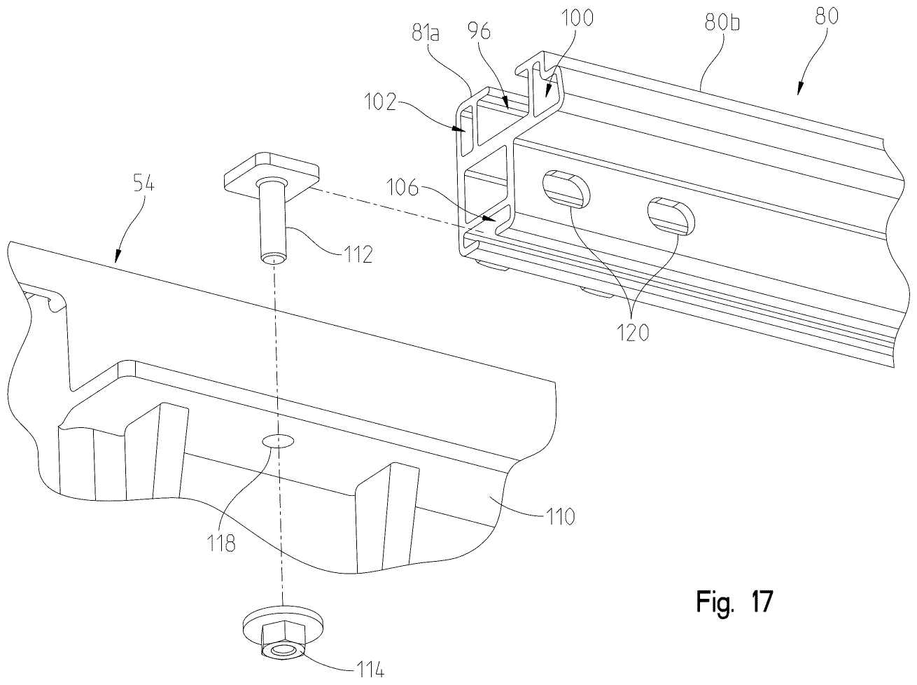

With reference still to FIG. 14, lower portion 92 includes a bottom opening 104 that defines a first lower channel 106 extending along longitudinal length L1 of rail 80. Further, lower portion 92 also defines a second lower channel 108 which may be arranged vertically above first bottom channel 106. As will be described further, bottom opening 104 and first lower channel 106 may be configured for receiving at least a portion of a fastener 112 (FIG. 16). For example, as illustrated in FIGS. 16-17, an outer surface of side panel 54 may include an extension 110 that may have an opening 118 for receiving one of fasteners 112 therethrough. Rail 80 may be positioned such that bottom opening 104 is aligned vertically with opening 118 of extension 110 of side panel 54 and fastener 112 may be inserted through openings 104, 118 and engage with a weld nut 114 on an opposing side of extension 110 for securing fastener 112. As a result of the above-described configuration, multiple methods of coupling of rails 80 to side panels 54 are possible and increase the secured engagement with side panels 54, while concealing fasteners 112 from at least a top view of rails 80. The ability to couple rails 80 to side panels 54 with both vertically extending fasteners 112 and laterally extending fasteners 82, as illustrated in FIGS. 14-17, increases the capability for cargo box to support a greater load applied on the sides of side panels 54, through straps for example, while reducing the chance of inward deflection or deformation of rails 80. Further, this may also prevent lateral deflection of side panels 54 when an increased load is secured with straps and/or other support mechanisms onto side panels 54.

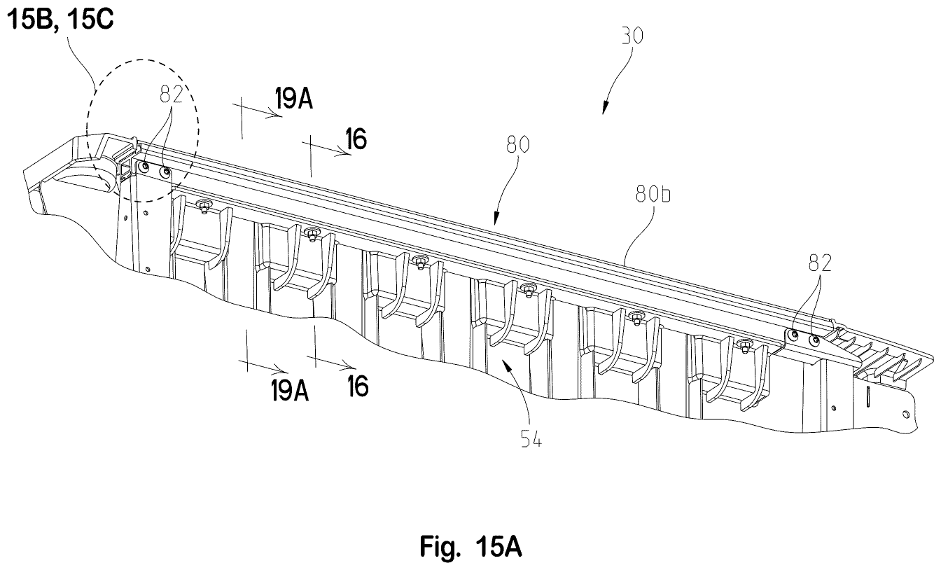

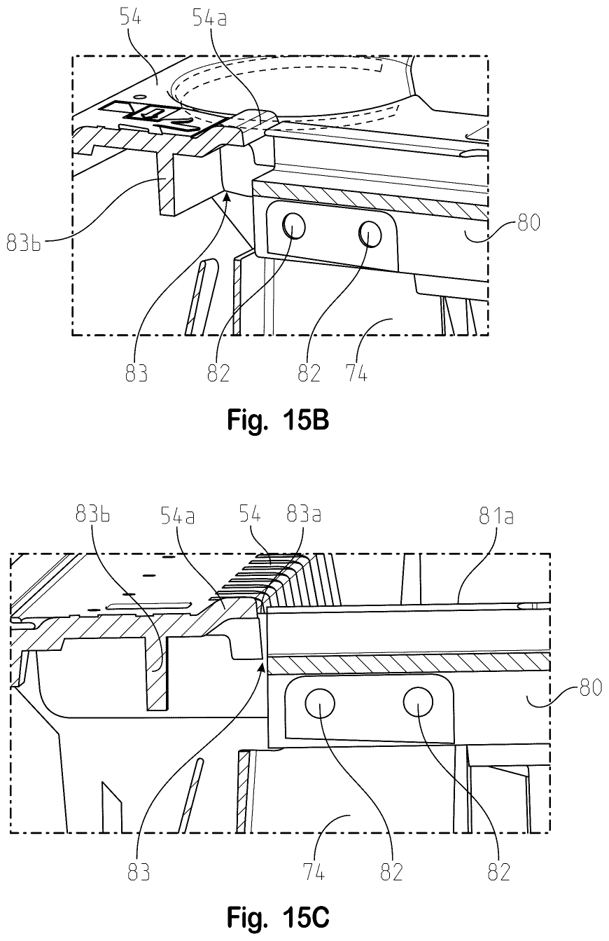

In other embodiments, further fastening mechanisms may be incorporated for securing rails 80 to cargo box 50. For example, rails 80 may be bolted to side panels 54 through additional fasteners that are received through first lower channel 106 of rails 80 and are spaced along longitudinal length L1 of rails 80. In these embodiments, the fasteners may be countersunk fasteners such that the opening that the fastener extends through is covered and the amount of debris and/or dust that may build up into rails 80 is reduced. For example, as shown best in FIGS. 15A-15C, the use of countersunk fasteners allows for debris to be cleaned out of rails 80 without the debris catching onto the fasteners. Additionally, in some embodiments the countersunk fasteners are spaced laterally from ends of rails 80 such that the debris may be swept along rails 80 and into a drain 83 formed by a spacing between rails 80 and side panel 54. The side panel 54 may have a flange 54A that touches or nearly touches the rail 80. In the present example, the flange 54A may have a gap 83A between the rail 80. The channel 96 within the rail 80 is therefore open and drains between a second flange 83B and the rear end of the rail 80. Any debris entering the rail 80 may be flushed through the channel and out the end of the rearward end of the rail 80.

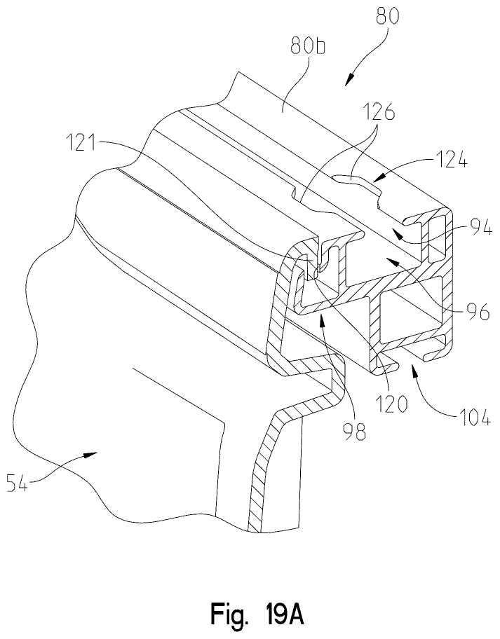

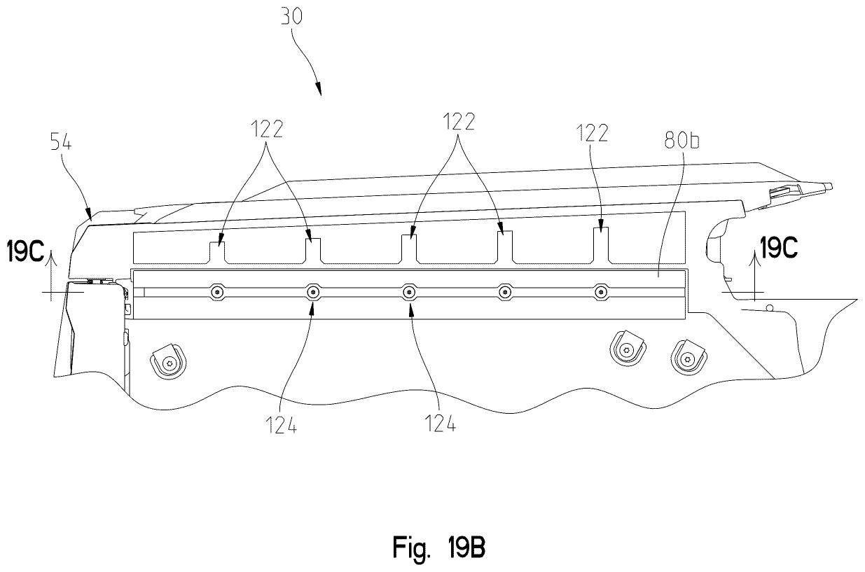

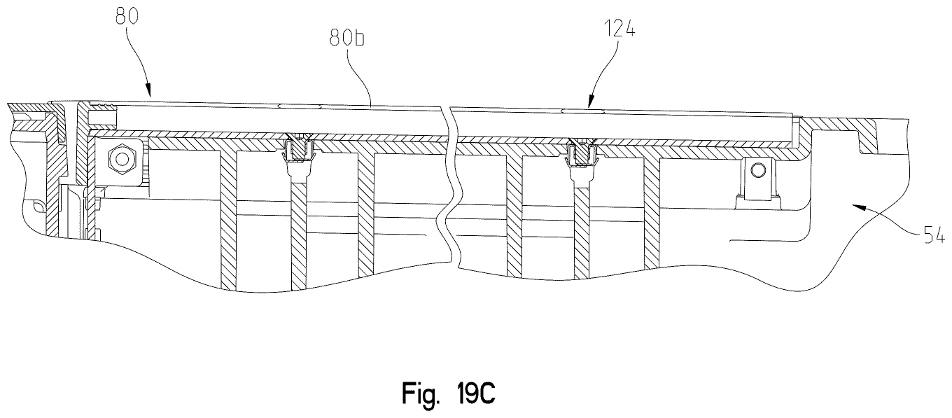

Further, the countersunk fasteners may be flush with a surface of rails 80 within channel 96 such that while items are translated along rails 80, interference or hinderance of those items will be reduced. In other words, the countersunk fasteners may have a top surface that is flush with a bottom surface of rails 80 for reducing debris buildup and/or interference while items are translated along rails 80 (see e.g., FIGS. 19B-19C). Additionally, rails 80 may incorporate three or more apertures 88 spaced along longitudinal length L1 of rails 80 to provide additional openings for fasteners 82 to couple rails 80 with side panels 54. Similarly, two or more fasteners 112 may be incorporated along longitudinal length L1 of rails 80.

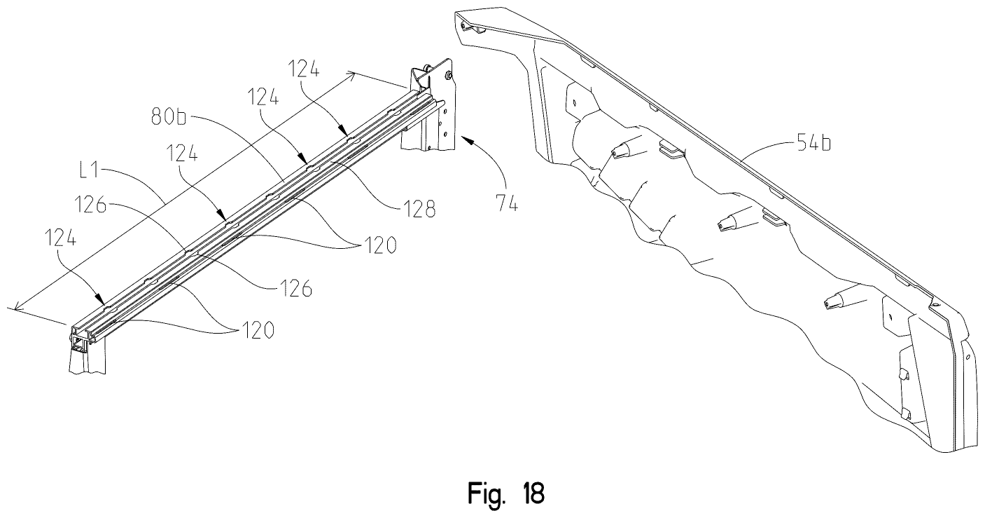

FIG. 18 illustrates an expanded view of forward panel 52 and first rail 80a

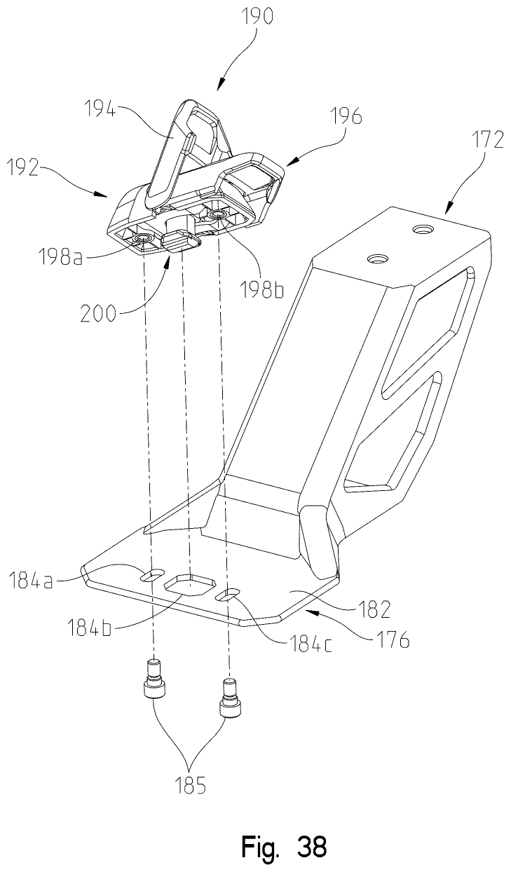

coupled with upstanding posts 74 before coupling of upstanding posts 74 to forward panel 52. As illustrated, first rail 80a includes a plurality of ports 124 arranged along longitudinal length L1 of rail 80. As illustrated, ports 124 are defined by opposing cut outs 126 in a top surface 128 of first rail 80a that form a portion of top opening 94. Cut outs 126 increase the lateral width of ports 124 to facilitate receiving a coupling mechanism, for example coupling mechanism 190 (FIG. 38), as will be described further herein. As illustrated, cut outs 126 may be generally curved or arced in shape. However, in other embodiments, cut outs 126 may have a generally square, triangular, polygonal, or otherwise irregular in shape. Any number of ports 124 may be incorporated along length L1 of first rail 80a. Further, ports 124 may be spaced apart from one another such that a distance between each of ports 124 is a value that may be a divisible value of a lateral distance between opposing rails 80. For example, with reference to FIG. 10, rails 80 may be laterally spaced from one another by a width W1, while ports 124 may be spaced from one another by a length L2. Width W1 may be divisible by length L2, or in other words, length L2 may have a value that is a multiple of the value of width W1. This may increase configurability of cargo area 30 in at least the ability to accommodate attachment of square and/or rectangle boxes and allow for rearrangement of the boxes. In other words, because of the relationship between the values of width W1 and length L2, square or rectangular boxes of varying sizes may be easily accommodated and may be rotated, for example by 90 degrees or 180 degrees, and still be coupled with rails 80.

With reference to FIGS. 18-19A, one of rails 80, illustratively first rail 80a, includes slots 120 extending within outwardly extending portion 98 of rail 80a and extending intermittently along longitudinal length L1 of first rail 80a. As illustrated in FIG. 19, slots 120 may define an opening for receiving a tab 121 extending from side panels 54 to further engage rails 80 with side panels 54. Tabs 121 extend downwardly relative to the uppermost surface of side panels 54 and engage with slots 120. In this way, slots 120 provide an additional mechanism of securing rails 80 with side panels 54 and may reduce the stress and load on fasteners 112 coupling rails 80 and side panels 54. Along with the above-described benefits, engagement of tabs 121 and slots 120 of rails 80 may optimize the engagement between rails 80 and side panels 54. More particularly, the engagement of tabs 121 within slots 120 ensures rails 80 are coupled and tightly fit against side panels 54 regardless of any inward or outward bowing of side panels 54. Further, slots 120 and tabs 121 may act as registration or alignment features for aiding the operator in positioning rails 80 onto side panels 54 correctly.

Additional embodiments of registration features may also be incorporated into rails 80 and side panels 54. For example, FIG. 19B illustrates a top view of one of side panels 54 and one of rails 80, where side panel 54 includes registration tabs 122 extending upwardly from the top surface of side panels 54. As illustrated, registration tabs 122 may be laterally aligned with ports 124 of rails 80 to aid the operator or passenger in knowing where ports 124 are positioned during use of rails 80. This may aid the operator and/or passengers in more efficiently locating ports 124 during engagement of coupling features or other structures with ports 124. Registration tabs 122 may be molded protrusions coupled to or integrally formed with side panels 54. However, various other registration features may be incorporated into other components of cargo box 50. For example, registration tabs 122 may be separate structures coupled to side panels 54 or may be markers that are applied to side panels 54. Further, registration tabs 122 may be indentations within the top surface of side panels 54 rather than upwardly extending features. Registration tabs 122 may also be comprised of a different material applied to the top surface of side panels 54. In this way, registration tabs 122 may provide a visual and/or a tactile indication of the relative position of ports 124.

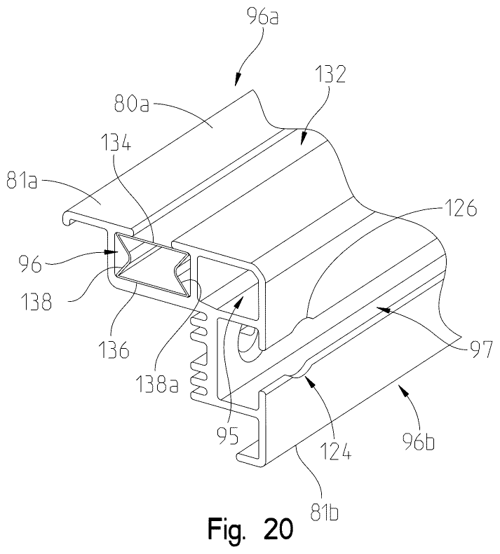

In some embodiments, the profile of rails 80 may be altered such that rails 80 may be mounted to side panels 54 with a portion of rails 80 extending along an inner surface of side panels 54 in combination with a portion of rails 80 extending along the top surface of an upper extent of side panels 54. In these embodiments, rails 80 may have a dual channel profile such that two channels may be incorporated that are accessible for receiving coupling mechanisms and/or accessories rather than only top channel 96. This embodiment will be described further with reference to FIG. 20.

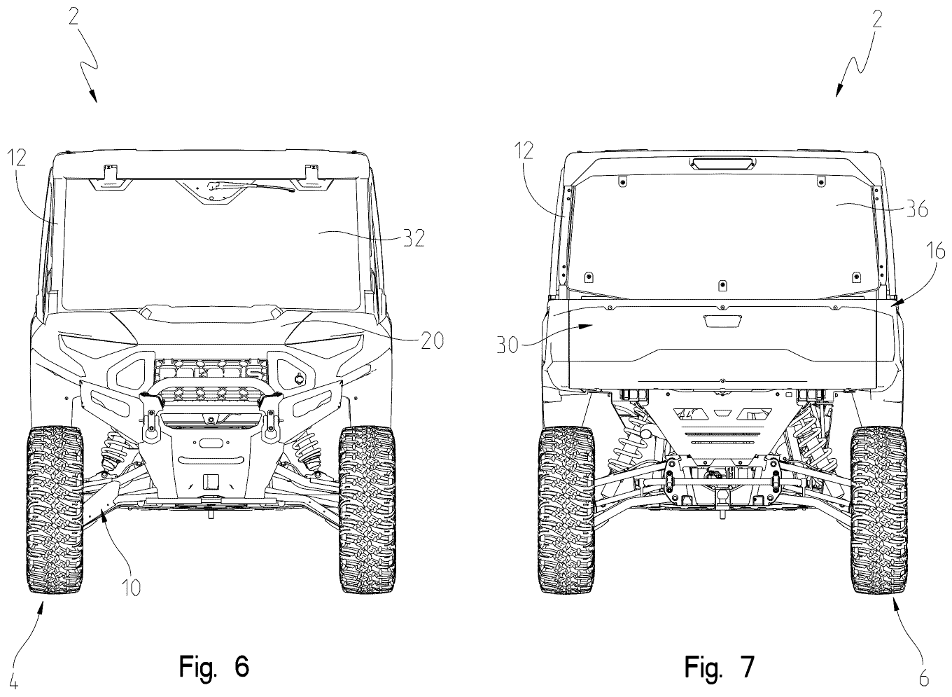

FIG. 20 illustrates an additional embodiment of rail 80 having first, top channel 96 extending along longitudinal length L1 of rail 80 and a second, side channel 97 arranged vertically below first channel 96, which is in a first portion 96A, and in a second portion 96B perpendicular to the first portion 96A. Side channel 97 extends from an opening in a vertical side 81b (when mounted on the side wall of the cargo area) that extends along longitudinal length L1 of rails 80 and is laterally aligned with an inner surface of side panel 54. Both sidewalls of the vehicle 2 may include rails 80a, 80b with horizontal sides 81a and vertical sides 81b. The sides 81a and 81b may be part of a rail that may be oriented in other locations and may not be horizontal or vertical per se. For example, side 81a may be oriented vertically, while side 81b is mounted vertically. The position depends on the type of accessories to be mounted. Further, side channel 97 includes ports 124 spaced apart along a length of side channel 97 for receiving coupling mechanisms 190 (FIG. 38), as will be described further herein. Rail 80, as illustrated in FIG. 20, may be used primarily in combination with cargo area 30, as shown in FIGS. 8-10, when cover 44 is implemented with the cargo box 50. In this way, a top surface of side panels 54 may not be used for receiving coupling mechanisms due to coupling of cover 44 with side panels 54, and side channel 97 remains available for coupling accessories. Rail 80 may additionally include a third channel 95, however, in these embodiments, third channel 95 is not configured for use with coupling mechanisms 190. Various other configurations of side panels 54 may be incorporated with cargo box 50 of FIGS. 1-5 or cargo box 50 of FIGS. 6-8. For example, rails 80 may be altered to have a three-channel profile, four-channel profile, or any other desired amounts of channels configured for receiving accessories. Regardless of the profile of rails 80 and the number of channels arranged within rails 80, it may be desired to incorporate various sealing or covering mechanisms to reduce the debris and dust that may enter rails 80. Dust and debris may impede the function of rails 80 and, as such, minimizing the entry of dust and debris within rails 80 may ensure proper functionality of rails 80. Methods of sealing and protecting rails 80 will be described further herein.

With reference now to FIGS. 20-28, embodiments of sealing mechanisms for use with rails 80 will be described. For example, FIGS. 20-28 illustrates first rail 80a in use with a seal 132 arranged within top channel 96 of first rail 80a. However, seal 132 may be used within various other channels of first rail 80a. As illustrated in FIG. 20, seal 132 may have a generally polygonal shape and may extend longitudinally within at least a portion of side channel 97 of first rail 80a. More specifically, as illustrated, seal 132 comprises a top wall 134, a bottom wall 136 opposite top wall 134, a right-side wall 138a and a left side wall 138b. As illustrated, right and left side walls 138a, 138b are configured for bending or buckling at a central point such that side walls 138 may fold inwardly. Seal 132 may be generally biased outwardly against the inner surface of channel 96 to increase the surface area contact between the inner surface of channel 96 seal 132 and reduce the amount of dust, dirt, or other debris that may enter into channel 96 of rail 80.

Seal 132 may be used with rails 80 during or after the operation of vehicle 2. Seal 132 may also be used with or without fasteners 82, 112 and/or any coupling mechanisms or features that may be arranged within channel 96 of rails 80. More specifically, seal 132 is formed of a flexible material, for example, rubber, or soft plastic, for example nylon, that may be molded or extruded into the desired shape. As previously mentioned, seal 132 may be biased generally outwardly and against inner surfaces of channel 96 such that seal 132 is biased into sealed engagement with inner surfaces of channel 96 of rail 80 and is meant to reduce the amount of space for debris and/or dirt to enter or reside within channel 96. However, due to the flexible nature of seal 132, when an element such as an accessory, fastener, or coupling mechanism 190 (FIG. 38) is inserted through top opening 94 and into channel 96 of first rail 80a, seal 132 will depress slightly to allow for the arrangement of the element. After removal of the element, seal 132 is configured to expand outwardly once again to be in sealing engagement with inner surface of channel 96. Further, seal 132 is configured to only flex or move at the localized point of the fastener being inserted into channel 96. In this way, debris and/or dirt are still minimized or prevented from entering channel 96 along portions of channel 96 that may not include fastener 112. This ability of seal 132 to accommodate the insertion of various fasteners or coupling mechanisms allows for seal 132 to be used regardless of what elements are being inserted into rails 80 and reduces the need for removing and reinserting seal 132 depending on what rails 80 are being used for.

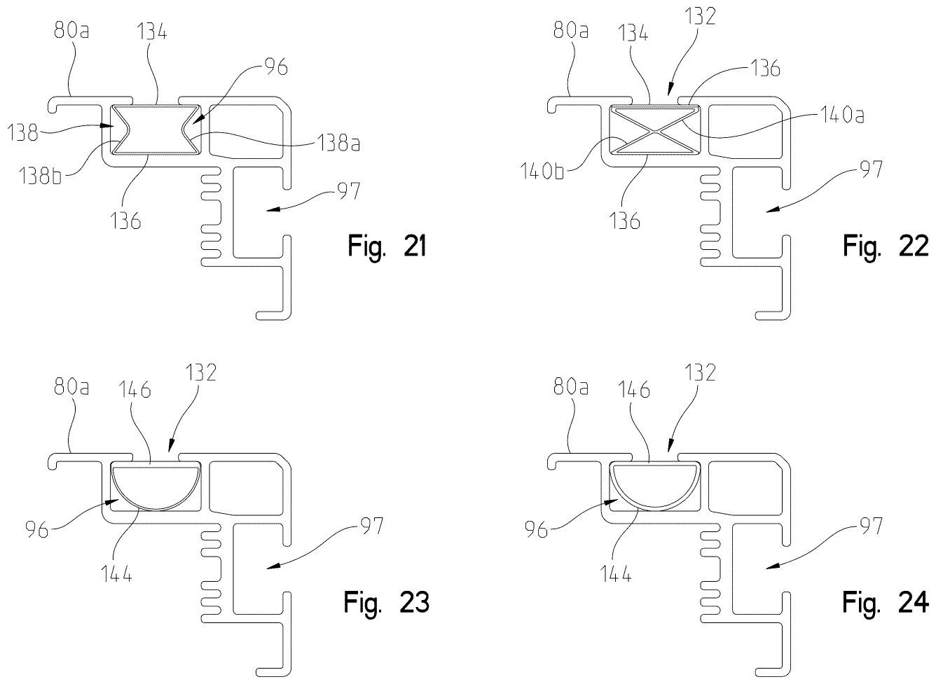

FIGS. 21-24 illustrate variations in a cross-sectional shape of seal 132 in use with first rail 80a. For example, FIG. 21 illustrates seal 132 having the same cross-sectional shape as shown in FIG. 20 such that seal 132 is generally rectangular in shape and side walls 138 are capable of bending and/or folding inwardly during compression. Further, FIG. 22 illustrates an additional configuration of seal 132 which includes top wall 134 opposite bottom wall 136. However, rather than have right and left side walls 138a, 138b as described with reference to FIGS. 20-21, seal 132 includes a first angled wall 140a extending between top wall 134 and bottom wall 136 and a second angled wall 140b extending between top wall 134 and bottom wall 136 which intersects with first angled wall 140a. As illustrated, FIG. 22 may additionally include a reinforcing member 133 positioned vertically above top wall 134 which may thicken seal 132 and increase the sealing engagement with channel 96.

Further, FIG. 23 illustrates an additional configuration of seal 132 within rails 80. More specifically, cross-sectional profile of seal 132 is illustrated as generally semi-circular shape. Seal 132 may be defined by a curved portion 144 coupled with a generally linear top portion 146. Further, FIG. 24 illustrates a variation of the cross-sectional profile of seal 132, the shape being similar to the configuration of FIG. 23, however, curved portion 144 in the configuration of FIG. 24 is illustrated as being generally thicker than curved portion 144 of FIG. 23. However, various other configurations of seal 132 may be used. Regardless of the cross-sectional shape, seal 132 is configured to expand outwardly for sealed engagement with inner surface of channel 96 while also being capable of compression and elastic deformation for receiving and accommodating fasteners 112, coupling mechanisms 190 (FIG. 38), and/or various other coupling features.

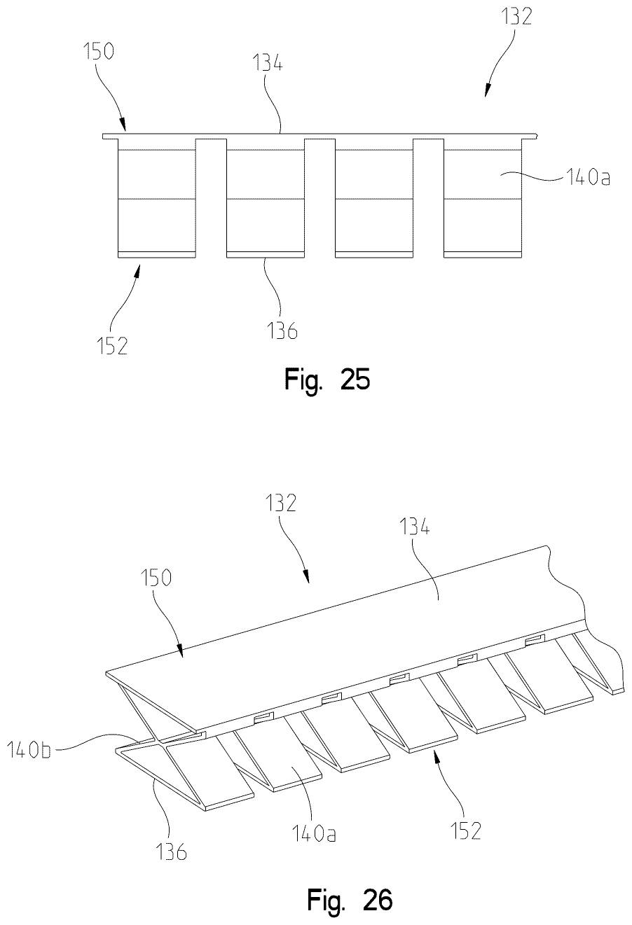

The ability for seal 132 to be compressed and/or reversibly deformed will be described further herein with reference to FIGS. 25-28. For example, FIG. 25 illustrates a side view of seal 132 and FIG. 26 illustrates a top left perspective view of seal 132. Seal 132 comprises a first spring area 150 and a second spring area 152 both of which are comprised of material that is able to compress and absorb compression of seal 132 when fasteners 112, coupling mechanism 190, and/or other accessories are inserted within rail 80. In this way, the entirety of seal 132 does not compress or deform, but instead localized areas of seal 132 deform to create space for fastener 112, coupling mechanism, or other accessories, while still maintaining the overall outward bias of seal 132. Thus, the integrity of the sealing between inner surfaces of channel 96 and seal 132 may be maintained. Further, in some embodiments, first spring area 150 may be defined by a lower coefficient of friction relative to that of a remainder of seal 132 such that the ability of the accessory to slide along rail 80 is maintained, even under compression. In these embodiments, second spring area 152 may undergo a higher amount of deformation or compression than first spring area 150 due to a higher durometer of first spring area 150 to ensure that the accessory is capable of sliding along rail 80. In these embodiments, first spring area 150 may be composed of a different material than a material that second spring area 152. In other embodiments, first spring area 150 may be mechanically modified to exhibit a lower coefficient of friction.

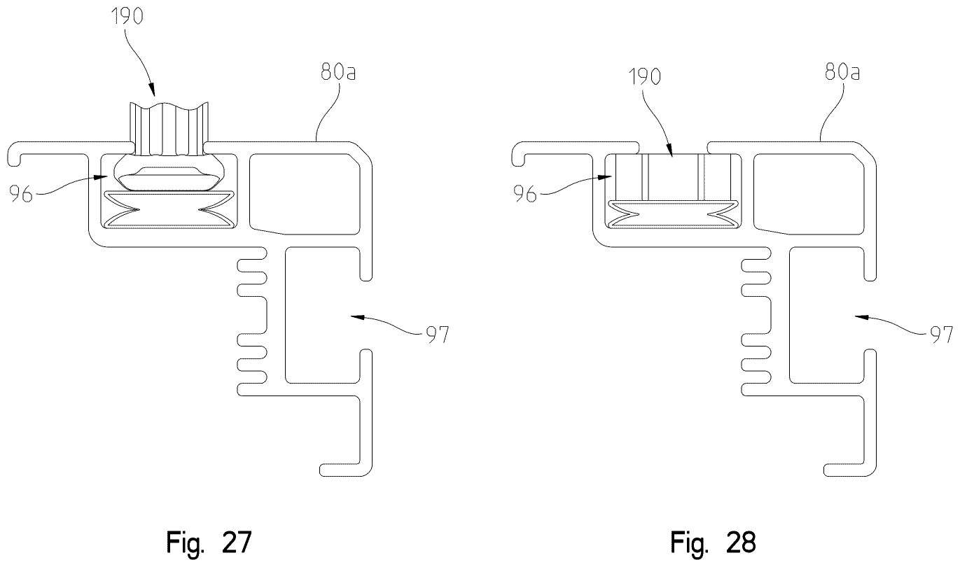

FIGS. 27-28 illustrate an embodiment of seal 132 in a depressed configuration after being contacted by various fasteners and coupling mechanisms. For example, FIG. 27 illustrates seal 132 having the configuration as illustrated in FIG. 21, after a coupling mechanism 190 has been inserted through opening 94 of rail 80 and is in contact with seal 132. As shown, insertion of coupling mechanism 190 causes deformation and compression of seal 132 such that top wall 134 of seal 132 is forced vertically downward. FIG. 28 illustrates seal 132 with the similar configuration as shown and described with reference to FIG. 21 after an additional embodiment of coupling mechanism 190 is inserted through top opening 94 of rail 80 and into channel 96. As illustrated, after insertion of coupling mechanism 190 into channel 96, seal 132 depresses vertically downward.

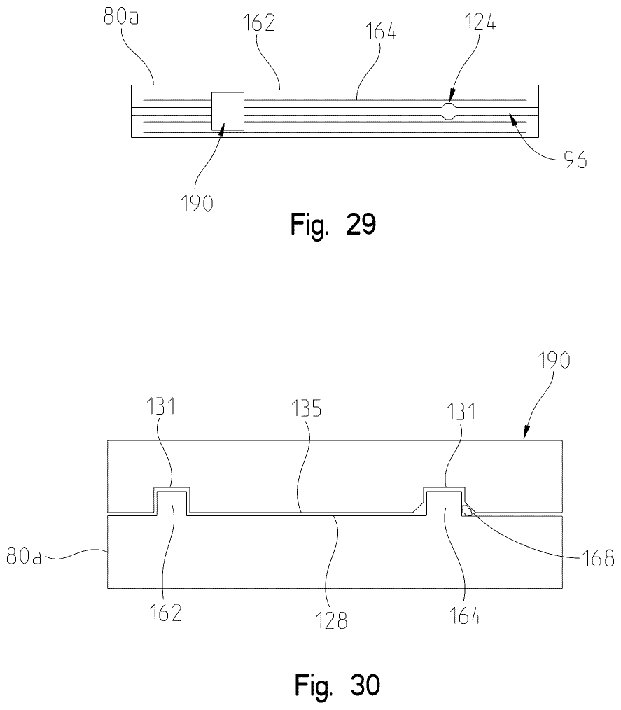

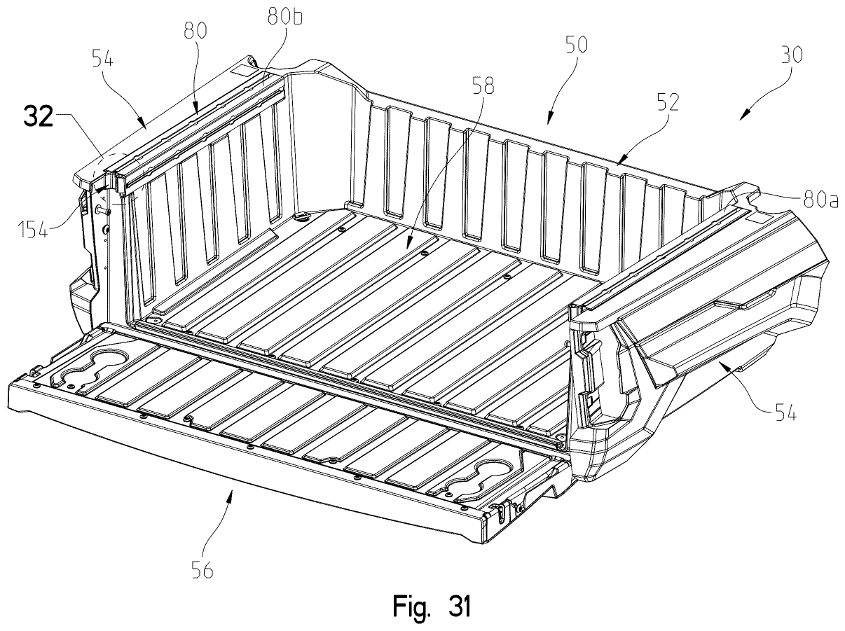

Further, rails 80 may include weather resistant strips that act as a water and wear resistant element for increasing the integrity and lifetime of rails 80. FIGS. 29-30 illustrate first rail 80a including a first wear member 162 and a second wear member 164 disposed on first rail 80a. Wear members 162, 164 may protrude from first rail 80a and may be configured to mechanically erode or abrade from rail 80a, for example, before substantial erosion or abrasion of first rail 80a. Substantial abrasion may include abrasion that effects at least one of the functionalities, structural integrity, or surface finish of top surface 128 of first rail 80a. Generally, wear members 162, 164 may include any suitable shape or pattern extending along at least a portion of longitudinal length L1 of first rail 80a and any suitable cross-sectional shape. For example, wear members 162, 164 may be substantially rectilinear strips, curvilinear strips, define one or more repeating or non-repeating patterns, or the like.

In some examples, coupling mechanism 190 may have a surface 135 defining receiving members 131 having a corresponding shape, i.e., a shape configured to receive at least a portion of wear members 162, 164 therein. Receiving members 131 may facilitate the alignment (e.g., registration) of coupling mechanism 190 relative to rail 80 and/or channel 96 of first rail 80a. Alignment may be facilitated in the lateral and/or longitudinal direction. Additionally, or alternatively, receiving members 131 may facilitate alignment of an orientation of coupling mechanisms 190, e.g., an angle of coupling mechanisms 190 relative to an axis, e.g., a longitudinal axis, of first rail 80a.

In further examples, a cross-sectional shape of receiving members 131 may be configured to enable alignment of coupling mechanism 190 when debris 166 may be present at or near wear members 162, 164. For example, one of receiving members 131 may include a tapered surface 137 which may enable receiving member 131 to fully receive wear members 162, 164 even if debris or dust is present near wear member 164. The above-described configuration of wear members 162, 164 may also be applied with second rail 80b or any of the rails described herein.

In some embodiments, a cap 154 may also be used in combination with rails 80. For example, FIG. 31 illustrates a rear perspective view of cargo area 30 having rails 80 coupled at least partially with inner surface of side panels 54 and a top surface of side panels 54. At rear end of rails 80, rails 80 are coupled with a cap 154. Cap 154 may be arranged at a longitudinal end of each of rails 80 for sealing or reducing access into the channels of rails 80a.

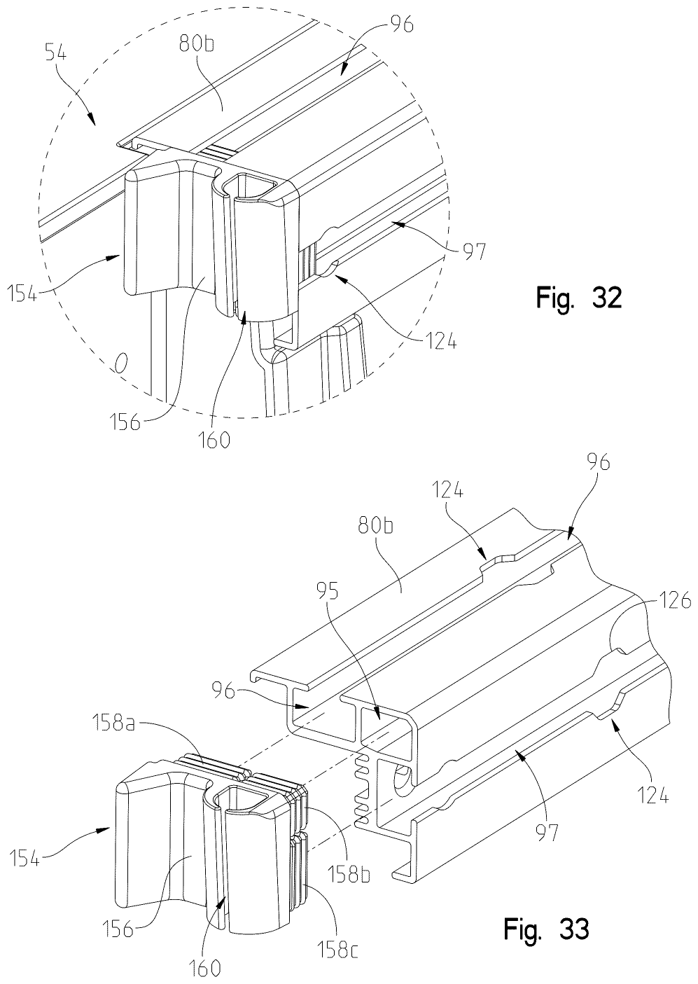

FIG. 32 illustrates the portion of cargo area and rails 80 as indicated in FIG. 31. As illustrated in FIG. 32, and the exploded view of FIG. 33, cap 154 is defined by a body portion 156 having a first extension 158a, a second extension 158b, and a third extension 158c extending longitudinally outward from body portion 156 of cap 154. Each of extensions 158 is configured for at least partial reception into a channel of rail 80. Illustratively, cap 154 includes three extensions such that first extension 158a is received within channel 96, second extension 158b is received within channel 95 and third extension 158c is received within side channel 97. However, any number of extensions may be incorporated with cap 154 to match the number of channels of rails 80. Further, cap 154 may be adjusted to be engaged with rail 80 having a single channel configuration, for example rails 80 illustrated in at least FIGS. 13-15.

With reference still to FIGS. 32-33, after engagement of cap 154, each channel 95, 96, 97 of first rail 80a may be entirely covered at an end by cap 154. Further, main body portion 156 includes an engagement portion 160 that may be configured to engage with coupling mechanisms or support accessories for further optimizing functionality of rails 80.

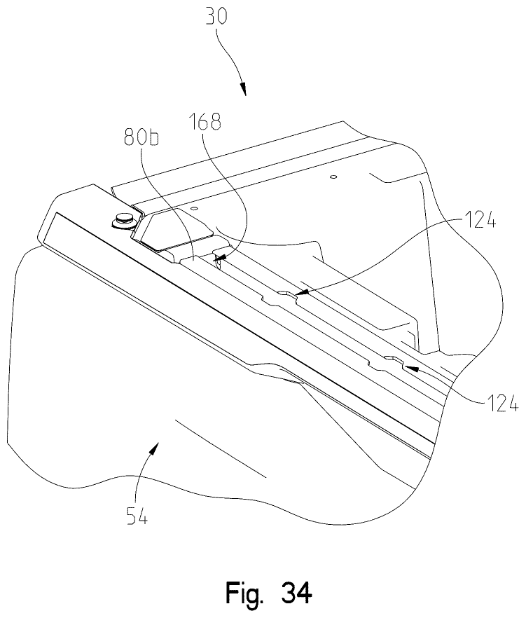

In the event that debris or any other substance is able to enter the channels of rails 80, rails 80 may be designed to include drain ports for removing such debris or the like. For example, FIG. 34 illustrates a perspective view of a portion of cargo area 30 having second rail 80b extending alongside panel 54. As illustrated, second rail 80b includes a port 168 which may act as a drainage port. In this way, while the above-described mechanisms allow for reduced collection of debris, dust and/or water into rails 80, incorporation of at least one port 168 provides a mechanism for removing such elements if they enter rails 80. Further, various tools may be used in combination with port 168 to remove (e.g., push) any dirt and/or debris that is within channel 96 of second rail 80b and bias the dirt and/or debris toward port 168 for exiting rails 80. While illustrated as being positioned at a longitudinal end of second rail 80b, in other embodiments, port 168 may be positioned along various other longitudinal locations of second rail 80b, for example in a longitudinal center or front end of rails 80.

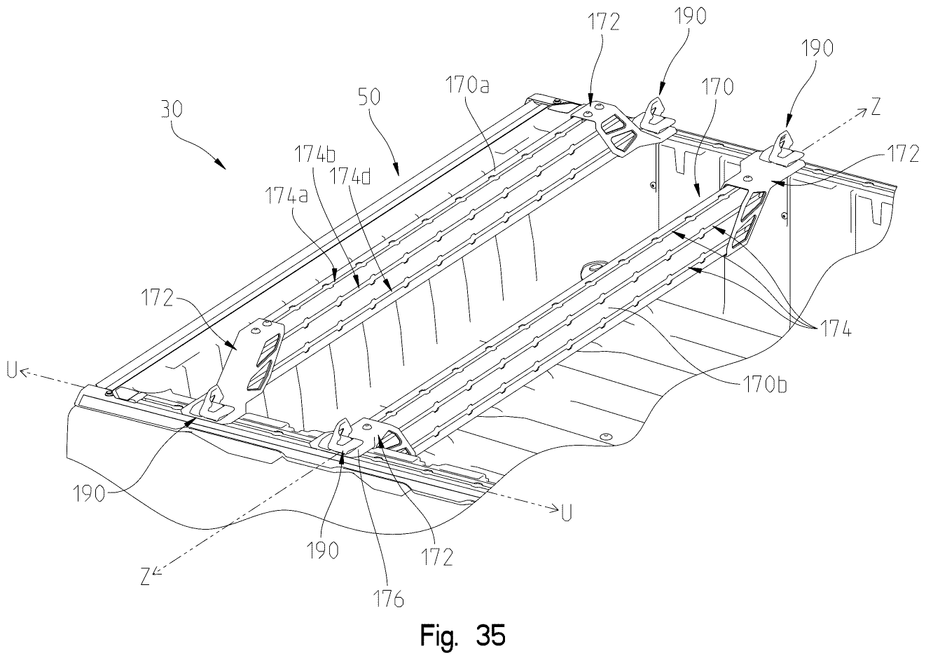

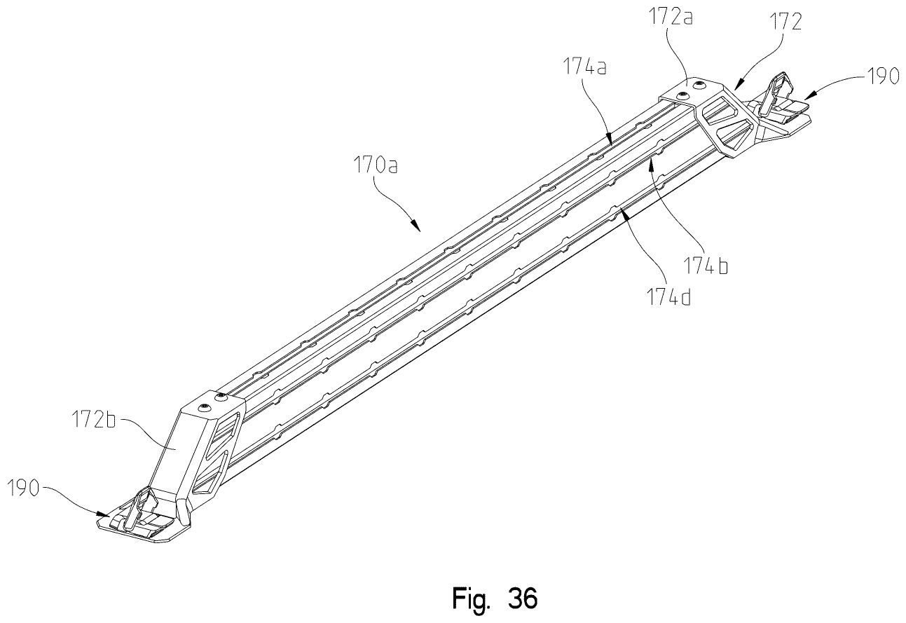

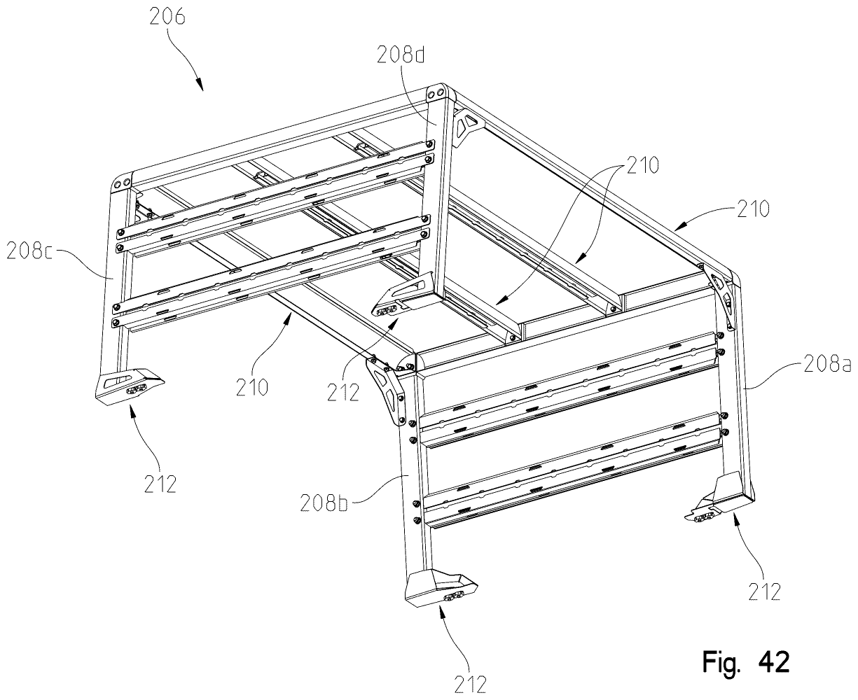

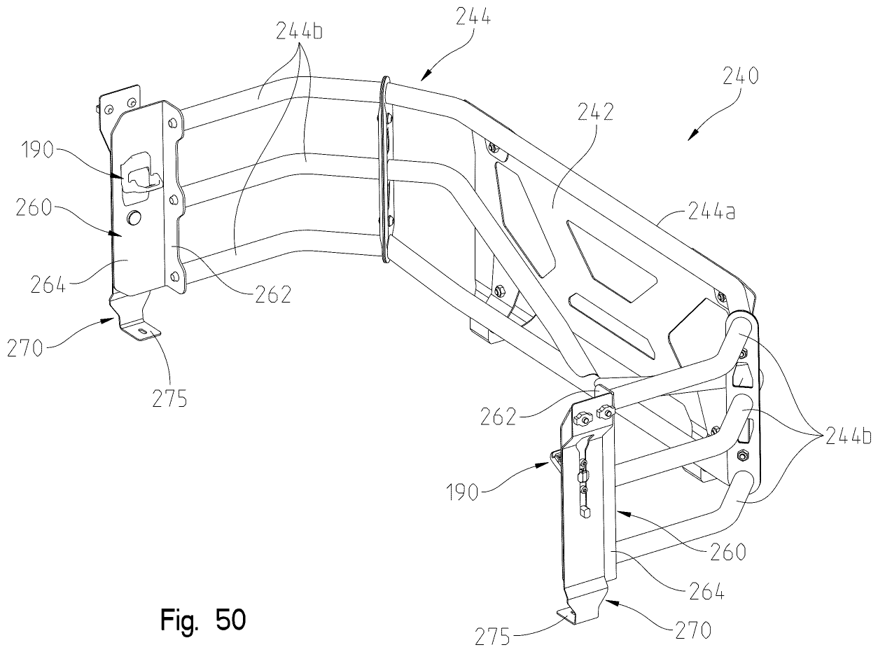

Due to the incorporation of rails 80, cargo box 50 may include various mechanisms and structures for optimizing the functionality and storage space within cargo box 50. With reference now to FIGS. 35-56, mechanisms for optimizing the storage space and supporting various accessory options for cargo area 30 will be discussed further.

For example, FIG. 35 illustrates cargo box 50 with crossbars 170 mounted to first and second rails 80a, 80b. As illustrated, each of crossbars 170 are coupled to rails 80 through brackets 172 and coupling mechanisms 190. More specifically, crossbars 170 extend along an axis Z that extends generally perpendicularly to an axis U of rails 80. Crossbars 170 may also be referred to herein as rails since crossbars 170 each include channels 96 that may be the same as, or similar to, channel 96 of rails 80 (FIG. 10). In this way, and as will be described further herein, crossbars 170 may receive coupling mechanisms 190 (FIG. 38) for attaching accessories to crossbars 170. Thus, with the incorporation of crossbars 170 onto rails 80, coupling mechanisms 190 (FIG. 38) may be coupled to each of rails 80 and each of crossbars 170 for supporting additional accessories.

Further, there may be flexibility in the arrangement of crossbars 170 and the configuration of crossbars 170 for flexibility in the attachment of accessories to crossbars 170. For example, as illustrated in FIG. 35, a first crossbar 170a is illustrated in an “up” configuration with a maximum vertical extent that is higher than a top vertical height of cargo box 50. A second crossbar 170b of crossbars 170 is illustrated in a “down” configuration and having a maximum vertical extent that is generally equal to or aligned with the top vertical height of cargo box 50. In this way, accessories may be coupled to one of crossbars 170 based on the size and height of the accessory. For example, for larger accessories, first crossbar 170a may be used for coupling of the accessory as it provides a greater vertical height extending between a top of first crossbar 170a and floor 58 than a vertical height extending between floor 58 and a top surface of second crossbar 170b.

The coupling of crossbars 170 to rails 80 will be described further with reference to FIGS. 35 to FIGS. 39C. First crossbar 170a includes a first channel 174, a first row of channels 174 laterally aligned with one another and vertically below first channel 174a, illustratively a second channel 174b and a third channel 174c, a second row of channels 174 laterally aligned with one another and vertically below and a second row of channels 174 comprising a fourth channel 174d and a fifth channel 174e, and a sixth channel 174f extending from a bottom surface of first crossbar 170b. Each of channels 174 may include ports 124 extending along a longitudinal length of first crossbar 170a. However, not all of channels 174 incorporated in crossbars 170 include ports 124.

As illustrated, each end of crossbar 170 is secured within brackets 172 through various fastening mechanisms which may then couple with rails 80. Each bracket 172, illustratively a first bracket 172a and a second bracket 172b, includes openings 184 extending through a first or top surface 176 of each bracket 172 that may receive fasteners 180. Fasteners 180 are configured for coupling with elongated nuts 181 which may be received within top channel 174a of crossbar 170 for securing of crossbar 170 within bracket 172. In this way, fasteners 180 and elongated nuts 181 secure top surface 176 of bracket 172 just above first channel 174a of crossbar 170. Further, fifth channel 174e of crossbar 170 is configured to receive an elongated nut 186 that is configured to receive a fastener 188 extending within an inner portion of first bracket 172a, thus providing an additional point of coupling between crossbar 170 and bracket 172a. In this way, both the top surface 176 and bottom surface 182 of bracket 172a are secured with first crossbar 170a.

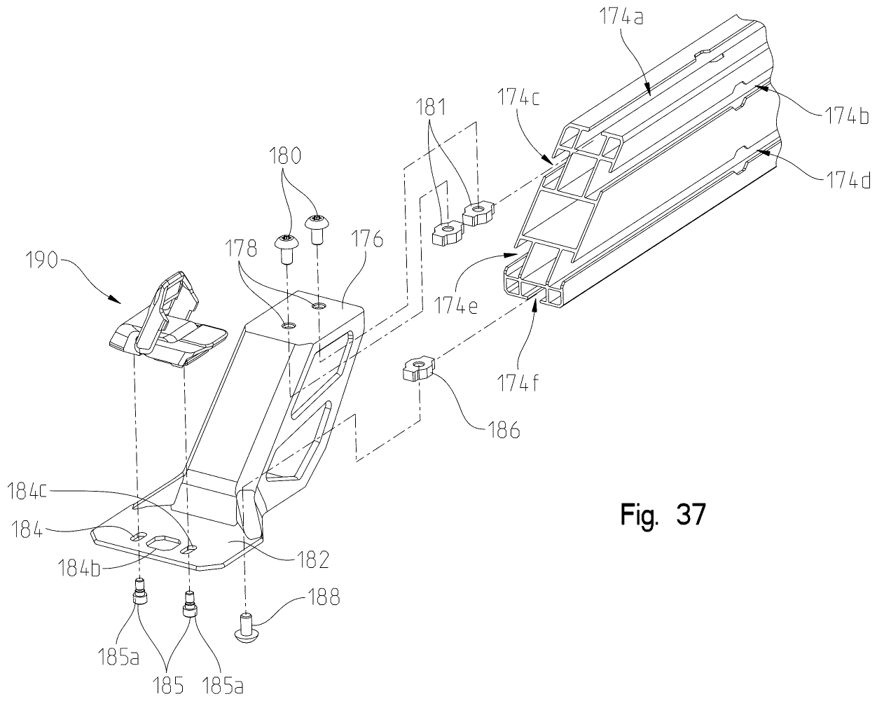

Further, with reference to FIGS. 37 and 38, the coupling of first bracket 172a to first rail 80a is illustrated. Bottom surface 182 of first bracket 172a is illustrated as having a plurality of openings, illustratively a first opening 184a, a second opening 184b, and a third opening 184c extending through bottom surface 182. FIG. 38 illustrates a bottom perspective view of coupling mechanism 190 prior to coupling with first bracket 172a.

As illustrated, coupling mechanism 190 includes a main body portion 192, a first handle 194 is in an unlocked position extending generally upward from main body portion 192 and in a second position 196 extending laterally from main body portion 192 in a locked position. Further, an underside of coupling mechanism 190 is illustrated as having a first opening 198a and a second opening 198b extending at least partially into main body portion 192. In various embodiments, openings 198 may be threaded for receiving threaded fasteners or various other coupling mechanisms. Still with reference to FIG. 38, coupling mechanism 190 includes a tab 200 extending vertically downward from main body portion 192. In assembly, first and second openings 198a, 198b are configured for receiving fasteners and tab 200 is configured for reception into an opening of a bracket or rail. Illustratively, first and second openings 198a, 198b are configured for alignment with openings 184a, 184c of bracket 172 such that fasteners 185 may extend through openings 184a, 184c and into openings 198a, 198b of coupling mechanism 190 for securing coupling mechanism 190 with bracket 172. The heads 185A of the fasteners 185 are wider than the openings 184a, c so that the coupling mechanism is engage to the bracket. The heads 185A are sized to fit within the top opening 94 of the rails 80. The fasteners 185 prevent the coupling mechanism 190 from rotating about the axis of the tab 200. The tab 200 fits through opening 184b. Further, during coupling, tab 200, which is retractable and securable by action of the handle 194, is pressed into engagement and securement with opening 184b of a second or bottom surface 182 of bracket 172 or rail 80. When the handle 194 is in the downward or locked position 196 the tab is pulled toward the underside of bottom surface 182. In the unlocked position the tab 200 is pushed away from the surface 182 to allow the tab 200 and therefore the coupling mechanism 190 to move freely withing the rail 80 of the vehicle.

While not illustrated, coupling mechanism 190 is also configured to couple with rails 80 such that when coupled with bottom surface 182 of brackets 172, coupling mechanism 190 also secures rails 80 with each bracket 172. Therefore, attachment of bracket 172 to rails 80 through coupling mechanisms 190 subsequently causes coupling of rails 80 to crossbars 170.

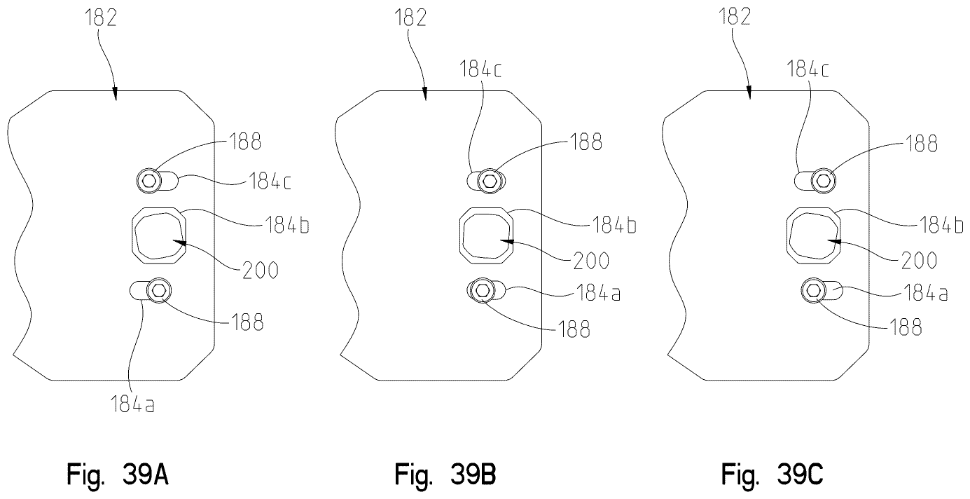

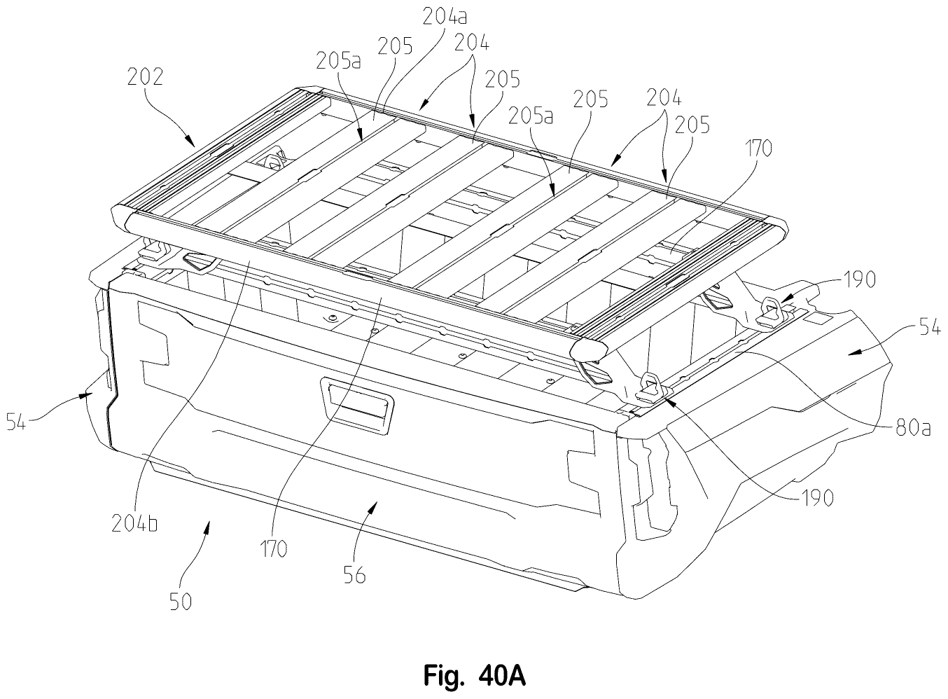

Further, the above-disclosed configuration of bottom surface 182 of bracket 172 along with coupling mechanism 190 allows for self-alignment of brackets 172 and rails 80. More specifically, the geometry and sizing of openings 184 of bracket 172 allow for brackets 172 and, thus, crossbars 170 to float on rails 80 while coupling mechanisms 190 are in an open position and accessories coupling to crossbars 170 or rails 80 may be translated along rails 80. More specifically, this provides the ability for the accessory to slide along rails 80 and for brackets 172 and thus crossbars 170 to slide along rails 80a without crossbars 170 or brackets 172 catching or stopping on rail 80. FIGS. 39A-39C illustrate bottom surface 182 of bracket 172 with the various orientations of fasteners 185 and extension within openings 184 of bracket 172 illustrating the tolerance of openings. As illustrated, coupling mechanisms 190 may be rotated and/or translated to account for sliding or movement of accessories and/or crossbars 170 while still being retained in openings 184 of brackets 172. This reduces the chance of accessories being caught on rails 80 or other elements of cargo area 30.

In operation, when an operator translates and/or rotates an accessory coupled to crossbar 170, coupling mechanisms 190 may first be actuated into an unlocked position. In the unlocked position, fasteners 185 retain the engagement between coupling mechanism 190 and mounting bracket 172 through openings 184 of mounting bracket 172. However, coupling mechanism 190 is still capable of movement relative to mounting bracket 172 and/or rails 80. For example, as the operator moves crossbar 170, and thus mounting bracket 172, the positioning of fasteners 185 within openings 184 may translate, for example as illustrated in FIGS. 39A-39C, and allow for relative movement between mounting bracket 172 and coupling mechanism 190. In this way, catching of coupling mechanism 190 onto rail 80 during movement is reduced, and as such, any interference from coupling mechanism 190 during adjustments of the accessory and/or crossbar 170 is reduced. Once the accessory and/or crossbar 170 is in the desired position, coupling mechanism 190 may be actuated into a locked position to secure the positioning of crossbars 170 onto rails 80.

As previously described with reference to FIGS. 35-39C, crossbars 170 may provide the opportunity for increasing accessory mounting space. Even further, additional rails 80 may be coupled to and stacked vertically on top of crossbars 170 or a base for additional cargo storage may be coupled with crossbars 170 of cargo area 30.

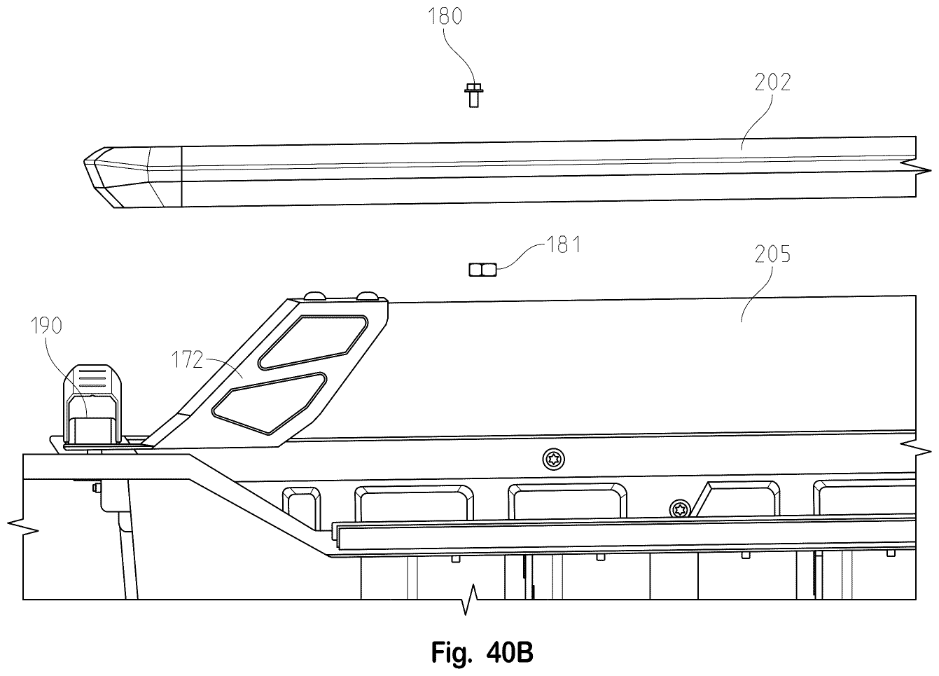

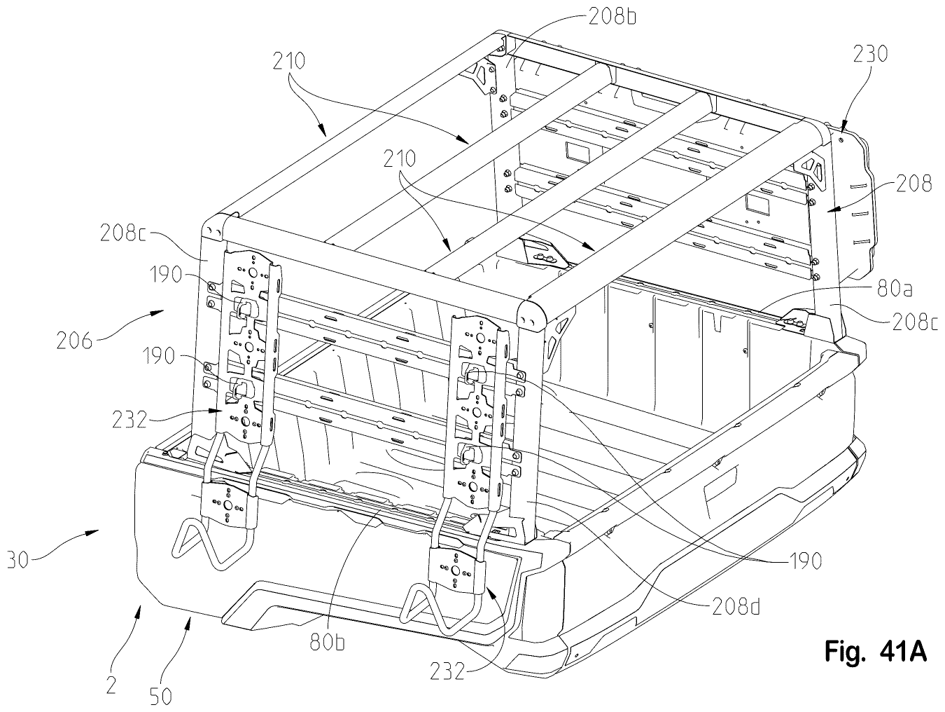

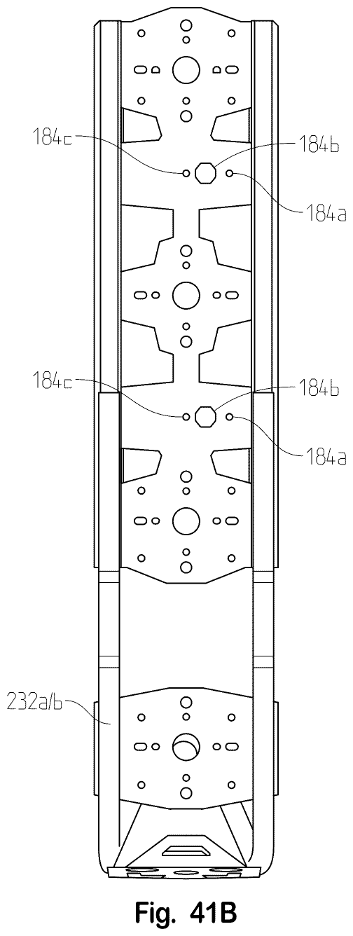

Referring now also to FIGS. 40A and 40B, a cargo base 202 coupled onto crossbars 170 and having a plurality of rack rails 204 each having cross members 205 having a channel 205A configured for receiving additional accessories or accessory coupled means. The cross members 205 may be perpendicular to the crossbars 170 to which they are coupled. Channels 205A may be the same, or similar to, channels 96 as described with reference to FIGS. 13-17. More specifically, channels 205A may include ports 124 extending along channels 205A. In this way, not only do crossbars 170 provide an additional mechanism of attaching accessories, but crossbars 170 also provide for additional mounting of rails 80 which may then also support accessories. Further, due to the coupling of crossbars 170 onto rails 80, the positioning of cargo base 202 and any other rails 80 may be adjusted and easily controlled by the operator. For example, the sizing of cargo base 202 may be decreased and cargo base 202 may slide laterally along rails 80 and shift in positioning. Further, additional rails 80 may be mounded onto cargo base 202 and stacked vertically upward. Additional rails 80 may be coupled with cargo base 202 through fasteners and/or coupling mechanism 190 (FIG. 28). While illustrated with one cargo base 202 in FIG. 39, any number of cargo bases and/or additional rails may be stacked onto crossbars 170 and incorporated in use with cargo area 30. The rack rails 204 may have ends 204A, 204B that may be used as support for the rack rails 204 and may provide a finished look.

In FIG. 40B the coupling of the cargo base 202 to the crossbar 170 is illustrated. Fasteners 180 coupled to elongated nuts 181 may extend from within the channels 205A into the channel 174A of one or more crossbars 170. In one example, four fasteners 180 and four elongated nuts 181 were used.

Referring now to FIGS. 41A-43B, an additional structure that may be mounted onto rails 80 for increasing the space available for supporting accessories within cargo area 30. Illustratively, a cargo overhead rack 206 may be coupled to rails 80 of cargo box 50 to provide further additional mechanisms and space available for coupling accessories and supporting items within cargo box 50. As illustrated, cargo overhead rack 206 includes a plurality of upstanding members or posts 208 extending from rails 80, including a first upstanding post 208a coupled with a second upstanding post 208b positioned opposite first upstanding post 208a. Cargo overhead rack 206 may additionally include a third upstanding post 208c coupled with a fourth upstanding post 208d positioned opposite third upstanding post 208c. Each pair of upstanding posts 208 may be coupled through the use of longitudinally extending coupling braces 224. Further, cargo overhead rack 206 includes a plurality of cross braces 210 extending laterally between upstanding posts 208.

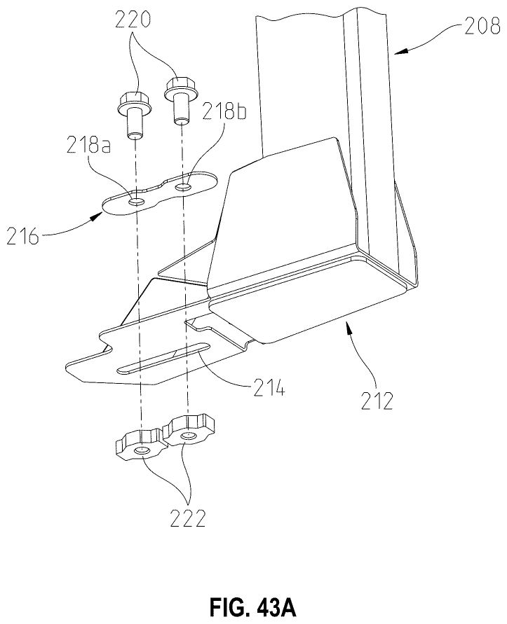

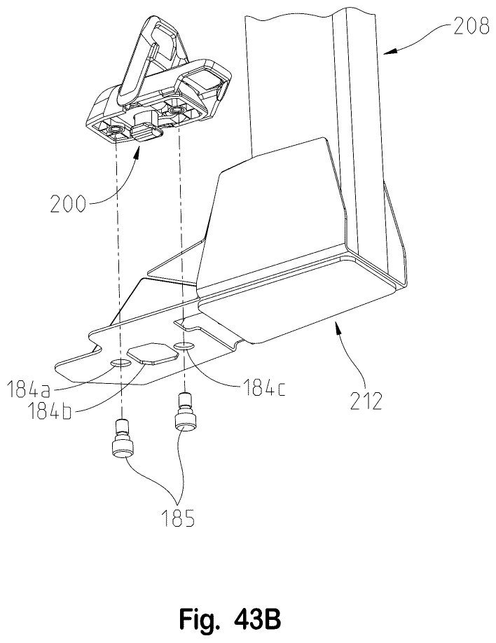

At a bottom most extent of each upstanding post 208, each upstanding post 208 includes a coupling bracket 212 for coupling upstanding posts 208 to rails 80 of side panels 54 of cargo box 50. As best illustrated in FIG. 43A, coupling bracket 212 includes a slot 214 configured for alignment with a panel 216 having a first opening 218a and a second opening 218b. Panel 216 is configured for reception within top channel 96 of rail 80, and after alignment of first and second openings 218a, 218b with slot 214, slot 214 and openings 218 may receive fasteners 220 configured for engagement with elongated nuts 222. In this way, each of upstanding posts 208 is secured with rails 80 through coupling brackets 212 and maintains the structure and integrity of cargo overhead rack 206.

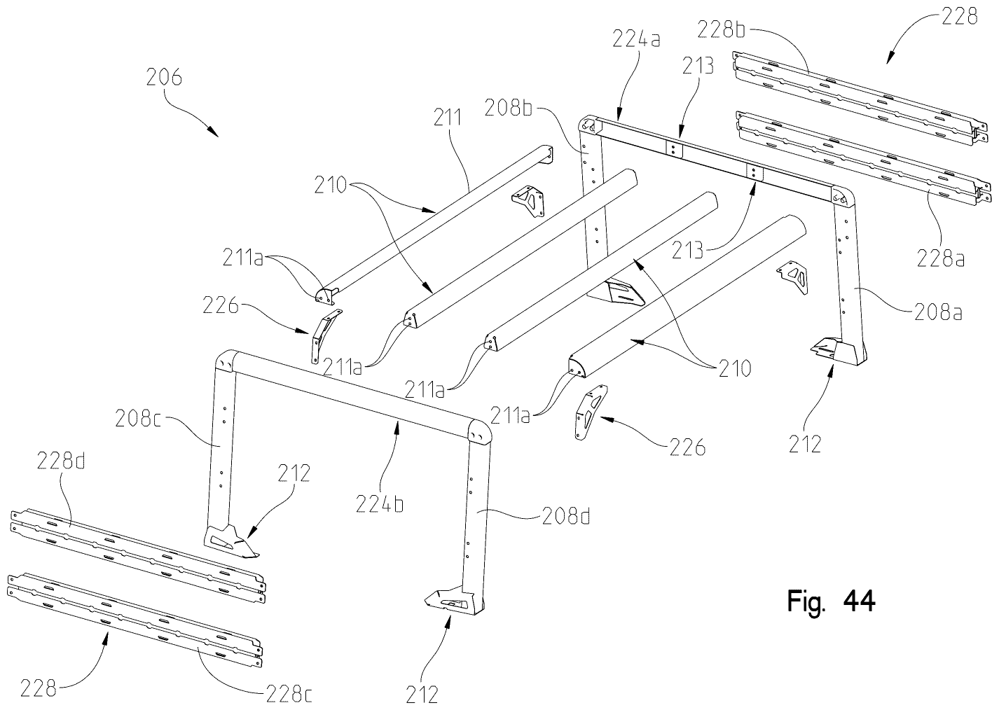

Further, as illustrated in the exploded view of FIG. 44, various of plurality of cross braces 210 may be coupled to upstanding posts 208 through the use of coupling brace 224. More specifically, as illustrated, overhead rack 206 includes a first coupling brace 224a extending laterally between first and second upstanding posts 208a, 208b and a second coupling brace 224b extending laterally between third and fourth upstanding posts 208c, 208d. As illustrated, two of cross braces 210 are coupled at coupling areas between upstanding posts 208 and coupling braces 224. Further, two central cross braces 210 are coupled directly to coupling braces 224. As illustrated, each of cross braces 210 include a housing 211 with plurality of openings 211a for aligning with openings 225 of coupling braces 224 and receiving fasteners to couple cross braces 210, coupling braces 224 and upstanding posts 208. Further, as illustrated, at least two engagement features 226 may be used for securing the coupling between upstanding posts 208, cross braces 210, and coupling braces 224.

As illustrated in FIGS. 41A-43B, cargo overhead rack 206 includes a plurality of side rails 228 extending longitudinally relative to the vehicle 2. As illustrated, a first rail 228a and a second rail 228b extending longitudinally between first and second upstanding posts 208a, 208b. Rails 228 may be the same as, or similar to, rails 80 of cargo box 50 in the purpose and functionality of rails 228. However, rails 228 may differ from rails 80 in the profile of rails 228. For example, rails 228 may be generally linear in profile and may not have the indented or otherwise irregular profile of rails 80. Rails 228 do not require engagement with side panel 54, but rather are illustrated as only fastened to upstanding posts 208. However, the profile and configuration of rails 228 may be varied and the coupling of rails 228 may be varied. Further, cargo overhead rack 206 includes a third rail 228c and a fourth rail 228d extending longitudinally relative to the vehicle 2 between third and fourth upstanding posts 208c, 208d. Rails 228 may be coupled to upstanding posts 208 with various coupling mechanisms, illustratively fasteners extending into upstanding posts 208, however, other coupling mechanisms may be incorporated. For example, rails 228 may be coupled to upstanding posts 208 through the use of coupling mechanisms 190 (FIG. 38). This may provide the advantage of rails 228 being capable for positioning at different vertical heights along upstanding posts 208 and therefore may provide flexibility in the configuration of cargo overhead rack 206.

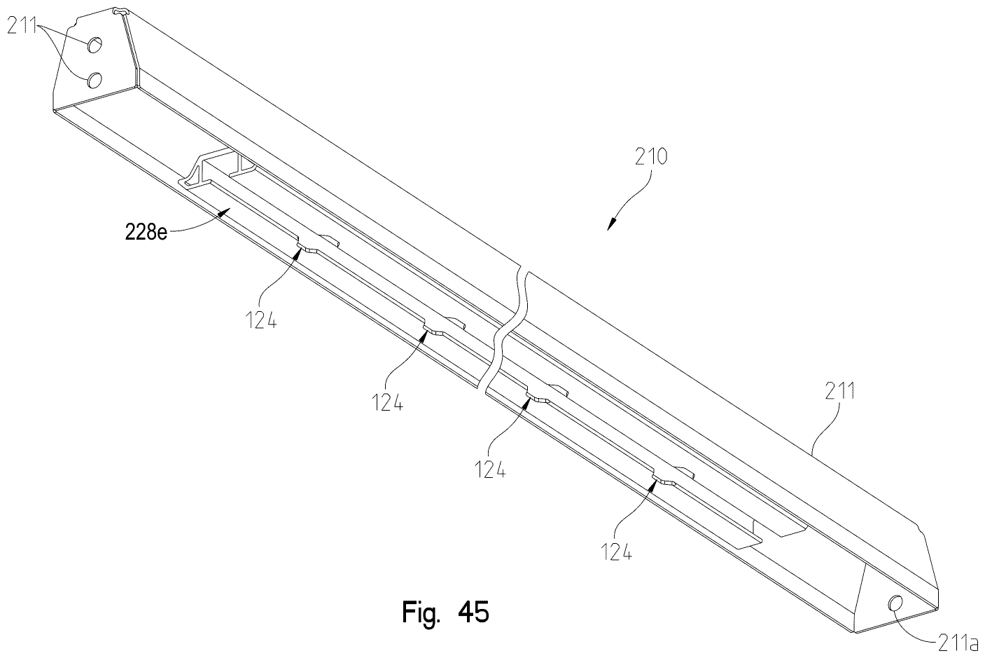

Further, while illustrated as having four rails 228, cargo overhead rack 206 may include any number of rails 228. For example, in some embodiments, rails 228 may include only one rail 228 or may include five or more rails 228. Further, in some embodiments, crossbars 170 may have rails 228 embedded within an underside of crossbars. For example, FIG. 45 illustrates a bottom, perspective view of one of cross braces 210 with an overhead rail 228e extending within cross brace 210 such that accessories or coupling mechanisms may be engaged with cross brace 210. Cross brace 210 may also be used for storage and attachment of accessories within cargo area 30. In this way, accessories may hang from cross braces 210 and be supported within cargo area 30 without occupying space on floor 58. Overhead rails 228, cross braces 210, and/or coupling braces 224 may be extended in length in order to increase the size of cargo overhead rack 206 and the space available for coupling and supporting of additional accessories. As a result, cargo overhead rack 206 may be used with varying sizes of cargo area 30, for example a cargo area that may be used with a 6×6 vehicle rather than a 2×2 or 4×4 vehicle. Similarly, rails 228, cross braces 210, and/or coupling braces 224 may be reduced in length such that cargo overhead rack 206 may be decreased in size and used with a vehicle having a smaller cargo area than that of vehicle 2.

In FIG. 43B a coupling mechanism 190 may be used to secure the overhead rack 206 to the rails 80 in a similar manner to FIGS. 37 and 38 at the brackets 212. The openings 184a, 184b and 184 receive fastener 185, tab 200 and fastener 185 of the coupling mechanism 190 respectively.

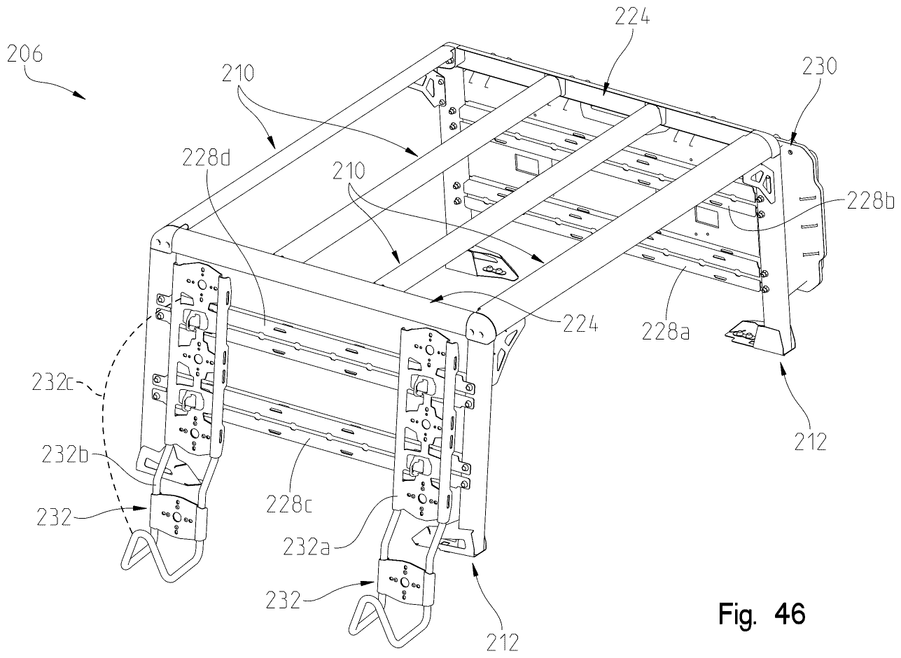

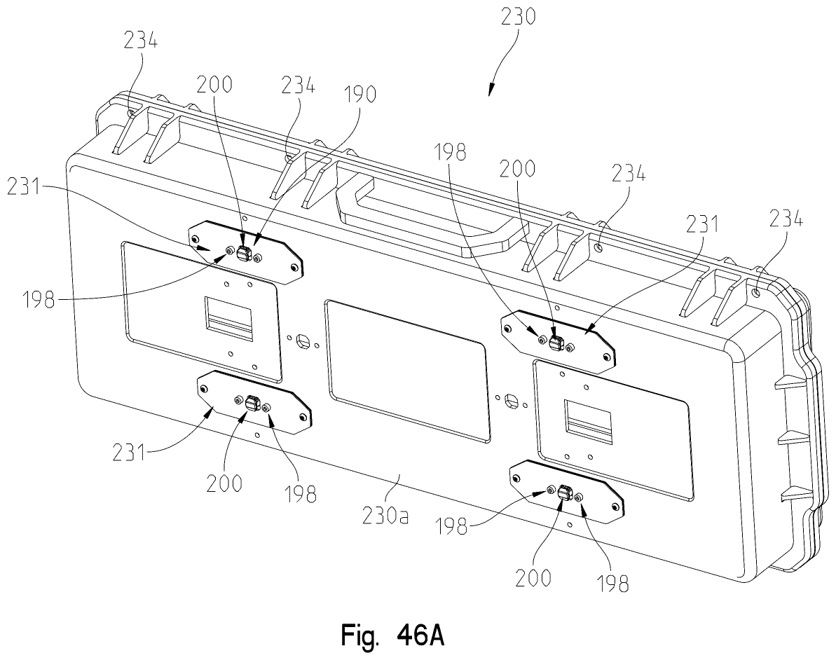

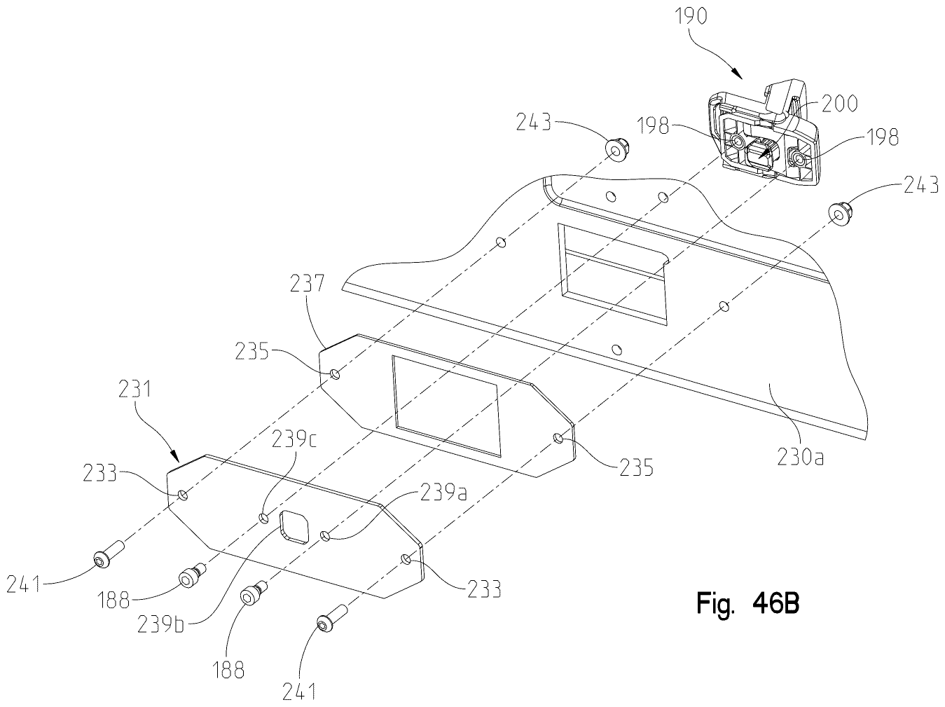

With reference to FIGS. 46-46B, the ability for rails 228 to support additionally accessories onto cargo overhead rack 206 will be described further. For example, FIG. 46 illustrates cargo overhead rack 206 with a plurality of accessories attached. For example, first and second rails 228a, 228b are engaged with a storage box 230, for example a toolbox using at least two coupling mechanisms. As illustrated four coupling mechanisms are provided; two for each side rail. The coupling mechanisms 190 are coupled to a side wall 230A with brackets 231. Further, third and fourth rails 228c, 228d may support and engage with a first accessory support 232a and a second accessory support 232b. First and second accessory supports 232a, 232b may be bracket-like features configured for supporting additional tools and other equipment that may be supported within cargo area 30. For example, first and second accessory supports 232a, 232b may be used in combination with straps 232c that may secure the equipment to first and second accessory supports 232a, 232b. In this way, accessory supports 232 provide additional methods for securing accessories and/or tools within cargo area 30. In FIG. 41B the back side of the accessory supports 232 is illustrated. The back side includes two sets of openings 184a, 184b and 184c for receiving the couplers illustrated in FIG. 41A.

FIG. 46A illustrates a rear view of storage box 230, which may be configured for supporting a gun, a bow and arrow, or various other desired tools. As illustrated, a rear surface of storage box 230 includes locking features 234 configured for locking storage box 230 in a closed position. Locking features 234 are positioned spaced along the rear surface of storage box 230 and may require a key, lock combination, or other customizable element for unlocking locking features 234. Locking features 234 may maintain storage box 230 in a closed configuration until proper credentials are used to open storage box 230. As will be described further herein, this configuration provides the advantage of an operator or passenger needing valid credentials to both open storage box 230 and remove storage box 230 from overhead rack 206, increasing the security with which accessories may be stored within storage box 230 arranged within cargo area 30.

The coupling of storage box 230 with rails 228 will be described further herein. As illustrated, the rear surface of storage box 230 includes at least four brackets 231 configured for receiving coupling mechanisms 190 (FIG. 38) through an interior region of storage box 230. As illustrated in FIGS. 46A-46B, bracket 231 comprises openings 239 configured for receiving fasteners 188 which may engage with openings 198 of coupling mechanism 190. Bracket 231 additionally includes openings 233 positioned towards an outer edge of bracket 231 which may align with openings 233 of plate 237 after lateral alignment of bracket 231 and plate 237. After bracket 231, mounting plate 237 and the rear surface of storage box 230 are laterally aligned, openings 233, openings 233, and openings 247 may receive fasteners 241 which may then engage with weld nuts 243 on an opposing side of a rear surface of storage box 230 to secure bracket 231 and plate 237 positioning onto storage box 230.

As previously described, coupling mechanism 190 is also configured for engaging with storage box 230 and brackets 231. Coupling mechanisms 190 are positioned within an interior region of storage box 230 and against the rear surface of storage box 230. During assembly, openings 198 of coupling mechanisms 190 are aligned with openings 239 of brackets 231 and may receive fasteners 188 which extend through bracket 231, plate 237, and the rear surface of storage box 230. Additionally, tab 200 of coupling mechanism 190 is configured for engagement with a second opening 239b of openings 239 of bracket 231. In this way, coupling mechanisms 190 may be used for securely coupling storage box 230 with rails 228 of cargo overhead rack 206. Tabs 200 may then engage with ports 124 of rails 228 to allow for secure coupling with rails 228 once coupling mechanisms 190 are actuated into the retain configuration.

Among other advantages, the above-described configuration allows for coupling mechanisms 190 to be arranged within storage box 230 and, therefore, may be concealed from view while still accomplishing the purpose of coupling storage box 230 with rails 228. Additionally, in some embodiments and for security purposes, for coupling mechanisms 190 to be released and storage box 230 to be removed from cargo overhead rack 206, the proper credentials for locking features 234 may be required.

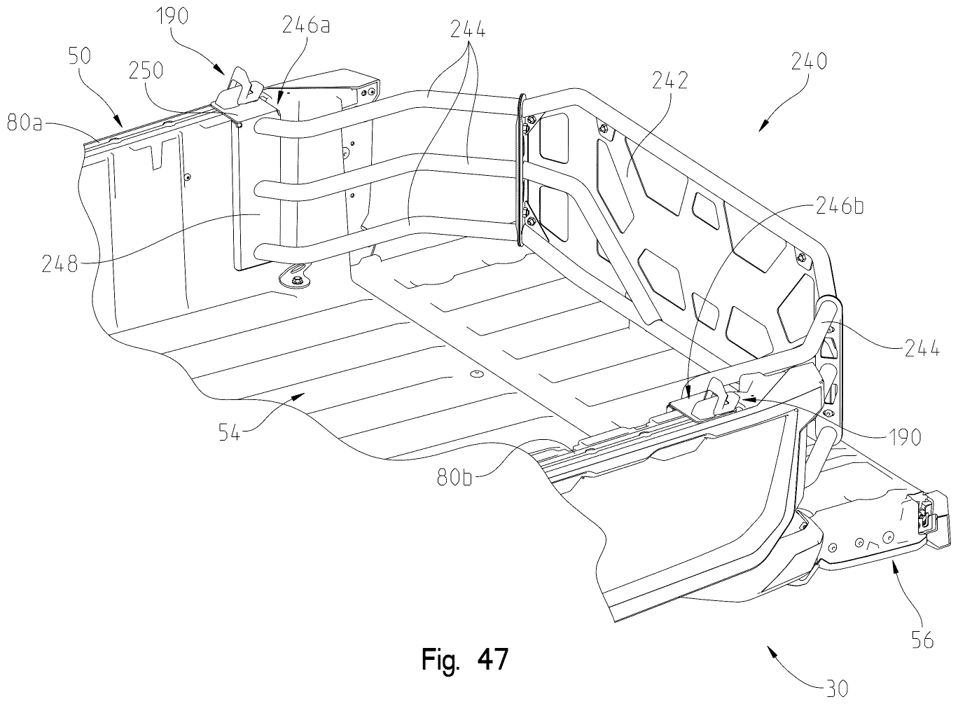

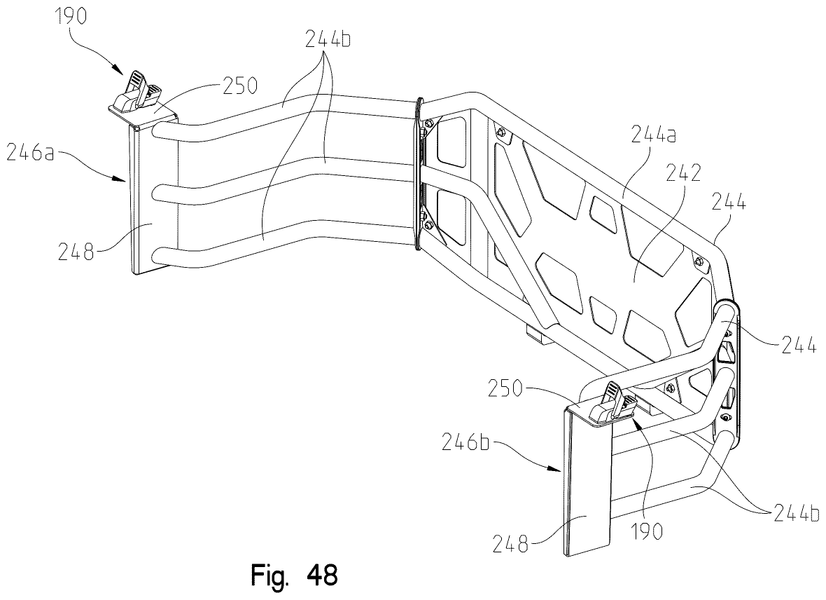

FIG. 47 illustrates an additional apparatus that may be used for optimizing the space within cargo area 30 for holding accessories. Specifically, FIG. 47 illustrates a cargo area extender 240 coupled with rails 80 of side panels 54 of cargo box 50 when the tailgate is in the lowered position Specifically, cargo area extender 240 has a main panel 242 with a plurality of curved bars 244 that have a straight portion 244A adjacent the main panel 242 and extending from main panel 242. The curved portion 244B extend from the straight portions 244A. Illustratively, three of the plurality of curved bars 244 are coupled with a first plate 246a and the remaining three curved bars 244 are coupled with a second plate 246b. As illustrated in FIGS. 47 and 48, each of plates 246a, 246b are illustrated as having a vertically extending portion 248 and a laterally extending portion 250. More specifically, first plate 246a includes a vertically extending portion 248a and a laterally extending portion 250a while second plate 246b includes a vertically extending portion 248b and a laterally extending portion 250b. Laterally extending portions 250a, 250b of each plate 246a, 246b are illustrated as being configured for receiving a coupling mechanism, for example coupling mechanism 190 as described previously, for securing plates 246a, 246b to rails 80. In the illustrative embodiment of FIGS. 47-48, rails 80 have a single channel profile such that channel 96 with ports 124 extends along a top surface of side panels 54. Plates 246 thus are configured such that horizontally extending portions 250 may rest on top of rails 80 and may each have openings (not shown) configured for receiving coupling mechanisms 190 for engagement with rails 80. Cargo area extender 240 works to increase the space available for securing accessories within cargo area 30 primarily when tailgate 56 is arranged in the downward configuration.

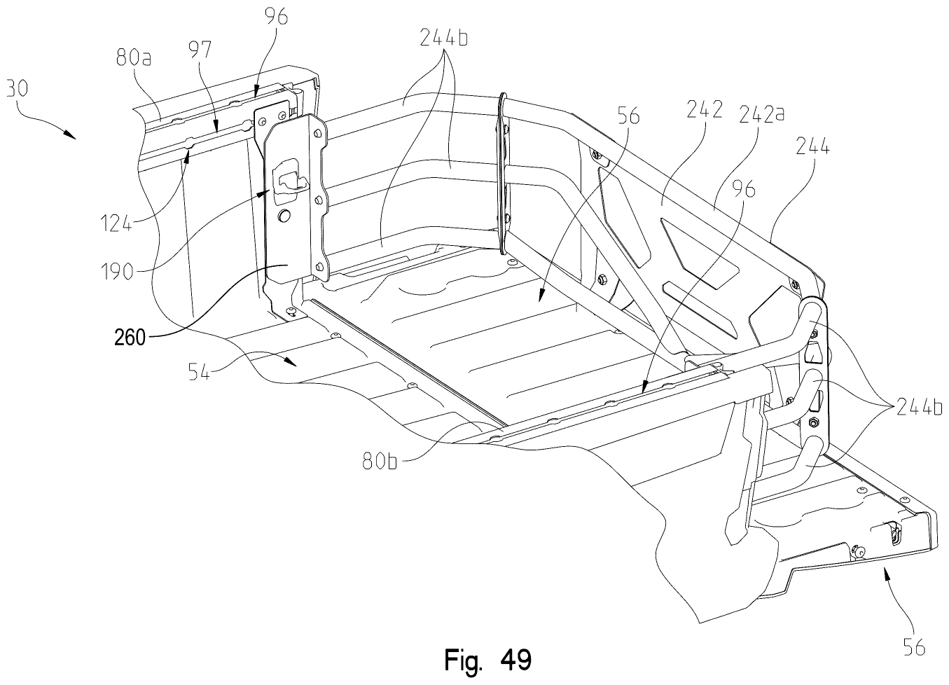

Additionally, as illustrated in FIGS. 49-51, cargo area extender 240 may also be used with cargo area 30 in the configuration as discussed with references to FIGS. 8-9, in which rails 80 include the dual channel profile. More specifically, this configuration may be preferentially used when cover 44 (FIG. 8) is used in combination with cargo box 50. In this application, cargo area extender 240 is substantially the same as illustrated with reference to FIGS. 47-48, however, the plates for coupling main panel 242 with rails 80 is modified. For example, rather than curved bars 244 coupling with plates 246, each of curved bars 244 is illustrated as coupling with plates 260.

Each of plates 260 includes a first portion 262 coupled with curved bars 244 and a second portion 264 extending generally perpendicularly to first portion 262. Second portion 264 includes a plurality of openings, illustratively a first opening 266a positioned vertically above a second opening 266b which is positioned vertically above a third opening 266c. Further, second portion 264 includes a protrusion 268 extending generally outward from second portion 264.

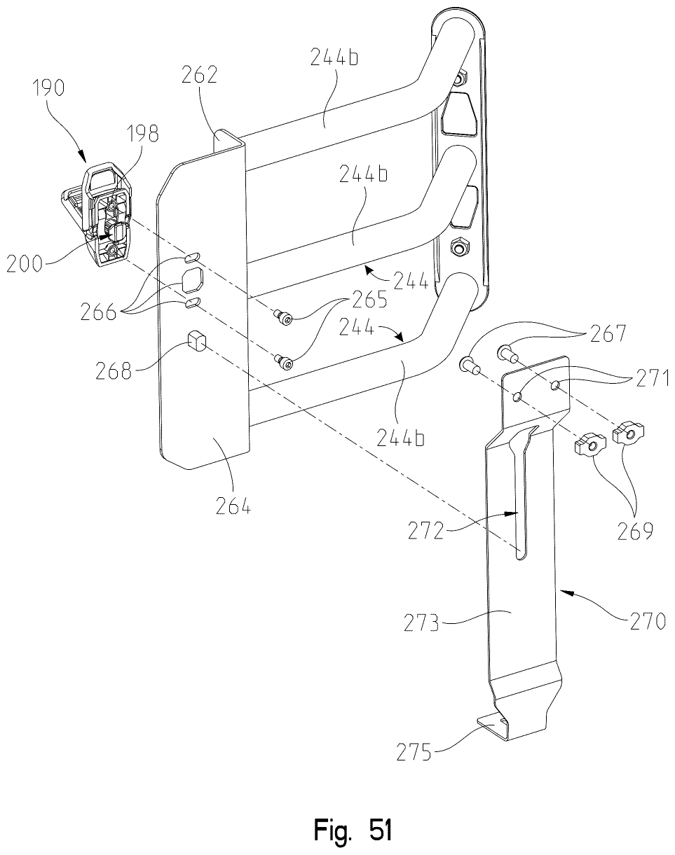

Plates 260 are configured for coupling with an intermediate member such as brackets 270, as will be described further herein. With reference primarily to FIG. 51, brackets 270 include a vertically extending portion 273 and a horizontally extending portion 275 at a bottom most extent of bracket 270. Vertically extending portion 273 includes a vertically extending slot 272 and a plurality of openings 271 positioned vertically above slot 272. During the coupling of plates 260 with brackets 270, brackets 270 are arranged laterally adjacent plates 260 such that protrusion 268 extends within slot 272 and openings 266 are aligned with slot 272. Further, horizontally extending portion 235 of brackets 270 are arranged vertically below plates 260. Once aligned, coupling mechanism 190 may be configured to couple plates 260 and brackets 270. Illustratively, tab 200 of coupling mechanism 190 may be received through second opening 266b of plate 260 and through slot 272 of bracket 270. Further, fasteners 265 may be inserted through first and third openings 266a, 266b of plate 260 for securing coupling mechanism 190 with plates 260. In this way, coupling mechanism 190 may be actuated between a secure position and a release position for coupling or uncoupling brackets 270 with plates 260 and the remainder of cargo bed extender 240.

Brackets 270 are independently secured to rails 80 through the use of fasteners 267 and elongated nuts 269. As best illustrated in FIG. 49, brackets 270 may be aligned with rails 80 such that openings 271 are aligned with channel 97 of rail 80. Fasteners 267 may extend into channel 97 and engage with elongated nuts 269 within channel 97 to secure brackets 270 to rails 80. Additionally, horizontally extending portion 275 may include an opening configured for receiving fastener 267 to secure horizontally extending portion 235 to floor 58. As a result of the above configuration, cargo bed extender 240 may be easily removed and reattached to rails 80 and thus cargo box 50 without requiring the repeated removal and reattachment of brackets 270.

While cargo area extender 240 is illustrated as extending longitudinally rearward of side panels 54 to extend the floor space available within cargo area 30, cargo area extender 240 may be adjusted such that vertically extending portion 248 and plates 260 may be positioned within cargo area 30. In this way, cargo area extender 240 may pivot inwards and permit the pivoting of tailgate 56 upwards to close cargo area 30. This configuration provides additional flexibility to cargo area 30 such that floor space may be optimized when needed and when no longer needed, the floor space may be reduced.

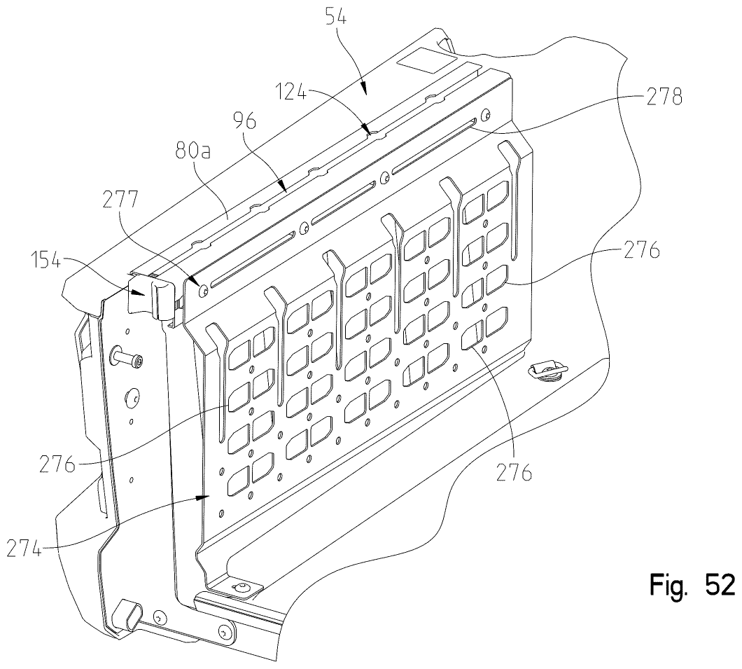

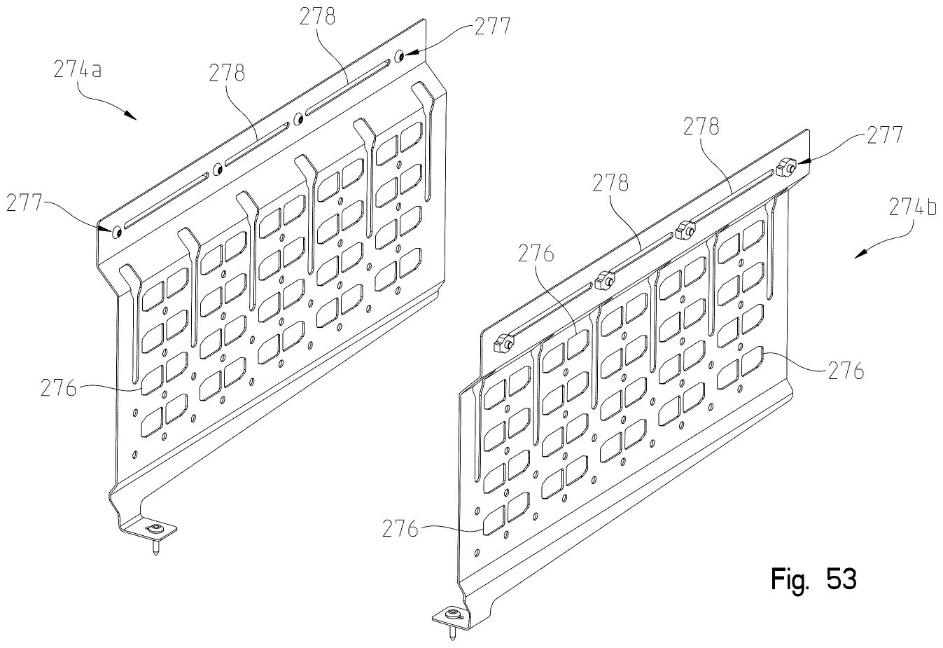

FIGS. 52-53 illustrate an additional apparatus and mechanism for optimizing the area within cargo box 50 for supporting additional accessories. Specifically, an accessory rack 274 is illustrated as being coupled to rails 80 when rails 80 are positioned along inner surface of side panels 54. Specifically, accessory rack 274 is illustrated in use with the dual channel profile of rails 80 as shown and described further with reference to FIG. 20. However, in various other embodiments, accessory rack 274 may be used in combination with the configuration illustrated in FIGS. 10-17. Further, while illustrated as being positioned on one side panel 54 in FIG. 52, cargo box 50 may include a first accessory rack 274a coupled with first rail 80a and a second accessory rack 274b that is positioned on the opposing side panel 54 (FIG. 10) and coupled with second rail 80b (FIG. 10). As illustrated, second accessory rack 274b may be similar to or the same as first accessory rack 274b. The incorporation of a first and second accessory rack 274a, 274b may optimize the space available for supporting accessories within cargo box 50.

With reference to FIGS. 52-53, first and second accessory racks 274a, 274b are coupled to rails 80 along inner surface of side panels 54. As illustrated, accessory racks 274 include each a plurality of slots 278 extending laterally between fasteners 277 and fasteners 277 may be configured for coupling accessory racks 274a, 274b with one of rails 80. As illustrated in FIG. 52 with reference to first accessory rack 274a, when fasteners 277 are used to couple accessory rack 274a with first rail 80a, slots 278 may be aligned with side channel 97 of first rail 80a such that coupling mechanism 190 may be used with accessory rack 274a and first rail 80a. While the above description is primarily made with reference to the coupling of first rail 80a and first accessory rack 274a, it may also apply to the coupling of second rail 80b with second accessory rack 274b.

As illustrated in FIG. 53, accessory racks 274a, 27b each include openings 276 configured for attaching accessories to rack 274 for additional carrying of items within cargo area 30. For example, hooks, fasteners, or other coupling mechanisms may be engaged with openings 276 to attach one or more accessories to accessory racks 274a, 274b. Spacings between openings 276 may be approximately 116 mm apart, however various other distances may be incorporated based on the desired function of accessory racks 274a, 274b. In this way, both slots 278 and openings 276 may be used for supporting additional accessories onto one or both of accessory rack 274a, 274b. Further, accessory racks 274a, 274b may be used for mounting of cargo area extender 240. In other words, coupling mechanisms 190 may be used to mount cargo area extender 240 to openings 276 of accessory racks 274a, 274b. In this manner the accessory racks 274a, 274b acts as an intermediate member to join the cargo extender 240 to the rails 80.

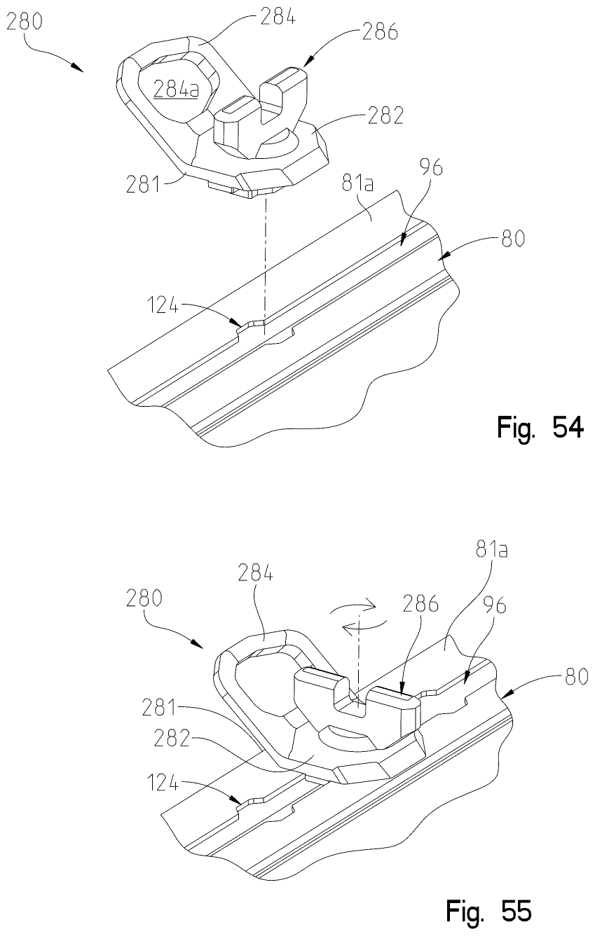

Referring now to FIGS. 54-56E, with each of the embodiments described herein, the coupling mechanisms may be used for mounting and attaching accessories to cargo area 30, as has been described with reference to coupling mechanism 190. FIGS. 54-56E illustrate an additional embodiment of a coupling mechanism 280 that may be used with mounting accessories herein. Specifically, coupling mechanism 280 is illustrated having a body with a body portion 282 and an attachment portion 284, illustratively a ring portion, extending at an angle from a first side of the body portion 282. The attachment portion 284 is configured for receiving accessories or coupling to accessories, such as for receiving hooks to couple accessories with. As illustrated, attachment portion 284 has a width and a length, the width being greater than the length so that several hooks or coupling mechanisms may be accommodated. An opening 284A of the attachment portion 284 is an irregular D-shape in this example.

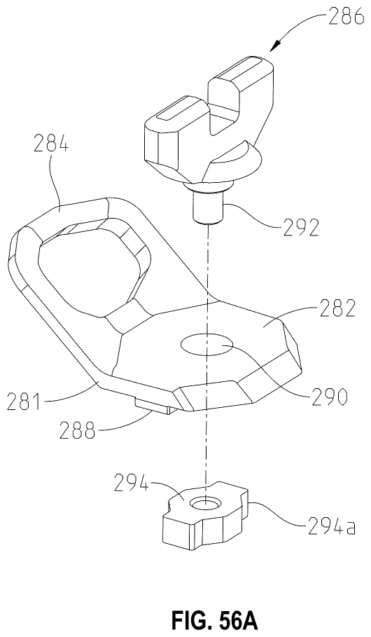

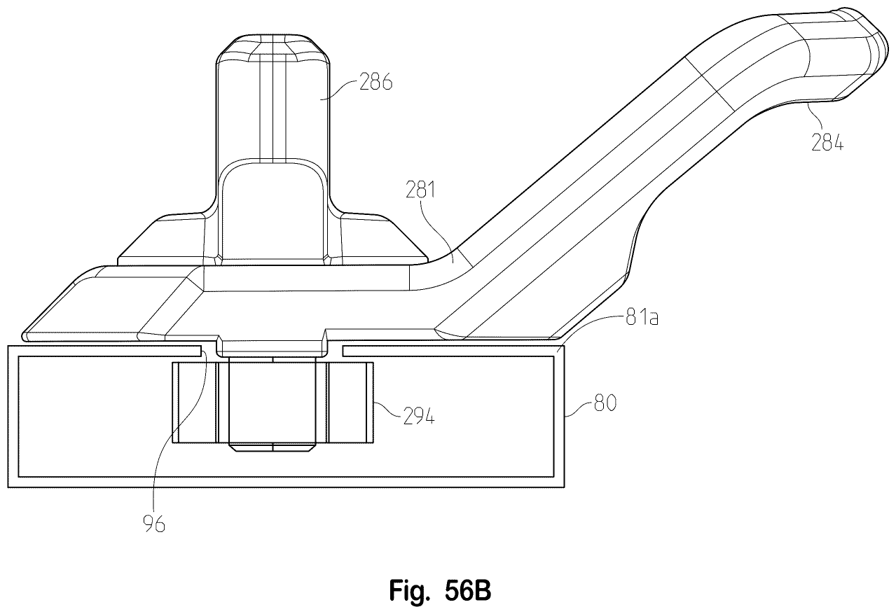

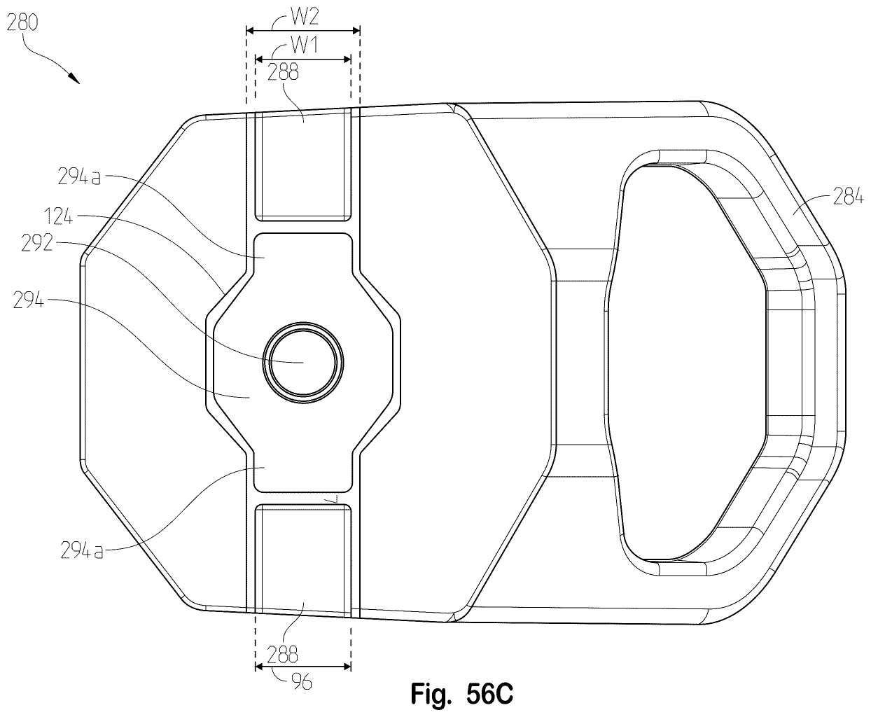

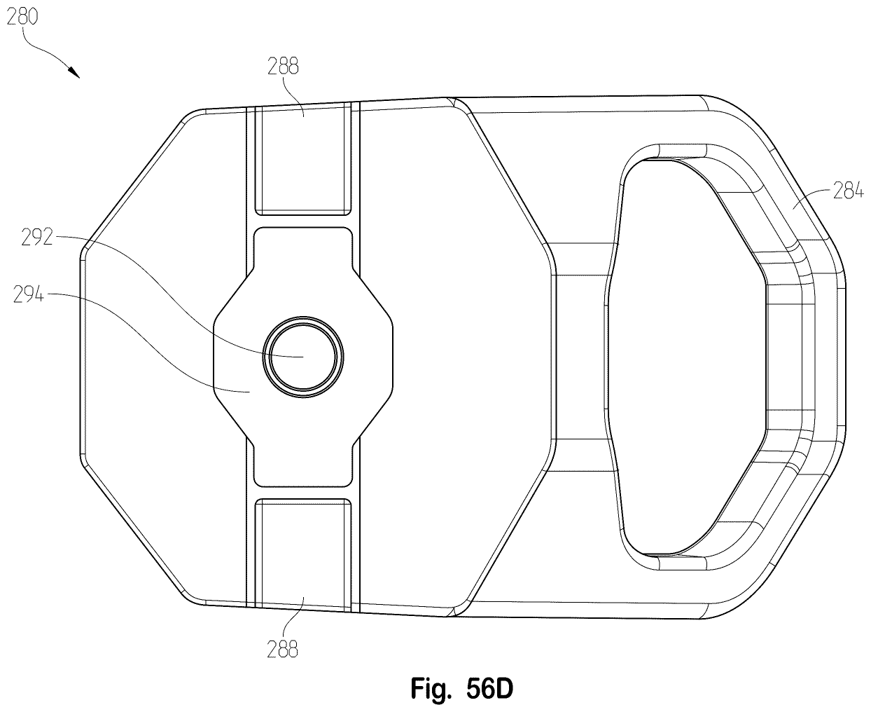

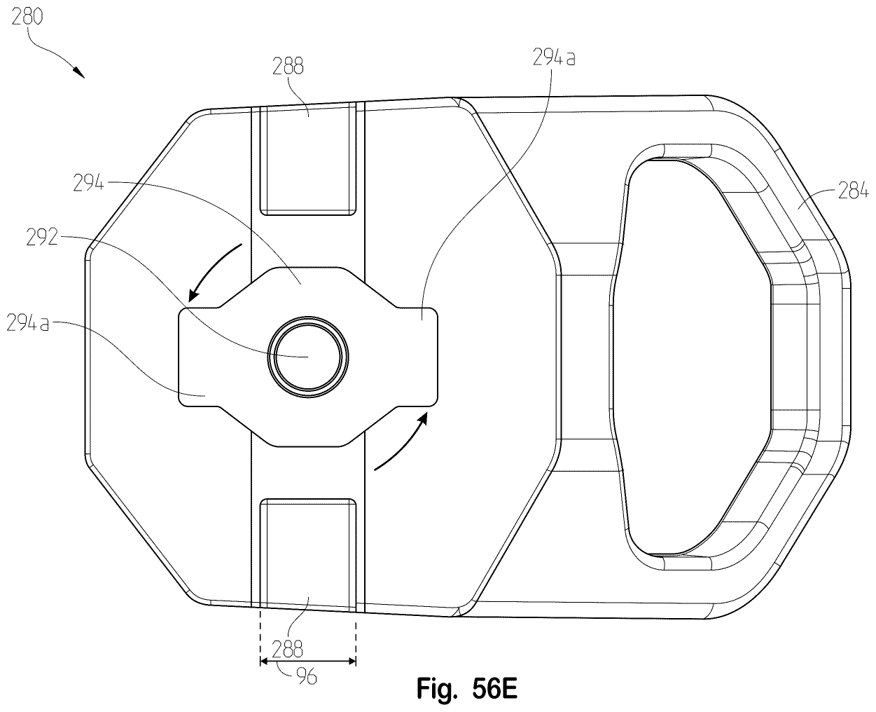

Coupling mechanism 280 additionally includes a handle 286 disposed at the first side of the body portion 282 which may be used by an operator for securing coupling mechanism into rails 80. As shown in FIGS. 56A-E, handle 286 includes an axle or tab 292 extending outwardly and configured for rotatable reception through an opening 290 of body portion 282. Further, body portion 282 comprises an alignment feature 288 extending from the second side of the body portion 282. Alignment feature 288 is configured to aid in the correct positioning of coupling mechanism 280 onto rail 80a. For example, during attachment of coupling mechanism 280 to one of rails 80, illustratively first rail 80a, coupling mechanism 280 may be aligned and arranged onto first rail 80a such that alignment feature 288 engages with an edge of the channel 96 to indicate to an operator that coupling mechanism 280 is aligned with port 124. In this position, tab 292 of handle 286 may extend downwardly into port 124 and engage with an engagement device such as an elongated nut 294 that is arranged within channel 96. As illustrated in FIG. 55, once coupling mechanism 280 is properly positioned within port 124, handle portion 286 may be rotated to securely engage the engagement device such as the extensions 294A of the elongated nut 294 with the underside of the surface adjacent the channel 96 of the rail 80 and secure positioning of coupling mechanism 280 into rail 80. The elongated nut 294 is disposed between two portions of the alignment feature 288. When the extensions 294A of the of the elongated nut 294 are inserted into the channel 96 the portion of the alignment features 288 and the extensions 294A are colinear. The rotation of handle portion 286 may cause rotation of tab 292 into secured engagement with elongated nut 294 such that vertical motion of coupling mechanism 280 is prohibited. An operator may rotate handle 286 to the first positioning as illustrated in FIG. 54 to release the engagement between first rail 80a and coupling mechanism 280.

The above-described configuration of coupling mechanism 280 and the rotation of handle 286 to allow for releasing or securing of coupling mechanism 280 allows coupling mechanism 280 to slide within channel 96 between ports 124 and be easily secured once positioned at the desired port 124. Once coupling mechanism 280 is secured within rail 80, attachment portion 284 may be used for attachment and securement of additional accessories within cargo area 30. Additionally, while coupling mechanism 280 is illustrated as incorporating alignment feature 288 for direct alignment with ports 124, various other mechanisms for alignment of coupling mechanism 280 and/or coupling mechanism 190 may be incorporated into cargo box 50 directly. For example, registration features or tabs may be incorporated into rail 80 or side panel 54 to aid in alignment with coupling mechanisms 190, 280. Further, coupling mechanism 190 and/or coupling mechanism 280 may be altered to incorporate a living hinge within a handle portion in order to the release and/or secure coupling mechanisms. Additionally, various other coupling mechanisms may be used as a toolless mechanism to couple accessories with rails 80 and/or crossbars 170. For example, in some embodiments, a retainer system similar to the retainer system as described in U.S. patent application Ser. No. 17/380,126, titled “Article Mounting System for a Vehicle,” and filed on Jun. 20, 2021, the entire disclosure of which is incorporated herein by reference, may be used as the coupling mechanism described herein.

FIG. 56C is a bottom view of the coupling mechanism 280 of FIGS. 54-56B aligned in a port 124 of a rail during insertion corresponding to FIG. 54. The extensions 294A are parallel with the opening 94 of the channel 96 during insertion.

FIG. 56D is a bottom view of the coupling mechanism 280 of FIGS. 54-56B aligned in the channel 96 of the rail 80 away from the port 124 after insertion. The alignment features 288 have a width W1 just narrower than the width W2 of the channel 96.

FIG. 56E is a bottom view of the coupling mechanism 280 of FIGS. 54-56B aligned in the channel 96 in a locked position. That is, the elongated nut 294 is rotated by movement of the handle 286 so that the extensions 294A are perpendicular to the channel 96.

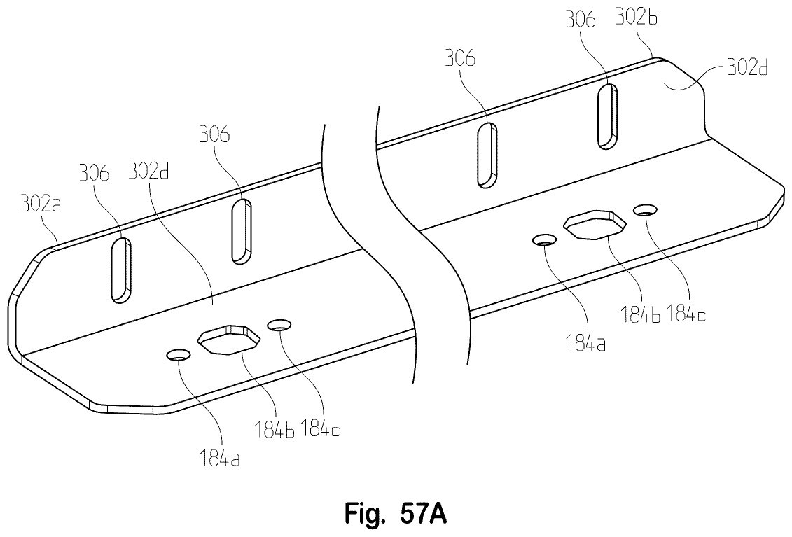

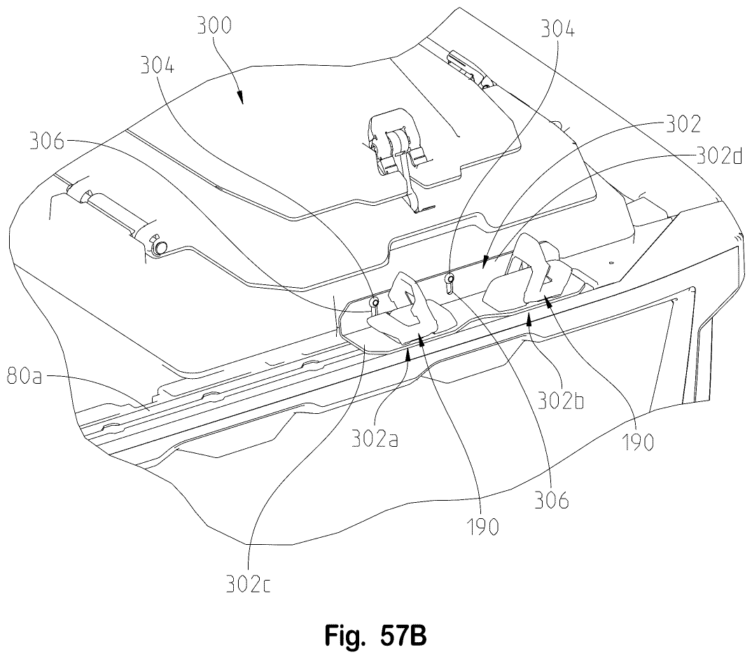

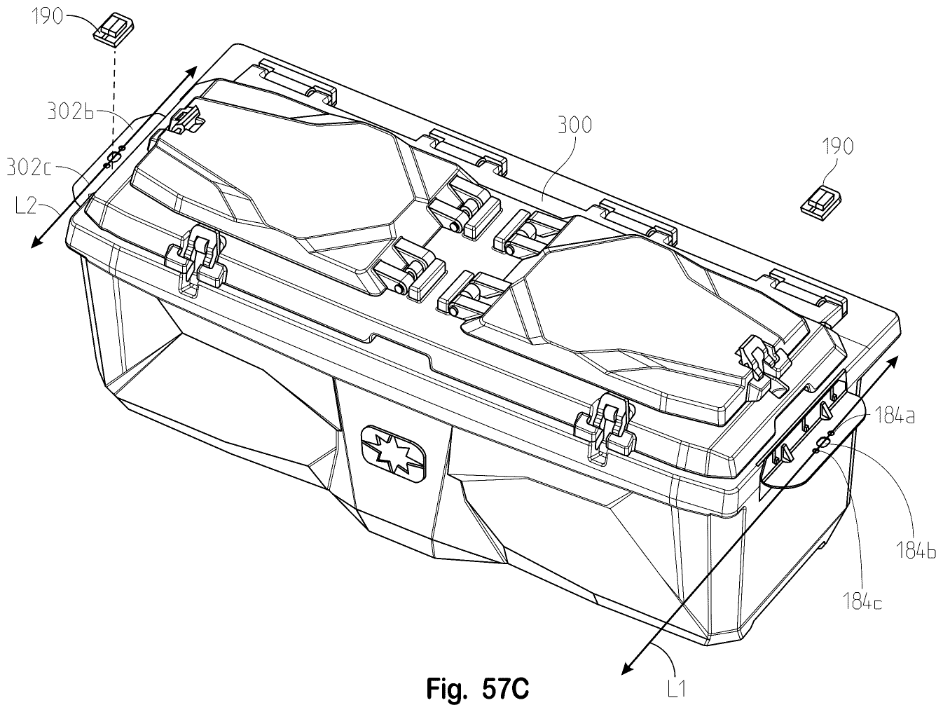

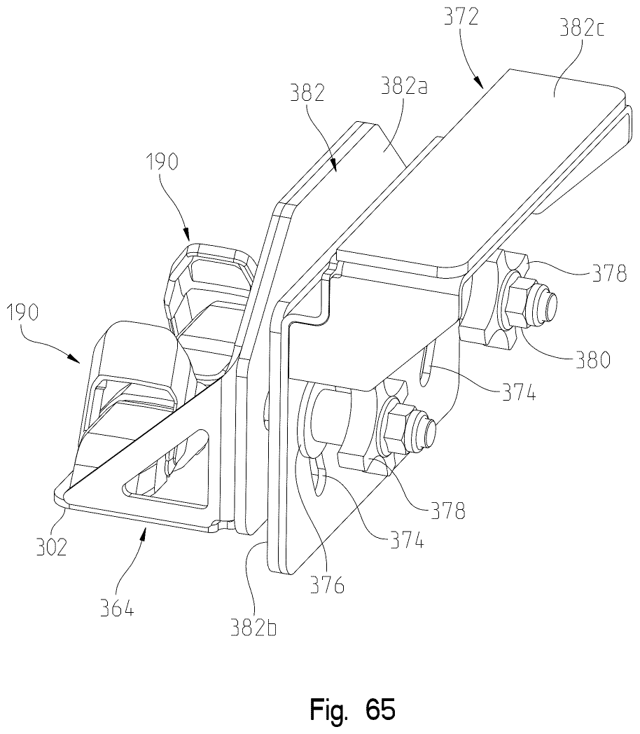

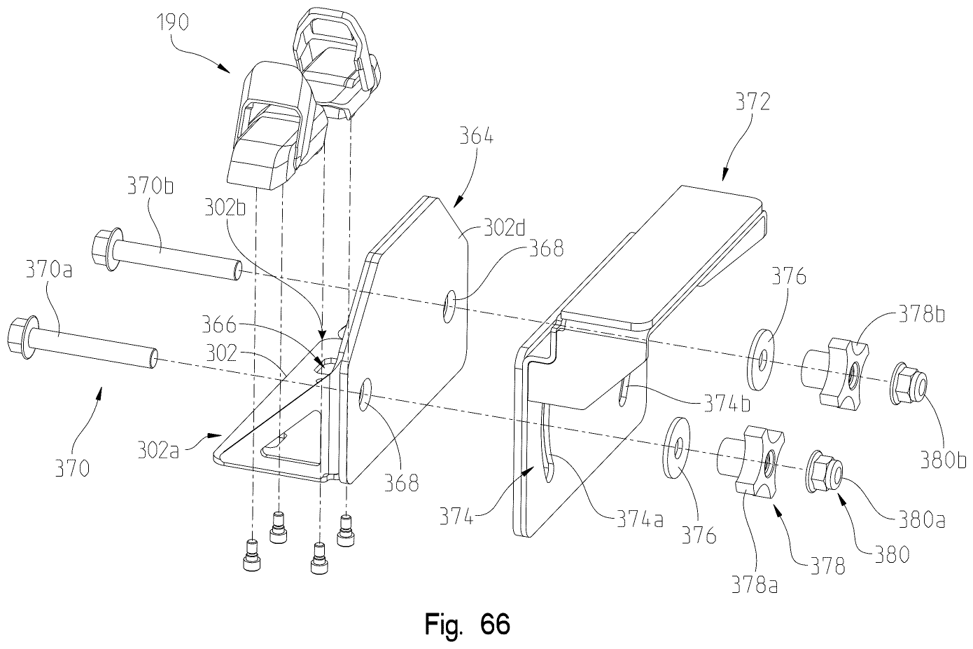

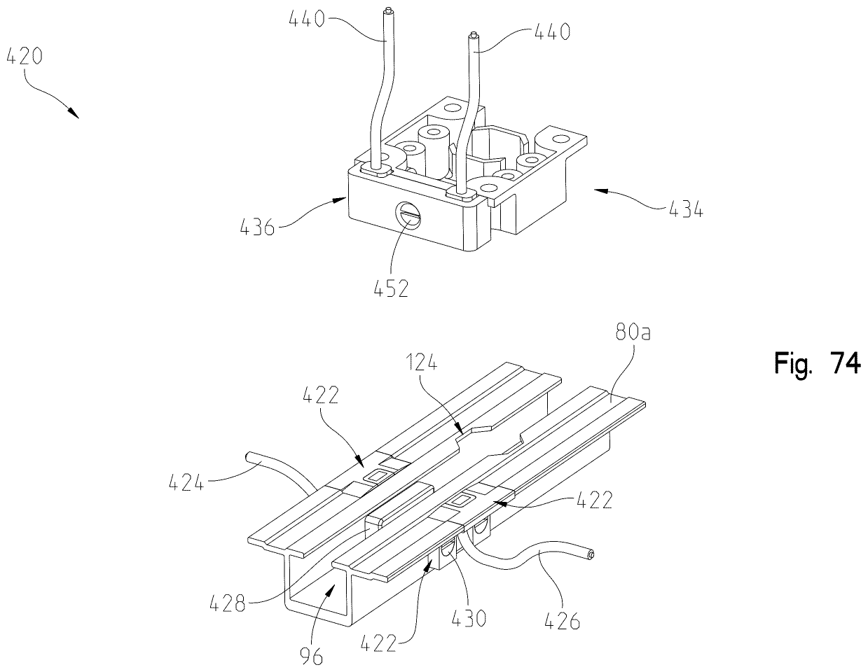

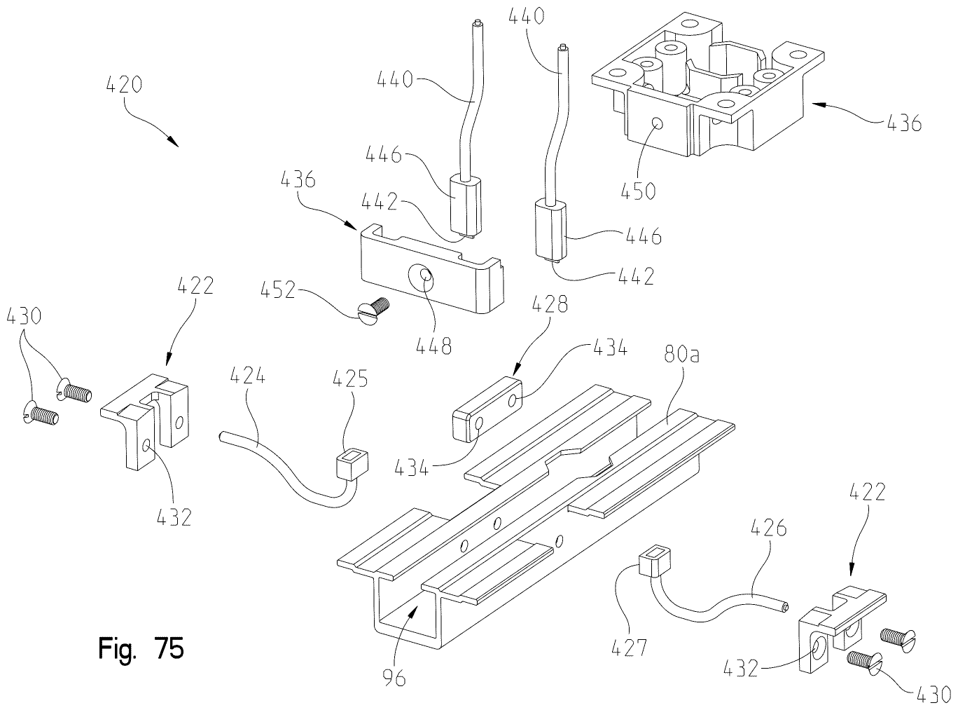

With reference now to FIGS. 57A-75, accessory assemblies that may be stored and attached to cargo area 30 will be described further herein. A double mounting configuration may be used that comprises a mounting bracket 302 that has a first mounting portion 302A and a second mounting portion 302B. Both mounting portions 302A and 302B have the first opening 184a, the second opening 184b, and the third opening 184c extending through a bottom plate 302C of the mounting bracket 302. The first opening 184a, the second opening 184b, and the third opening 184c in each mounting portion 302A, 302B may be aligned colinearly. Likewise, the bottom plate 302C for each portion whether in one bottom plate or separated in two as in FIG. 57A are coplanar. FIG. 57A illustrates the mounting bracket 302 has two physically separated mounting portions 302A and 302B, the bottom surface of which are coplanar with the first openings 184a, the second openings 184b, and the third openings 184c colinear. In FIG. 57A slots 306 in a side are used to receive fasteners. Two slots 306 are used for each portion. However, if the mounting bracket 302 is continuous two or three slots 306 may be used for mounting to an accessory.

FIG. 57B illustrates the use of coupling mechanisms 190 and one of rails 80, illustratively first rail 80a, for coupling of a storage box 300 onto first rail 80a and cargo box 50. For example, a mounting bracket 302 is illustrated supported on first rail 80a and coupled to first rail 80a through two coupling mechanisms 190. Mounting bracket 302 is coupled with storage box 300 with a plurality of fasteners 304 inserted through openings or slots 306 of a side plate 302D of the mounting bracket 302 and into storage box 300. Further, as illustrated in FIG. 57B, openings or slots 306 of mounting bracket 302 are configured such that storage box 300 can slide vertically upward or downward slightly while fasteners 304 are inserted through storage box 300. In this way, various sized storage boxes may be accommodated in use with rails 80 while a bottom panel or surface of storage box 300 may still be in contact with floor 58 of cargo area 30. For example, a smaller storage box may be arranged such that fasteners 304 are positioned at a lowermost point of openings or slots 306 to ensure that the bottom floor of the smaller storage box is in contact with floor 58, while a larger storage box may be arranged such that fasteners 304 are positioned at an uppermost extend of openings or slots 306 to accommodate the larger vertical height of the storage box while maintaining contact between floor 58 and the larger storage box. Additionally, the use of coupling mechanisms 190 to secure storage box 300 with first rail 80a provides the operator with increased flexibility in where storage box 300 is secured and positioned within cargo box 50. For example, coupling mechanisms 190 may be actuated into a release position so that mounting bracket 302, and thus storage box 300, can be translated along first rail 80a to another position before securing coupling mechanism 190 once again.

In FIG. 57C the storage box 300 may be coupled to two rails 80a, 80b on opposite sides of a cargo area (such as illustrated in FIG. 10 and therefore not repeated here). One coupling mechanism 190 is disposed in each of the first mounting portion 302A and the second mounting portion 302B. In this example, each of the rails 80a, 80b use a single coupling mechanism 190 at each mounting potion 302A, 302B. In this manner only one set of openings 184a, 184b and 184c are used on each bracket 302′ at each side of the storage box 300. The openings 184a, 184b and 184c of each of the mounting portions are colinear. However, between each mounting portion, the openings 184a, 184b and 184c are parallel as illustrated by parallel lines L1 and L2.

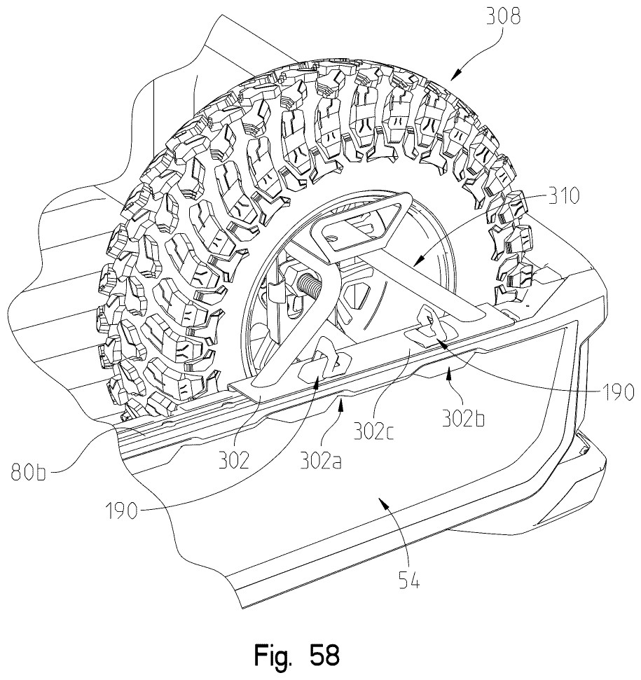

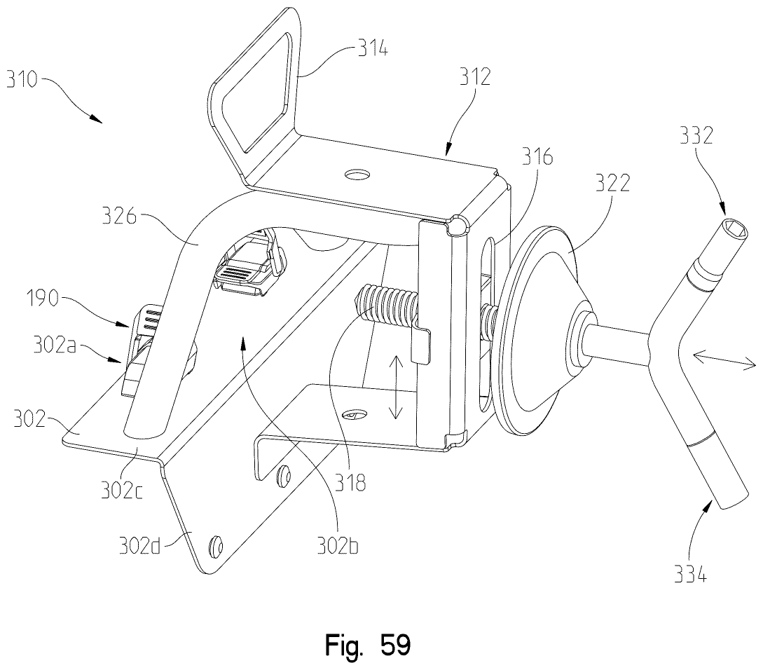

Referring now to FIGS. 58 and 59, an accessory such as a spare tire 308 may additionally be supported by cargo box 50. A tire mount 310 that may be used with rails 80, illustratively second rail 80b, of cargo box 50 using a mounting bracket 302 having the mounting portions 302A, 302B, the bottom plate 302C and the side plate 302D. In this example the side plate 302D extends downward from the rail 80. Rail 80b is illustrated as having the single channel profile such that second rail 80b are integrated on the top surfaces of side panels 54 of cargo box 50, as described with reference to FIGS. 10-11. FIG. 59 illustrates tire mount 310 prior to supporting a tire 308 and prior to coupling with either of rails 80. Tire mount 310 includes a frame 312 having a handle 314 and an opening 316 for receiving a fastener, such as weld nut 318. Extending from weld nut 318, tire mount 310 further includes a first socket 332 and a second socket 334 which may act as a handle for actuation by the operator to rotate weld nut 318, as will be described further. Additionally, weld nut 318 extends through a tire cup 322 configured for securement against at least a portion of tire 308. Further, frame 312 includes a top horizontally extending portion 324 supported by frame tubes 326. Frame tubes 326 and a bottom most portion 328 of frame 312 are coupled to a bracket 330, which may then couple with one of rails 80, illustratively second rail 80b, as will be described further herein.

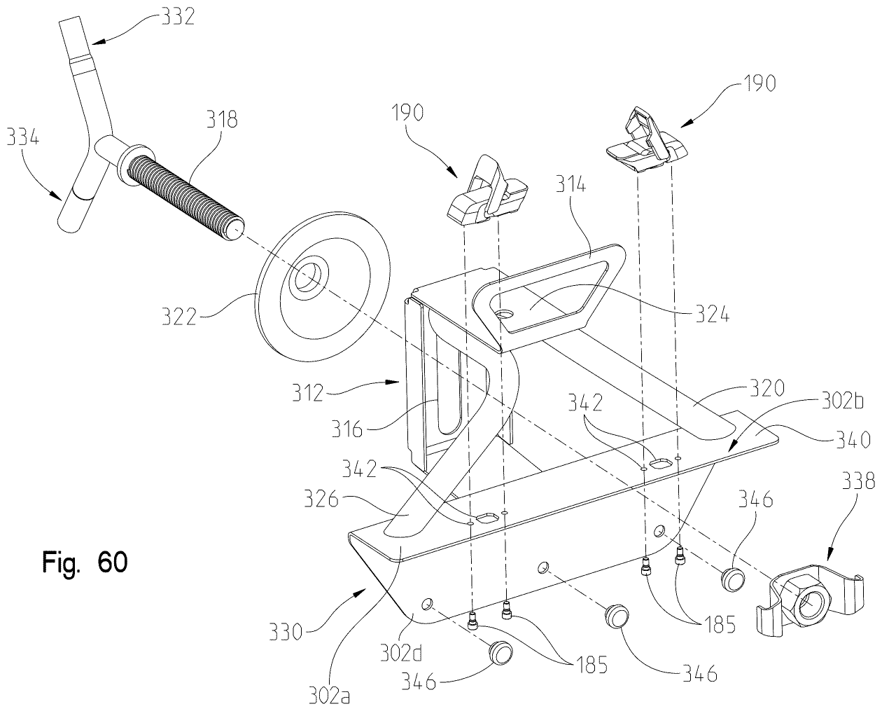

With reference to FIG. 60, in assembly, weld nut 318 is configured for reception with an opening 336 of tire cup 322. After reception into opening 336, weld nut 318 extends through opening 316 of frame 312. Opening 316 extends vertically with a greater length than a diameter of weld nut 318 such that weld nut 318 may slide vertically within opening 316, which may be beneficial for accommodating various diameters of tires, as will be described further herein. Further, after reception through opening 316, weld nut 318 may be engaged with a fastener 338 for securing the positioning of weld nut 318. Bracket 330 may then be arranged onto top surface 128 of second rail 80b and coupling mechanisms 190 may be secured with bracket 330 to couple bracket 330 to second rail 80b. Illustratively, a top surface 340 of bracket 330 comprises a plurality of openings 342 for receiving coupling mechanisms 190. Illustratively, tab 200 of each coupling mechanism 190 may extend through one of openings 342 while fasteners 185 are received through the remaining openings 342 to couple with coupling mechanisms 190.

The above-described configuration of tire mount 310 allows for flexibility in the arrangement of tire 308 along with flexibility in the sizing of tire 308. For example, as previously described, first and second socket 332, 334 may be used to rotate weld nut 318. In this way, once tire 308 is positioned onto weld nut 318 between tire cup 322 and frame 312, an operator may rotate weld nut 318 until tire 308 is engaged with both tire cup 322 and frame 312. Further, tire mount 310 may accommodate tires having a variety of different diameters. When positioned onto tire mount 310, a bottom surface of tire 308 is supported by floor 58 and weld nut 318 may be vertically adjusted within openings 316 to accommodate a varying diameter of tire 308 while retaining the support of tire 308 by floor 58.

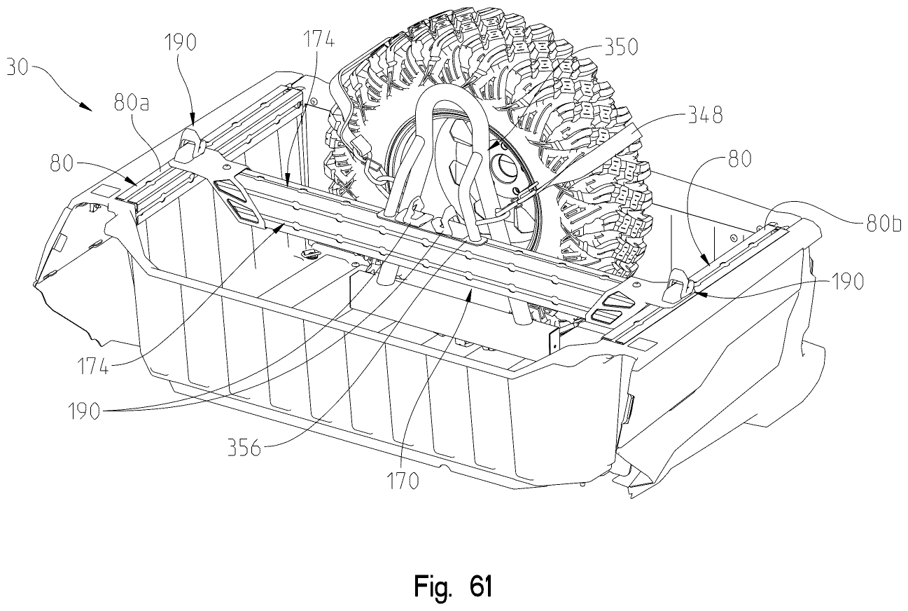

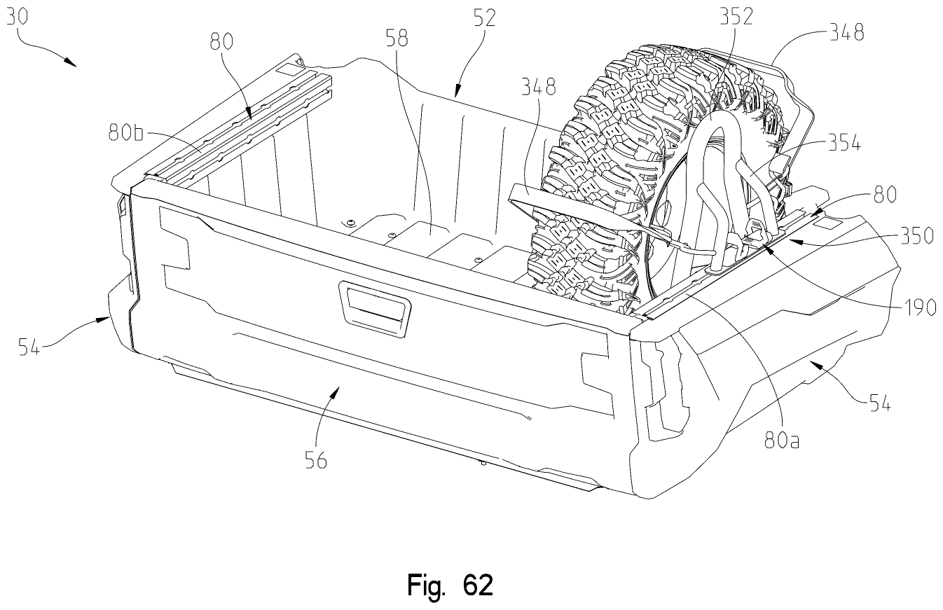

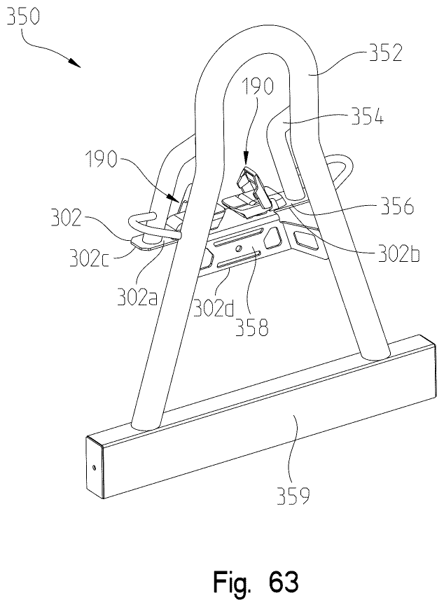

FIG. 61 illustrates an additional embodiment of tire mount, illustratively tire mount 350. Rather than coupling directly to second rail 80b as shown with tire mount 310, tire mount 350 is shown coupled with crossbar 170 which extends between rails 80. This may particularly useful when rails 80 are coupled with an inner surface of side panels 54 such that cover 44 (FIG. 9) may be coupled with top surfaces of side panels 54. FIG. 62 shows tire mount 350 directly coupled with one of rails 80, illustratively first rail 80a. As illustrated best in FIG. 63, tire mount 350 is composed of a main frame tube 352 having frame tubes 354 extending from main frame tube 352 and coupled with a bracket 356. Bracket 356 is configured for receiving coupling mechanisms 190 and will be mechanically coupled with first rail 80a of cargo box 50. More specifically, bracket 356 is coupled with channel 96 of first rail 80a through coupling mechanisms 190. Extending vertically downward from bracket 356 is a supporting bracket 358 that is coupled to main frame tube 352 and may provide additional support to tire mount 350. Supporting bracket 358 may engage with a portion of second rail 80b that extends along an inner surface of side panels 54. Further, tire mount 350 includes a block 359 coupled with bottom portions main frame tube 352. Further, as illustrated in FIG. 62, tire mount 350 is configured to support tire 308. Tire mount 350 may additionally include straps 348 that may extend around the tire and couple with frame tubes 354 to hold tire 308 in place. Straps 348 may be adjustable in order to accommodate various sized tires, for example in both diameter and in thickness. Various other fastening mechanisms may also be used. For example, in some embodiments, floor 58 may include various fastening or coupling mechanisms for holding the tire in place and securing tire mount 360.

As previously described, tire mounts 310, 350 may each accommodate various types and sizes of tires based on the operator's needs. For example, the tire may have a diameter ranging between at least 27 inches to 32 inches and may be accommodated through the above-described flexibility in the arrangement of tire mounts 310, 350. However, various other sizes of the tires may be accommodated as well. For example, the diameter of the tire may range from 20 inches to 40 inches. Additionally, due to the use of rails 80 and coupling mechanisms 190 for coupling of tire mounts 310, 350 to cargo box 50, the lateral positioning or longitudinal positioning of tire mounts 310, 350 within cargo box 50 may be easily adjusted through actuation of coupling mechanisms 190 and translation of tire mounts 310, 350 on rails 80 or through translation of crossbars 170 on rails 80.

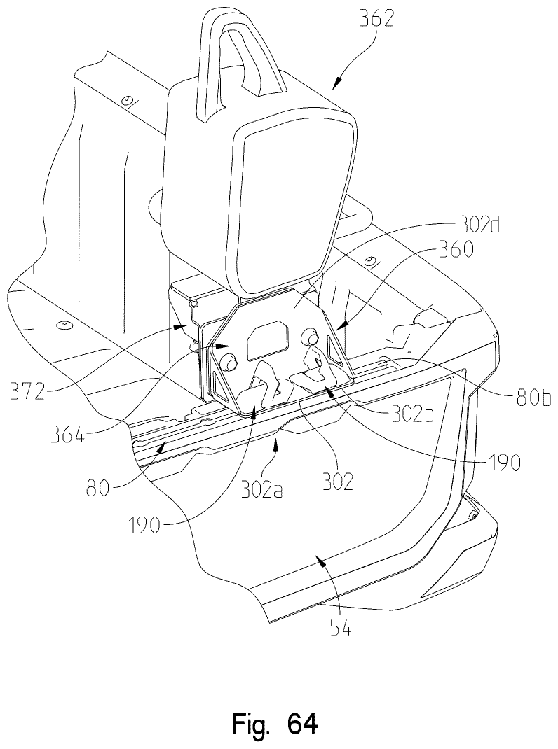

Various other accessories may be carried or supported by rails 80 in combination with coupling mechanisms 190. For example, FIGS. 63-67 illustrate an embodiment of a chainsaw mount 360 for use with rails 80 and coupling mechanisms 190. FIG. 64 illustrates a portion of side panel 54 with second rail 80b extending along a top surface of side panel 54 and engaged with chainsaw mount 360 which is illustrated carrying a chainsaw 362. Illustratively, chainsaw mount 360 includes a mounting bracket 364 having a plurality of openings 366 extending through a horizontally extending portion of mounting bracket 364. Openings 366 are configured for engaging with coupling mechanism 190 which allow for the securing of chainsaw mount 360 to rails 80, as has been previously described with reference to various of the accessory mounts herein. Mounting bracket 364 additionally includes a vertically extending portion that extends upwardly from the horizontally extending portion. As illustrated, the vertically extending portion includes openings 386 which may align laterally with a plurality of slots 374 of a support plate 372 of chainsaw mount 360. After lateral alignment of slots 374 and openings 368, openings 368 and slots 374 may receive fasteners 370 extending laterally therethrough. Once fasteners 370 extend through slots 374, fasteners 370 are secured with weld nuts 380. Washers 376 are illustrated as positioned against support plate 372 and handles 378 are positioned against washers 376. In this way, handles 378 are positioned laterally between washers 376 and weld nuts 380. Handles 378 may be rotated and/or actuated by the operator to loosen or tighten the coupling between mounting bracket 364 and support plate 372.

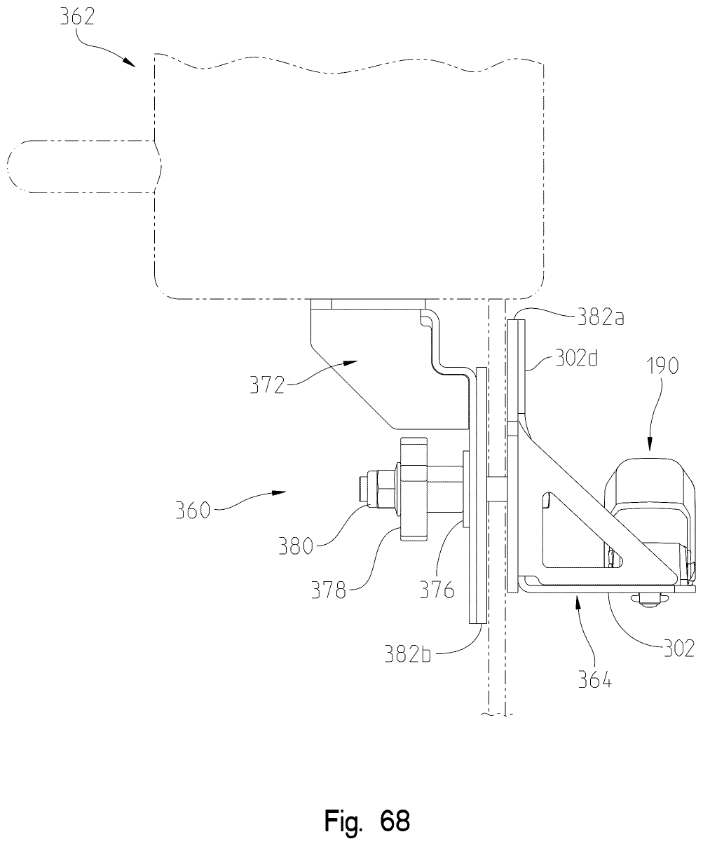

Additionally, chainsaw mount 360 includes a plurality of foam pads 382 positioned against various portions of chainsaw mount 360 to protect chainsaw 360 after mounting of chainsaw 362 onto chainsaw mount 360. For example, a first foam pad 382a may be positioned against the vertically extending portion of mounting bracket 364, a second foam pad 382b may be positioned against a vertically extending portion of support plate 372, and a third foam pad 382c may be positioned against a horizontally extending portion of support plate 372. As shown in FIG. 64 and in phantom in FIG. 68, a handle portion of chainsaw 360 is positioned against third foam pad 382c that is positioned on horizontally extending portion of support plate 372 while a blade of chainsaw 362 extends downward and between first and second foam pads 382a, 382b.

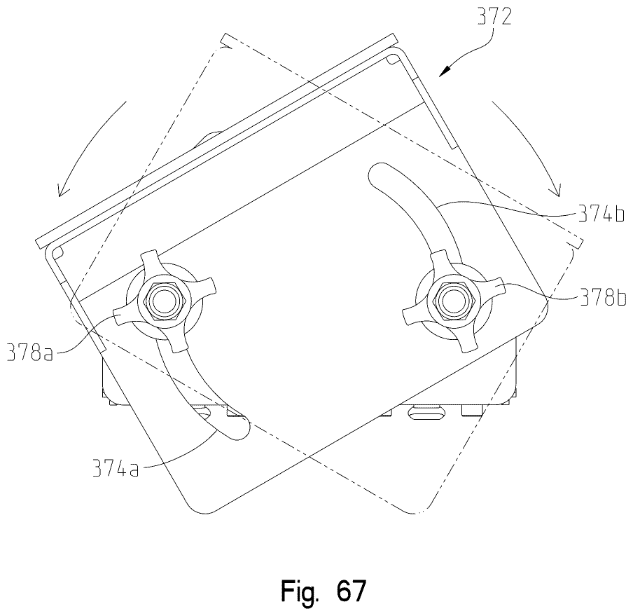

Upon mounting of mounting bracket 364 to support plate 372, fasteners 370 extend through at least a portion of each of slots 374. In this way, support plate 372 may rotate relative to mounting bracket 364. For example, FIG. 67 illustrates support plate 372 in a first tilted position defined by a first fastener 370a of fasteners 370, and therefore a first handle 378a of handles 378, being positioned at an upper extent of a first slot 374a of slots 374 and a second fastener 370b of fasteners 370, and therefore a second handle 378b of handles 378, being positioned at a lower extent of a second slot 374b of slots 374. This tilted position may correlate to support plate 372 being tilted at approximately 30 degrees relative to mounting bracket 364, however, support plate 372 may be rotated at any angle between 0 degrees and 30 degrees. In phantom lines, a second tilted position of support plate 372 is illustrated defined by first fastener 370a being positioned at a lower extent of first slot 374a and second fastener 370b being positioned at an upper extent of second slot 374b. Further, the second tilted position may be defined as when support plate 372 is rotated relative to mounting bracket 364 at an angle of approximately 30 degrees, however, support plate 372 may be rotated relative to mounting bracket 364 by any angle between 0 degrees and 30 degrees. The ability to rotate the positioning of chainsaw mount 360 within a range of approximately 60 degrees allows for chainsaw 362 positioning to be customized within cargo box 50 to optimize storage space of cargo box 50. Further, while illustrated as having chainsaw mount 360 positioned substantially within cargo area 30, chainsaw mount 360 may be adjusted such that it is positioned on an outer surface the side panels 54 and positioned outside of cargo area 30. This provides additional flexibility and customizing of the arrangement of chainsaw mount 360 and may increase the space available within cargo area 30 for supporting other accessories.

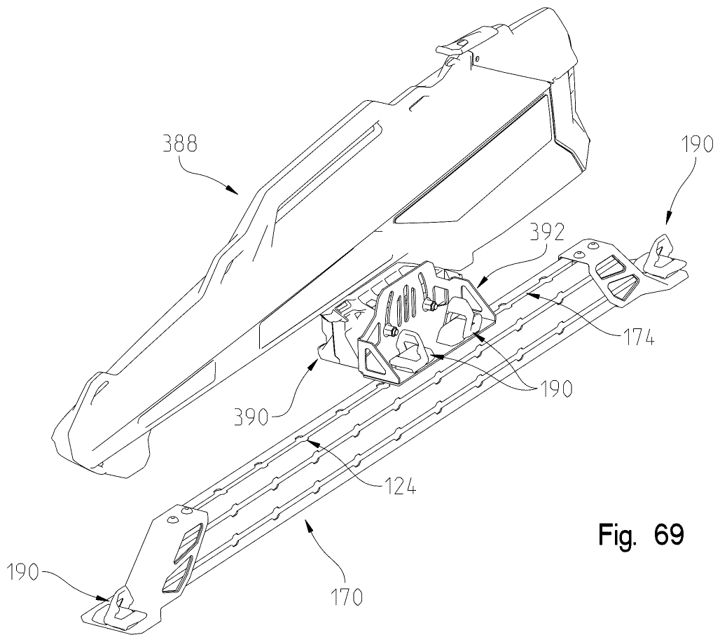

In further embodiments, additional accessories may be mounted onto cargo area 30 through the use of coupling mechanisms 190, 280 and rails 80 and/or crossbars 170. As illustrated in FIG. 69, crossbar 170 and coupling mechanisms 190 may be used for coupling a gun or gun case 388 to crossbar 170 and thus to rails 80, through the use of a gun mount 392. As illustrated, gun mount 392 is generally coupled to an outer surface of crossbar 170, however, gun mount 392 may be coupled to an inner surface of crossbar 170. Illustratively, gun mount 392 includes a mounting bracket 394 having a plurality of slots 396. As illustrated, a first slot 396a is defined by an arcuate shape and is configured for receiving a first fasteners 398a. Further, bracket 394 includes a second slot 394b, a third slot 396c, and a fourth slot 396d that each have a linear shape and extending generally vertically. Additionally, bracket 394 is illustrated as having a fifth slot 396e positioned laterally adjacent fourth slot 396d and is defined by an arcuate shape and configured to receive a second fastener 398b. As illustrated, fasteners 398 are configured for directly coupling bracket 394 with a gun boot 390 supporting gun or gun case 388.

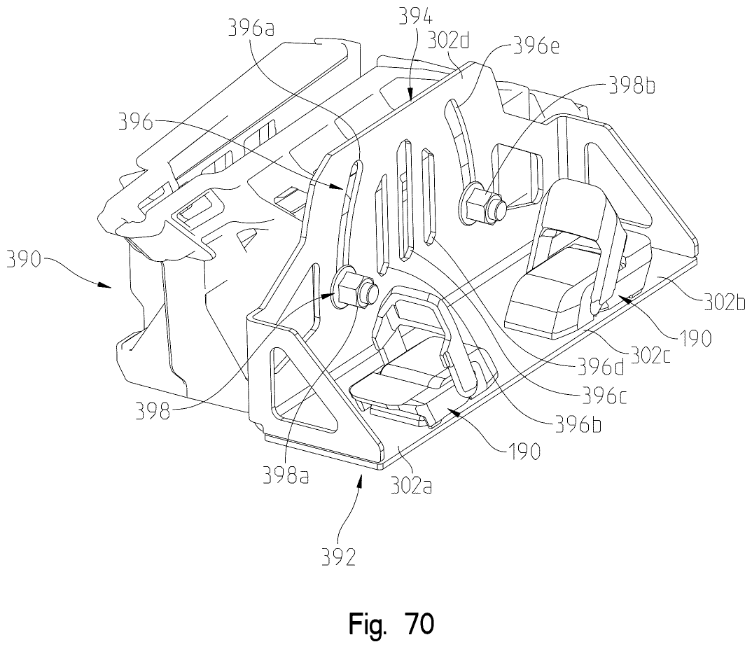

Bracket 394 may additionally receive coupling mechanisms 190 when at least a portion of bracket 394 is supported by crossbar 170 such that coupling mechanisms 190 couple bracket 394 directly to crossbar 170. In some embodiments, gun mount 392 and thus gun boot 390 may be coupled directly to rails 80. With reference still to FIG. 70, the above-described configuration allows for flexibility in the positioning of gun boot 390 within cargo area 30 and allows for flexibility in the positioning of gun boot 390 itself. For example, due to coupling of gun mount 392 with coupling mechanisms 190 to channel 174 of crossbar 170, gun mount 392 may be translated along crossbar 170. For example, operator may actuate coupling mechanism 190 into an open position, slide gun mount 392 to the desired longitudinal positioning along crossbar 170, and secure coupling mechanisms 190 into the retain configuration to secure the positioning of gun mount 392.

Additionally, the arcuate shapes of first and fifth slots 396a, 396e allow for pivoting of gun boot 390 while coupled with gun mount 400 and crossbar 170. For example, similar to as described with reference to chainsaw mount 360 of FIGS. 64-67, gun boot 392 may be rotated such that first fastener 398a may be positioned at an upper extent of first slot 396a and second fastener 398b may be positioned at a lower extending of fifth slot 396e. Similarly, gun boot 392 may be rotated to a second tilted position such that first fastener 398a is positioned at a lower extent of first slot 396a while second fasteners 398b may be positioned at an upper extent of fifth slot 396e. In this way, operator may adjust the angle at which gun boot 390, and therefore the gun within gun boot 390, is positioned within cargo area 30 to optimize cargo area 30 spacing.

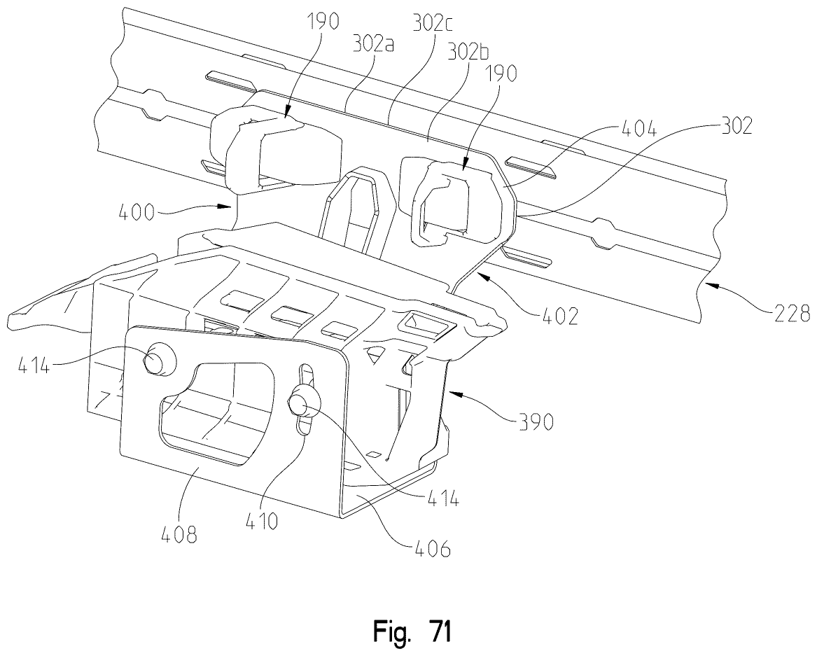

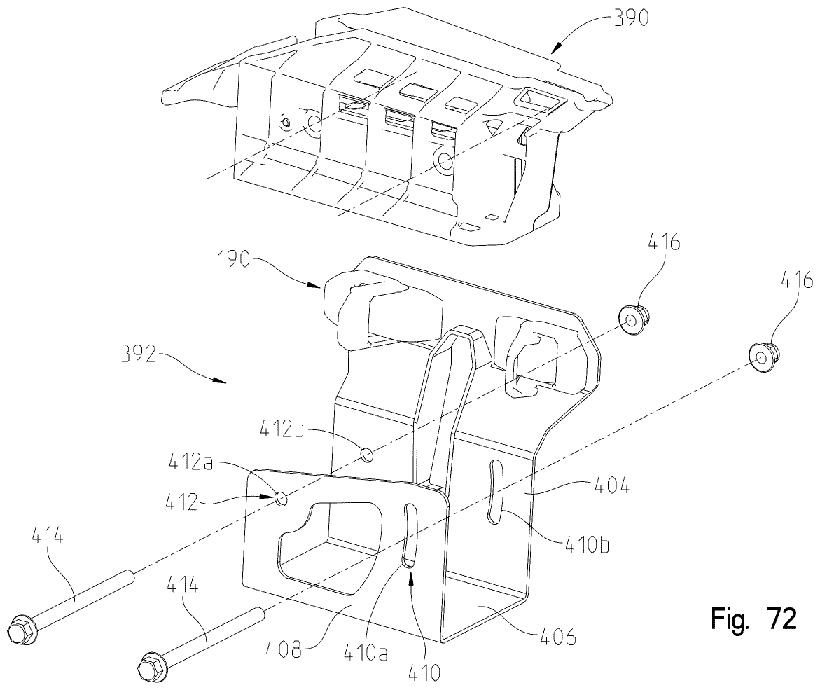

FIGS. 71-72 illustrate an additional embodiment of a gun mount 400. As shown, gun mount 400 may be directly mounted onto rail 80. However, gun mount 400 may be mounted to any of rails 80, 228, or crossbars 170 previously described herein. For example, gun mount 400 may alternatively be mounted to rail 228 of cargo overhead rack 206 as discussed with reference to FIGS. 41A-46B. As shown in FIGS. 71-72, gun mount 400 includes a mounting bracket 402 for attachment to rail 228 through coupling mechanisms 190. More specifically, mounting bracket 402 includes a first plate portion 404 having openings for aligning with ports 124 of rail 228 for coupling with coupling mechanisms 190. Further, mounting bracket 402 includes a first portion 404, a second portion 406 extending horizontally from first portion 404, and a third portion 408 coupled with second portion 406. In the illustrative embodiment of FIGS. 71-72, each of first portion 404, second portion 406 and third portion 408 are formed integrally with one another, however, in various embodiments, first portion 404, second portion 406, and third portion 408 may be separate plates coupled with one another. As illustrated in FIGS. 71-72, third portion 408 includes a first opening 412a that aligns laterally with a second opening 412b of first portion 404. Further, third portion 408 additionally includes a first slot 410a laterally aligned with a second slot 410b of first portion 404. Gun boot 390 includes openings 418 which may align laterally with openings 412 and slots 410 of mounting bracket 402. In this way, gun boot 390 may be arranged within mounting bracket 402 and supported between first and third portions 404, 408 of mounting bracket 402, and fasteners 414 may be inserted laterally through openings 412 of third portion 408, openings 418 of gun boot 390, and slots 410 of first portion 404, for securing gun boot 390 with mounting bracket 402.

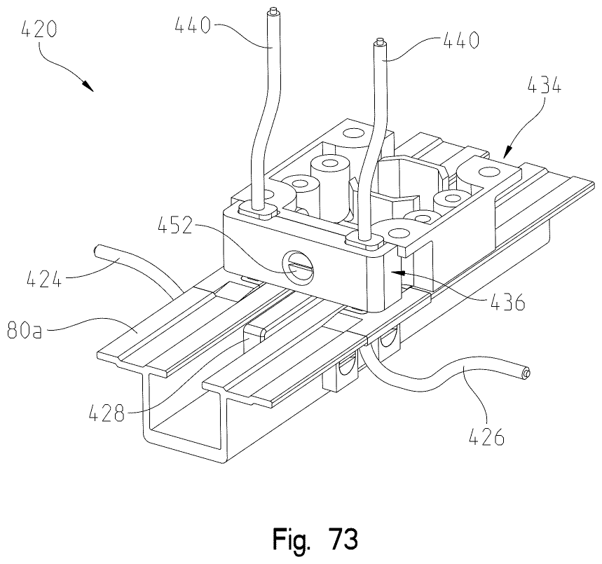

While the above-described embodiments have illustrated accessories including tires, gun boots and/or chainsaws, various other accessories may be supported within cargo box 50 and used with the various mounting mechanisms. For example, smaller power tools may be supported by cargo box 50. Any of the above-described accessories may benefit from additional power supply or charging while vehicle 2 (FIG. 1) is in operation. FIGS. 73-75 illustrate a power assembly 420 that may be mounted to rails 80, 228, or crossbar 170 to provide electric power from an on-vehicle power supply to power assembly 420 that allows for power to be routed to a powered accessory that may be engaged with power assembly 420. In further embodiments, an LED light may be supported by cargo box 50. The LED light may include a work light, a reverse light, a spotlight, or any other applicable LED light that may be positioned onto rails 80, 228, or crossbar 170. In these embodiments, the LED light may be coupled with power assembly 420 to provide power to the LED light. For example, the LED light may be mounted directly onto power assembly 420.

Illustratively, power assembly 420 includes a base 434 for attachment with first rail 80a. While described with reference to first rail 80a, power assembly 420 may additionally be coupled with second rail 80b. Base 434 couples with a bracket 436 through openings 448 and 450, and a fastener 452 configured for reception and securement with openings 448 and 450. Bracket 436 and base 434 may have electrical contacts 442 supported therein and extending from wires 440 which are also supported by bracket 436 and base 434. In some embodiments, electrical contacts 442 may be contact brushes. As illustrated, electrical contacts 442 extend through isolators 446 of wires and into bracket 436. Electrical contacts 442 may be configured to electrically couple with a power source from vehicle 2 for providing power to an accessory through wires 440. For example, wires 440 may couple with an electric drill or other electrically powered tool to provide power during use of vehicle 2. More specifically, electrical contacts 442 are configured for coupling with electrical connectors (not shown) of a power wire 424 and a ground wire 426 which are configured for coupling with a battery or other power source of vehicle 2. The structure of power assembly 420 and coupling mechanism to first rail 80a allowing for this power transmittal will be described further herein.

Power assembly 420 additionally includes a backplate 428 configured for arrangement into channel 96 of rails 80, a first cover 422 configured for being positioned against an outer surface of second rail 80b with openings 432 configured for receive fasteners 430 for securing the positioning of first cover 422 against first rail 80a. Further, as illustrated, power assembly 420 additionally includes a second cover 422 for being positioned on an opposing side of first rail 80a having openings 432 for receiving fasteners 430 to secure second cover 422 against first rail 80a. Power wire 424 having an isolator 425 coupled therewith extends through first cover 422a. Further, ground wire 426 having an isolator 425 extends through second cover 422b. In this way, power and ground wires 424, 426 are secured within power assembly 420 and arranged for connection with electrical contacts 442 of wires 440 and connection with the battery and/or another power source of vehicle 2. Thus, power is transmitted from a power source of vehicle 2, though power assembly 420, and to the desired accessory.

Power assembly 420, as described, provides the advantage of not requiring the removal of power and ground wires 424, 426 for the removal or attachment of power wires 440. Similarly, it may not be required to remove power wires 440 to remove and/or attach power and ground wires 424, 426. Further, due to the above-described configuration, electrical contacts 442 are easily accessible for the operator to access, clean and repair if needed.

With reference to any of the above-described systems and mechanisms for optimizing the accessory spacing within cargo area 30 or for coupling accessories to cargo area 30, the coupling mechanisms and/or attachment structures may be designed such that a predetermined failure point is incorporated to control a location of failure within the systems. For example, with reference to the coupling mechanism of FIGS. 55-57, coupling mechanisms 280 may be designed with a localized area that is designed to deform or fail under a certain stress or load. In this way, coupling mechanism 280 may deform and/or fail before the rail or crossbar that coupling mechanism 280 is connected to deforms and/or fails. For example, if attachment portion 284 of coupling mechanism 280 is being used for attachment of an accessory, the accessory may impart a load onto coupling mechanism 280 that is greater than a certain threshold, and attachment portion 284 may be designed such that attachment portion 284 deforms or breaks off with the accessory rather than coupling mechanism 280 being pulled out of port 124 or causing rail 80 and/or port 124 to deform.

The above description may also apply to coupling mechanism 190. For example, a portion of coupling mechanism 190, such as tab 200 or main body portion 192 may be formed as a predetermined failure location such that the coupling mechanism 190 fails before a stress can cause deformation or failure of rails 80. This may be through the mechanical design of coupling mechanism 190, the material that coupling mechanism 190 is composed of, or any other applicable design consideration. Further, this concept may be applied to various other systems described herein. For example, with reference to cargo area extender 240 as described with reference to FIG. 48, a junction between curved bars 244 and vertically extending portions 248 may be designed as a predetermined failure point such that the junction of curved bars 244 and vertically extending portions 248 would deform and/or fail under stress prior to the remainder of cargo area extender 240 and connection of vertically extending portions 248 to rails 80. In this way, in the event of stress imposed onto cargo area extender 240, portions of cargo area extender 240 may fail before the stress can deform or damage rails 80 and/or cargo box 50. However, any portion of cargo area extender 240 or coupling mechanism 190 may be designed to deform and/or fail before any other portion of cargo area extender 240 to protect the integrity of rails 80.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A utility vehicle comprising:
a plurality of ground-engaging members;
a frame assembly having a front frame portion and a rear frame portion;
upstanding posts coupled to the frame assembly;
a cargo area supported by the rear frame portion, the cargo area including a floor, a first side wall extending vertically upward from the floor, a second side wall extending vertically upward from the floor, and forward wall coupled with the first side wall and the second side wall, and a rear wall or tailgate coupled to the first side wall and the second side wall;
a first rail coupled between a first two of the upstanding posts and a second rail coupled to a second two of the upstanding posts, each of the first rail and the second rail including at least a first channel extending along a longitudinal length of the rail, and at least one port integrated with the first channel configured for receiving a coupling mechanism.

2. The utility vehicle of claim 1 further comprising a plurality of body panels supported by the frame assembly.

3. The utility vehicle of claim 1 wherein a bottom channel formed within the rail said bottom channel receiving at least a portion of a fastener for supporting a side panel.

4. The utility vehicle of claim 3 wherein the portion of the fastener comprises a head and wherein the side panel is coupled to the rail between the head and a nut.

5. The utility vehicle of claim 4 wherein said first channel is disposed above the bottom channel.

6. The utility vehicle of claim 1 wherein the first rail further comprises a laterally extending portion and further comprising a side panel comprising a tab, said laterally extending portion receiving the tab.

7. The vehicle of claim 1 wherein a top surface of a side panel coupled with the first rail includes a registration feature indicating a positioning of ports along the rail.

8. The utility vehicle of claim 1 wherein first rail further comprises a first portion comprising the first channel and a side channel disposed in a second portion of the first rail.

9. The utility vehicle of claim 8 wherein the second portion is perpendicular to the first portion.

10. The utility vehicle of claim 1 wherein the second rail comprises a second port integrated with the second channel configured for receiving the coupling mechanism

11. The utility vehicle of claim 10 wherein the rail has a first longitudinal end and a second longitudinal end, and wherein the rail comprises a cap positioned at the first longitudinal end, the cap configured to engage with at least one of the first channel and the second channel and provide a sealing mechanism at the first longitudinal end of the rail.

12. The utility vehicle of claim 11 wherein a seal is positioned within the first channel of the rail, the seal being biased into sealing engagement with a surface of the first channel.

13. The utility vehicle of claim 1 wherein the first rail is coupled with a first side panel the second rail is coupled with a second side panel, and wherein the cargo area includes at least one crossbar extending laterally between the first rail and the second rail.

14. The utility vehicle of claim 13 wherein the crossbar includes a plurality of channels integrated with the crossbar, each channel of the plurality of channels configured for receiving a coupling mechanism for coupling accessories to the crossbar.

15. The utility vehicle of claim 1 wherein the coupling mechanism comprises a body having a body portion having a first side having an attachment portion extending therefrom, said body portion having a second side having an alignment feature, an engagement device; and a handle disposed adjacent the first side coupled to the engagement device adjacent the second side and engaging the rail, said engagement device comprising an extension rotatable with the handle.

16. A utility vehicle, comprising:
a plurality of ground-engaging members;
a frame assembly having a front frame portion and a rear frame portion;
upstanding posts coupled to the frame assembly;
a plurality of body panels supported by the frame assembly;
a cargo area supported by the frame assembly, the cargo area including a floor panel and at least two side panels extending vertically upward from floor panel; and
wherein the cargo area includes a first rail coupled with one of the side panels of the cargo area and coupled between a first two of the upstanding posts, the first rail including:
a first channel extending along a longitudinal length of the first rail and extending along a top surface of the side panel;
a second channel extending along the longitudinal length of the first rail and extending along an inner surface of the side panel; and
at least one port integrated with the second channel configured for receiving a coupling mechanism; and
wherein the first rail is coupled to the side panel with at least one fastener, wherein the fastener is concealed from a top view of the side panel.

17. The utility vehicle of claim 16, wherein a seal is arranged within the first channel and configured for local deformation in response to inserting of the coupling mechanism into the rail.

18.-45. (canceled)

46. A utility vehicle, comprising:
a plurality of ground-engaging members;
a frame assembly having a front frame portion and a rear frame portion;
upstanding posts coupled to the frame assembly;
a plurality of body panels supported by the frame assembly; and
a cargo area supported by the frame assembly, the cargo area including a floor panel and a first side wall extending vertically upward from the floor panel, a second side wall extending vertically upward from the floor panel and a tailgate coupled with the floor;
wherein the cargo area includes a first rail coupled with the first side panel and coupled between a first two of the upstanding posts and a second rail coupled with the second side panel and coupled between a first two of the upstanding posts, the first rail and second rail each having a longitudinal length and comprising:
a first channel, and the first channel of each of the first and second rails extends along the longitudinal length and extending along a top surface of the corresponding first or second side panel;
a plurality of ports arranged within the top surface of the first rail and the second rail configured for receiving a coupling mechanism; and
wherein the cargo area includes an overhead rack coupled with the first rail and the second rail, the overhead rack defined by a plurality of upstanding posts coupled with the first and second rails and at least two cross braces extending laterally between the upstanding posts, wherein the at least two cross braces each comprise a channel.

47. The utility vehicle of claim 46, wherein each of the upstanding posts are coupled to the first rail or the second rail through a mounting bracket fastened to the first rail and the second rail through at least one fastener.

48. The utility vehicle of claim 46, wherein the at least two cross braces extend laterally between the upstanding posts are defined by a flat, linear profile and are fastened to the upstanding posts through a mechanical fastener.

49. The utility vehicle of claim 46, wherein the overhead rack includes at least two crossbars extending longitudinally between the upstanding posts, and wherein at least one of the crossbars includes a rail integrated on an underside of the at least one crossbar.

50.-100. (canceled)
